(19) United States
(12) Patent Application Publication
(10) Pub. No.: US 2014/0200824 A1
(43) Pub. Date: Jul. 17, 2014

(54) K-PARTITE GRAPH BASED FORMALISM FOR CHARACTERIZATION OF COMPLEX PHENOTYPES IN CLINICAL DATA ANALYSES AND DISEASE OUTCOME PROGNOSIS

(71) Applicant: Petr Pancoska, Pittsburgh, PA (US)

(72) Inventor: Petr Pancoska, Pittsburgh, PA (US)

(73) Assignee: University of Pittsburgh Of the Commonwealth System of Higher Education, Pittsburgh, PA (US)

(21) Appl. No.: 14/212,036

(22) Filed: Mar. 14, 2014

Related U.S. Application Data
(63) Continuation-in-part of application No. 13/063,832, filed on Mar. 14, 2011.
(60) Provisional application No. 61/781,460, filed on Mar. 14, 2013.
(60) Provisional application No. 61/098,599, filed on Sep. 19, 2008.

(51) Int. Cl. G06F 19/24

(52) U.S. Cl. CPC G06F 19/24
USPC 702/19

(57) ABSTRACT

Systems and methods are disclosed that can analyze relationships between parameters in data matrices (e.g., collections of individual profiles). A graph topology can be defined on a data matrix with partitions as variables and vertices in all partitions and their potentials and edges as the co-occurrence of a pair of variable values in a profile. Individual graphs can be constructed from data and value co-occurrences for every profile, and a study data graph made as a union of all individual graphs. Heterogeneity Landmarks (HLs) can be determined from the study data graph, and graph-graph distances between individual graphs and all HLs. These distances can be used for prognoses based on similarity of a profile to one or more HLs.

### CROSS-REFERENCE TO RELATED APPLICATIONS

This application claims the benefit of pending U.S. Provisional Patent application Ser. No. 61/781,460 (Atty. Dkt. No. 106852.62PRO) entitled ‘K-PARTITE GRAPH BASED FORMALISM FOR CHARACTERIZATION COMPLEX PHENOTYPES IN CLINICAL DATA ANALYSES AND DISEASE OUTCOME PROGNOSIS’ and filed Mar. 14, 2013, and is a continuation-in-part of pending U.S. patent application Ser. No. 13/063,832 (Atty. Dkt. No. 106852.7PCTUS) entitled “DISCOVERY OF τ-HOMOLOGY IN A SET OF SEQUENCES AND PRODUCTION OF LISTS OF τ-HOMOLOGOUS SEQUENCES WITH PREDEFINED PROPERTIES” and filed Mar. 14, 2011, which is a U.S. national stage entry under 35 U.S.C. §371 of international application PCT/US09/57438 (Atty. Dkt. No. 01707 (PIT-106845-PCT)) entitled “DISCOVERY OF τ-HOMOLOGY IN A SET OF SEQUENCES AND PRODUCTION OF LISTS OF τ-HOMOLOGOUS SEQUENCES WITH PREDEFINED PROPERTIES” and filed Sep. 18, 2009, which claims priority to U.S. Provisional Patent Application 61/098,599 (Atty. Dkt. No. 01707/PITTP112US) entitled “METHOD AND APPARATUS FOR DISCOVERING τ-HOMOLOGY IN A SET OF SEQUENCES AND PRODUCING LISTS OF τ-HOMOLOGOUS SEQUENCES WITH PREDEFINED PROPERTIES” and filed Sep. 19, 2008. The entirety of the above-noted applications are incorporated by reference herein.

### NOTICE ON GOVERNMENT FUNDING

This invention was made with government support under grants #CA090440 and #CA047904 awarded by the National Institutes of Health. The government has certain rights in the invention.

### BACKGROUND

Conventional approaches to disease prognosis either focus on individual parameters without considering relationships between parameters, or use models that explicitly consider full data relationships, where intractably large sets of interaction terms are required. The former approach ignores meaningful information in the data set, and the latter approach nullifies the power of any realistic clinical study.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a method of analyzing relationships between parameters in data matrices (e.g., collections of individual informative profiles). A graph topology can be defined on a data matrix with partitions as variables and vertices in all partitions and their potentials represented by the variable values or function thereof and edges as the co-occurrence of a pair of variable values in a profile. Individual graphs can be constructed from data and value co-occurrences for every profile, and a study data graph is then made as a union of all individual graphs. Heterogeneity Landmarks (HLs) can be determined from the study data graph, and graph-graph distances determined between individual graphs and all HLs. These distances are based on similarity of a profile to one or more HLs and can be used as parameters in schemes for prognoses

In another aspect of the subject innovation, embodiments can include systems that can facilitate network phenotype strategy techniques for characterization of data matrices. One such embodiment can include an input component that can receive a data matrix comprising a plurality of informative profiles. Each profile can comprises a plurality of values, and each value can be associated with a distinct parameter of a plurality of parameters. Such a system can also include a topology component that can define a graph topology associated with the data matrix and a graph component that can construct a plurality of individual graphs associated with the plurality of profiles. The graph component can also construct a cumulative data matrix graph as the union or another construct of the individual graphs. The system can further include a reference relationship pattern component that can determine a plurality of reference relationship patterns (RRPs) from the data matrix graph and a distance component that can compute the graph-graph distances between the plurality of individual graphs and the plurality of RRPs. The distance component can also define proximities of the plurality of individual graphs to the plurality of RRPs based at least in part on the computed graph-graph distances.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a system that can facilitate characterizing subtypes of a collection of data profiles (e.g., patient profiles, etc.) via NPS techniques in accordance with aspects of the subject innovation.

FIG. 2 illustrates a flowchart of a method of applying NPS techniques to identifying clinically relevant subgroups in connection with a disease in accordance with aspects of the subject innovation.

FIG. 3 illustrates a flowchart of employing NPS techniques in connection with entromic data to optimize and manufacture personal prognostic tools for heterogeneous subgroups previously identified via NPS techniques in accordance with aspects of the subject innovation.

FIG. 4 illustrates a method of applying NPS techniques to data sets involving both genetic assays and clinical assays in accordance with aspects of the subject innovation.

FIG. 5 illustrates considerations in an optimization procedure for production of biologics.

FIG. 6 illustrates a conceptual scheme showing the effect of clinical context on personalization of patient information in clinical data processing.

FIG. 7 illustrates an example 10-partite individual clinical profile of a patient and associated cycle graph.

FIG. 8 illustrates four selected pairs of liver test parameters with maximal sum of pairwise correlation coefficients for hepatocellular carcinoma (HCC) phenotyping.

FIG. 9 illustrates an edge-weighted study graph for an HCC application of the subject innovation.

FIG. 10 illustrates the full decomposition of the single schema of all networked context relationships in the study data into reference clinical profiles for an HCC application of the subject innovation.

FIG. 11 illustrates determination of a personal distance vector in connection with an HCC application of the subject innovation.

FIG. 12 illustrates an example of using projections of the all-level multidimensional clinical parameter relationship networks into 3D and 2D components defined by selected pairs of personal distance vector components from specific reference relationship subgraphs of a full disease-characterizing k-partite edge-weighted graphs.

FIG. 13 illustrates a modified Kaplan-Meier (KM) characterization of odds for a given tumor mass in S (small tumor)-subgroups and L (large tumor)-subgroups in connection with an HCC application of the subject innovation.

FIG. 14 illustrates clinical profiles associated with the S and L-phenotypic groups and the similarities and differences of the levels in the associated parameters.

FIG. 15 illustrates differences in typical parameter level trends as function of tumor mass in S- and L-subgroups.

FIG. 16 illustrates differences in typical trends of AST/ALT ratio for the S- and L-subgroups.

FIG. 17 illustrates box plots of significant differences in distributions of tumor mass and survivability for the S- and L-subgroups, along with plots of survival probabilities.

FIG. 18 illustrates the results of examination of differences in patterns of trends between platelets and other parameters in the S- and L-subgroups.

FIG. 19 illustrates an example of how a parameter change impacts the relationship pattern.

FIG. 20 illustrates box plots of the significant differences in distributions of tumor masses for the S- and L-subgroups of HCC patient subgroups and the differences in overall survival in days for the two subgroups.

FIG. 21 illustrates he results of systematic analysis of single-parameter change in S-tumor reference relationship profiles (RRPs) on the odds used to diagnose phenotypes.

FIG. 22 illustrates he results of systematic analysis of single-parameter change in L-tumor RRPs on the odds used to diagnose phenotypes.

FIG. 23 illustrates an example of the three types of response of an RRP to a single parameter change.

FIG. 24 illustrates a screenshot of an implementation of the subject innovation via the Excel platform, together with images of identified HCC reference profiles and S- and L-subgroup diagnosis.

FIG. 25 illustrates a maximal cut for an application of the subject innovation to genetic factors involved in chemotherapy response, and the resulting pairing of the six pathway-specific data.

FIG. 26 illustrates reference relationships and distance vectors classifying responders to chemotherapy from non-responders and independent Kaplan-Meier survival analysis in the NPS-diagnosed responder and non-responder subgroups.

FIG. 27 illustrates an example of an experimentally determined CTLA-4 genotype for a patient, and its transformation into graphs of personal relationship profiles for the patient.

FIG. 28 illustrates study graphs constructed as unions of all personal CTLA-4 genotype relationship profiles.

FIG. 29 illustrates three examples showing how elements of distance vectors are computed for the same patient.

FIG. 30 illustrates decomposition of study graphs for healthy controls and melanoma cases into component cycles.

FIG. 31 illustrates case-control discrimination based on a “missing” CTLA-4 genotype reference profile.

FIG. 32 illustrates selection of the maximally case-control survival discriminating combination of distances from all RRPs.

FIG. 33 illustrates a histogram of patients with observed valued of Δ(ij), showing heterogeneity of distributions of healthy and sick individuals shown in the CTLA-4 genotype landscape.

FIG. 34 illustrates the actual composition of reference CTLA-4 genotype patterns for discrimination between melanoma cases and controls.

FIG. 35 illustrates a comparison of RRPs, distances from which are most significantly different in the two survival groups.

FIG. 36 illustrates a computer-readable medium or computer-readable device comprising processor-executable instructions configured to embody one or more of the provisions set forth herein, according to some embodiments.

FIG. 37 illustrates a computing environment where one or more of the provisions set forth herein can be implemented, according to some embodiments.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

In various embodiments, systems and methods of the subject innovation can employ mathematical techniques discussed herein (e.g., k-partite graph based formalism, etc.) for subtype (e.g., phenotype, etc.) characterization and prognosis determination in a variety of settings, such as clinical data analysis for disease prognosis, treatment diagnosis, personalized medicine, in manufacturing biologics (e.g., via quantification of the impact of vector incorporation on the production cell biosystem in the context of one or more sets of technological parameters, etc.).

In aspects, systems and methods of the subject innovation can facilitate identification of disease subtypes and can use resulting sub-classifications in a variety of settings, such as for outcome or therapy result prognosis with functional interpretation that can be applied in connection with personalized medicine, such as via design of a Personal Prognostic Tool, etc.

In various embodiments, the subject innovation can employ techniques described herein to extract new information from personal clinical data and high throughput assay results by replacing analysis of clinical parameter values by the simultaneous analyses of these values and relationships between them. This complex process can be accomplished by Network Phenotyping Strategy (NPS) systems and methods of the subject innovation. Additionally, although many of the example applications discussed herein involve phenotypic characterization in connection with diseases and associated characterization and prognosis determination, the subject innovation can be employed in a wider variety of settings, as explained herein and as would be apparent to a person having ordinary skill in the art in light of the discussion herein.

In another embodiment, after NPS processing of a data set (e.g., sequencing data, high-throughput assays, etc.), the resulting Personal Prognostic Tool can include identified composition of matter (e.g., enzymes, cells, segments of DNA probes, molecular targets for therapy or drug intervention, etc.) that can then be used in various embodiments, for example, as part of an NPS-designed assay kit, NPS-designed diagnostic procedure, NPS-designed manufacturing scheme, etc.

Conventional approaches that explicitly consider full data relationships require models with intractably large sets of interaction terms, which nullify the power of any realistic clinical study. In NPS techniques employed in connection with the subject innovation, however, theorems of discrete mathematics and graph theory are applied to formulate original algorithms. This can be applied, in one example setting, by converting raw clinical data into clinically interpretable distances between personal and reference clinical profile network graphs. Through this and similar applications described herein, the power problem can be solved. Instead of using simple data in prohibitively complex models, NPS techniques of the subject innovation can use manageably complex data in simple models.

By processing graph distances (e.g., clinical graph distances, etc.) as multi-informative inputs that capture both parameter values and parameter value relations relationships in a minimal number of numerical quantitative descriptors, NPS techniques employed herein can provide a variety of novel insights.

Continuing the clinical example for the purposes of illustration, NPS techniques can provide new functional and personalized disease-related insight even with “just” classical clinical or clinical practice data (medical records, screening databases etc.). If any additional, “molecular” data and/or results are available (either from literature or experiments), embodiments of the subject innovation can utilize an entromics-derived genome-wide network of function-linked relationships between genes, gene groups or pathways as underlying general, but also personalization-capable, trans-disease information structure that can be incorporated directly into the processed clinical profile network.

In experiments discussed herein, NPS analysis of enhanced clinical profile networks was shown to discover, highlight and functionally prioritize novel function related associations in data to complex phenotypes and their components. One of the reasons for this efficiency and the functional significance of obtained results is the fact that NPS techniques discussed herein can identify clearly separable heterogeneous subgroups in clinical cohorts.

Models obtained via NPS techniques of the subject innovation reflect the actual structural relationships involved in what is modeled. For example, in the clinical setting, predictive or diagnostic quantitative disease models built with NPS techniques, data and algorithms reflect the actual function-related disease structure. In experiments discussed herein, these models were shown to work even in situations where previous analyses failed. Embodiments of the subject innovation employing NPS techniques in a clinical setting have potential for highly clinically relevant hypothesis generation, which challenge current thinking and provide insight into complex biological phenomena.

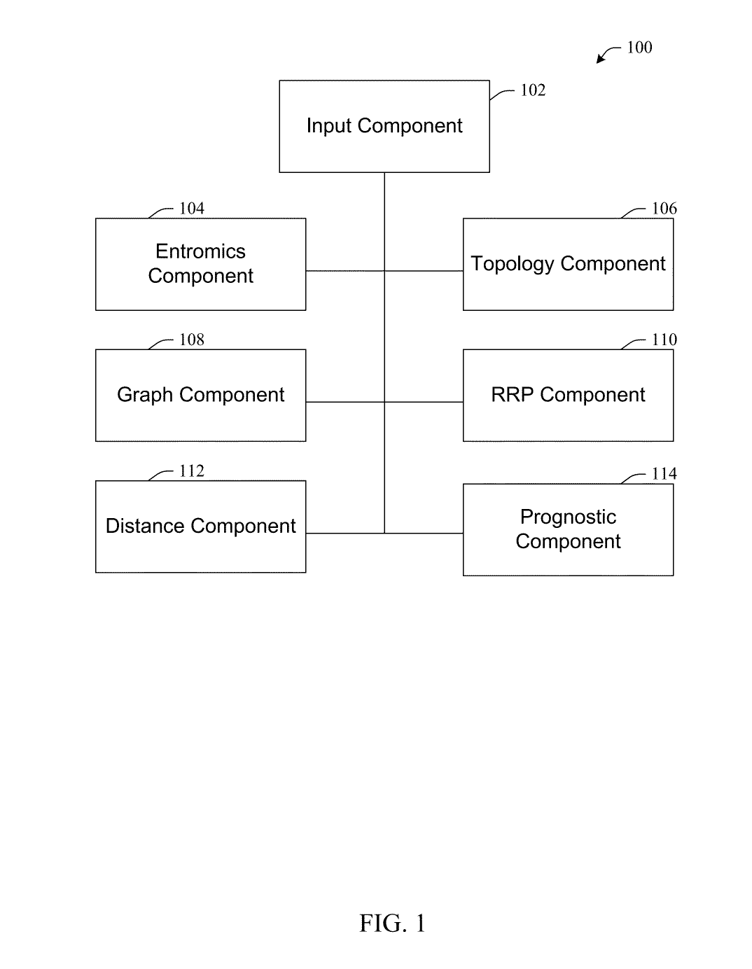

Referring initially to the drawings, FIG. 1 illustrates a system 100 that can facilitate characterizing subtypes of a collection of data profiles (e.g., patient profiles, etc.) via NPS techniques in accordance with aspects of the subject innovation.

System 100 can include an input component 102 that can receive a data matrix that comprises a plurality of profiles (e.g., with each data profile associated with a different patient in a diagnostic embodiment, etc.), wherein each profile comprises a plurality of variables (e.g., clinical, genomic, etc.) and arbitrary values (e.g., binary or n-ary, real number, arrays, character strings, or substantially any value of a plurality of values) for each of a plurality of parameters. In some embodiments, at least a portion of the data matrix (e.g., one or more variables for each profile, etc.) can be received from an entromics component 104, which can provide variables and associated values based on function-linked relationships between genes, gene groups, pathways, etc. (that can be determined by entromics component 104) to input component 102.

A topology component 106 can be included that can define a topology in connection with the data matrix, which can be used for construction of graphs associated with the data matrix and individual profiles. Topology component 106 can define partitions as variables and vertices in all partitions and their potentials. The selection of values or thresholds for vertex definitions can be via data driven discretization of real-valued variables if needed. In various aspects, these vertices can be expert-defined (e.g., received via input component 102, etc.), whereas in other aspects these vertices can arise naturally from the data (e.g., dichotomies such as yes/no, male/female, etc.), or can be derived via analysis of the data by topology component 106 (e.g., tercile thresholds, 50/50 thresholds, etc.). Topology component 106 can define edges as the co-occurrence of a pair of variable values in a profile, for example, as actual results (e.g., laboratory results, survey answers, etc.) of data accrual for a person.

Graph component 108 can define an individual graph (personal relationship pattern (PRP), etc.) for each profile of the data matrix from the actual values and value co-occurrences for each profile in the data matrix. Graph component 108 can then construct a data matrix graph as the union of all individual graphs (individual PRPs), defining vertex weights as the function, derived from the associated variable values and edge weights as the total number of co-occurrences in individual profiles of associated pairs of variable values.

Reference relationship pattern (RRP) component 110 can determine a plurality of RRPs (or heterogeneity landmarks (HLs), reference profiles, reference subgraphs, or reference relationship subgraphs) associated with the data matrix, for example, by using a greedy algorithm (e.g., extracting sequentially the co-occurrence relationship profiles that had the highest frequency in the dataset and repeating this process until there was no relationship left) to decompose the data matrix graph into the RRPs in such a way that all co-occurrence frequencies between all the parameter levels in each RRP are identical.

Distance component 112 can compute graph-graph distances for each combination of individual graph and RRP. Based on these distances, the data matrix can be characterized and diagnostic phenotypes can be identified (e.g., as collections of relationships to one or more RRPs, as common variables among collections of relationships to one or more RRPs, etc.). This can include defining proximities of individual graphs to RRPs based at least in part on the computed graph-graph distances.

In aspects, prognostic component 114 can be included, which can generate prognostic information for one or more additional profiles not associated with the data matrix (e.g., new patients, etc.). Graphs for each of these additional profiles can be constructed and relationships, such as distances from each of the RRPs can be determined as described above. Based on the relationships, such as distances from the RRPs, a prognosis can be generated based on degrees of closeness to one or more RRPs and known prognoses associated with the one or more RRPs.

Although system 100 and associated NPS techniques can be applied in a variety of settings, for the purposes of illustration, a clinical embodiment that can facilitate identification of phenotypic categories is discussed herein. In such a setting, system 100 and/or NPS techniques can facilitate characterizing clinically relevant and different phenotype, disease or treatment outcome subgroups of patients that are internally more homogeneous in their complete (intra-group) clinical profiles compared to maximized inter-group heterogeneity between any two of these non-identical phenotypes, disease or treatment outcome subgroups.

In aspects, such methods and systems of the subject innovation can implement algorithms that can facilitate quantitative capturing of the complete set of diverse multivariable (e.g., clinical, demographic, psychological, epidemiologic, environmental, genetic, biological, etc.) parameter relationships into the mathematical structure of an edge-weighted complete graph with potential-weighted vertices.

Additionally, these embodiments can implement algorithms that can employ an information-preserving simplification of complete graphs into k-partite edge-weighted graphs with potential weighted vertices (e.g., clinical demographic, psychological, epidemiologic, environmental, genetic, biological etc. potential weighted vertices).

Such embodiments can further implement algorithms that can facilitate extraction of reference relationship subgraphs of the full (e.g., disease-characterizing, etc.) k-partite edge-weighted graph with potential weighted vertices (e.g., clinical demographic, psychological, epidemiologic, environmental, genetic, biological etc. potential weighted vertices) describing the idealized complete all-order relationships between parameters (e.g., clinical demographic, psychological, epidemiologic, environmental, genetic, biological etc. parameters) in the (e.g., clinical) relationship profiles.

Moreover, these embodiments can implement algorithms that can facilitate capturing the complete all-order relationship between parameters (e.g., experimental clinical, demographic, psychological, epidemiologic, environmental, genetic, biological etc. parameters) for each individual patient into a k-partite graph, which in some embodiments can be a cycle graph.

Further, such embodiments can implement algorithms that can utilize the multi-dimensional graph-graph distance vector elements or their subsets as all-order parameter-parameter relationship defined input variables in the quantitative classification, distance relationship pattern-based schemes, optimized to characterize, recognize and predict the complex phenotype, disease or treatment outcome subgroups of patients. These subgroups are internally more homogeneous in their complete (intra-group) clinical profiles compared to maximized inter-group heterogeneity between any two of these non-identical phenotype, disease or treatment outcome subgroups.

Additionally, these embodiments can implement algorithms that can compute graph-theoretical distances as elements of the multi-dimensional graph-graph distance vector between an individual patient k-partite cycle graph and all the reference relationship subgraphs of the full disease-characterizing k-partite edge-weighted graph.

Moreover, such embodiments can implement algorithms that can utilize “majority voting” principle to define the various implementations of graph-graph distance vector elements characterizing closeness or diversity of the individual patient clinical parameter relationship graph from the reference relationship subgraphs of the full disease-characterizing k-partite edge-weighted graph, thus allowing a model that can encompass the inter-patient variability in parameter relationship while keeping clinical relevance and direct interpretability of the classification process.

In further aspects, embodiments of the subject innovation can facilitate identification of the functional basis for the inter-group heterogeneities between any two of the non-identical subgroups (e.g., phenotype, disease, treatment outcome, etc.) defined via NPS techniques.

Such aspects can implement algorithms for tools (e.g., pathway-based, systems biology-based, bioinformatics-based, clinical practice data-based, insurance database-based, experimental screening data-based, empirical, statistical, entromic coherence based etc. tools) that can identify target pathways and their molecular components, as well as their relationships and functional relevance for the mechanistic and clinical outcome identification of target processes and their candidate target or regulatory molecular or systems biology components.

These aspects can additionally implement algorithms for identifying candidate target biomolecules such as DNA, RNA, genes, enzymes, proteins, their complexes and their systems biology relationships, etc., that are responsible for inter-group heterogeneity. In such aspects, the identified components can include, at least in part, one or more of a gene sequence, at least one of a structural level, a functional level, etc. The functional level can include at least one of a conformation, a dynamic stability behavior, a polymorphism, genetic variation, or mutation effect on at least one of a disparate gene sequence or a product of transcription of a gene sequence, where the product of transcription can be natural or synthetic. In some further aspects, the target molecules, structural levels and/or functional levels can be different but specific for each heterogeneous subgroup identified as discussed above.

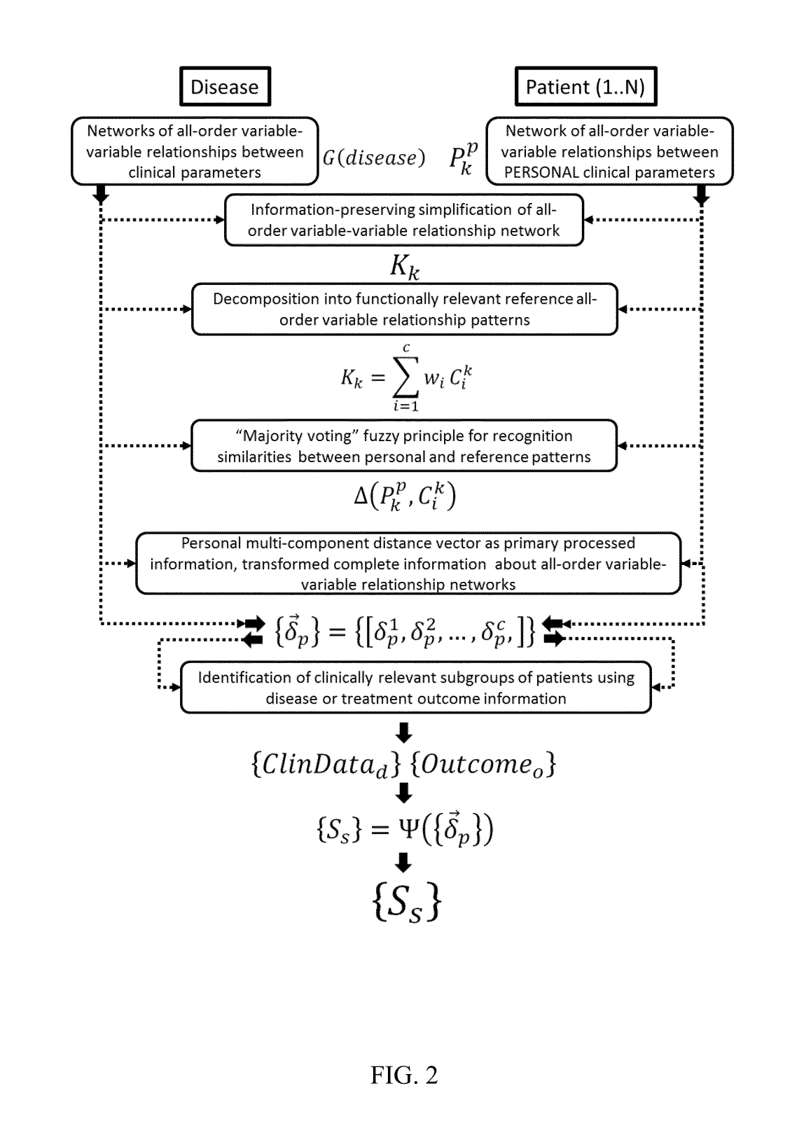

In other aspects, as illustrated in connection with FIG. 2, showing a flowchart 200 of a method of applying NPS techniques to identifying clinically relevant subgroups in connection with a disease, the subject innovation can include systems or methods that can facilitate characterization and design of a k-partite graph that can represent the all-order relationship networks of disease-describing clinical variables. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

In aspects, methods employing NPS techniques of the subject innovation can include the following acts. Starting with some data matrix (e.g., collected clinical data for multiple patients) that has multiple (e.g., 4139 subjects, etc.) profiles, with each profile having multiple clinical variables with arbitrary values (e.g., continuous test/assay results, categorical patient information (male/female, result of HIV test +/−, questionnaire answers (“did you ever drink alcohol?”, etc.), results of literature search, etc.) for each of a number of parameters. Using expert knowledge or data-driven analytical methods, the clinically relevant values, ranges, intervals etc. of every such variable from the set of multiple variables that define the patient's clinical profile can be identified and their clinical relevance can be validated. These intervals can then serve as the definition of vertices in associated NPS graph. Each set of vertices representing value ranges of one variable define one partition in the NPS graph. The characteristic values (such as medians, etc.) of these intervals or ranges for each variable (in one partition) define the respective vertex potentials. Edges in the NPS-k-partite graph representing the clinical profile of a single patient can be defined as the connection of all value intervals or ranges that were simultaneously observed in the actual clinical profile of that patient. For each patient, an individual graph can be constructed from the individual profile using the actual co-occurrences of all variable values, intervals or ranges as identified in actual individual test/assay/questionnaire etc. results defining the clinical profile. Using all of these personal complete k-partite graphs, a cumulative graph can be constructed as an edge-weighted (with edge weight equal to how many individual patient profiles have the pair of parameter values, defined by each edge) complete k-partite graph with potential-weighted vertices. Reference subgraphs (corresponding to reference profiles) can be extracted from the cumulative graph. The graph-graph distances between the individual graph and at least some or all of the reference subgraphs extracted from the complete k-partite graph (e.g., distances from reference subgraphs identified as significant in terms of a prognosis) can be determined for each individual profile. A prognosis can then be generated for an individual (or test) profile based on the determined distances.

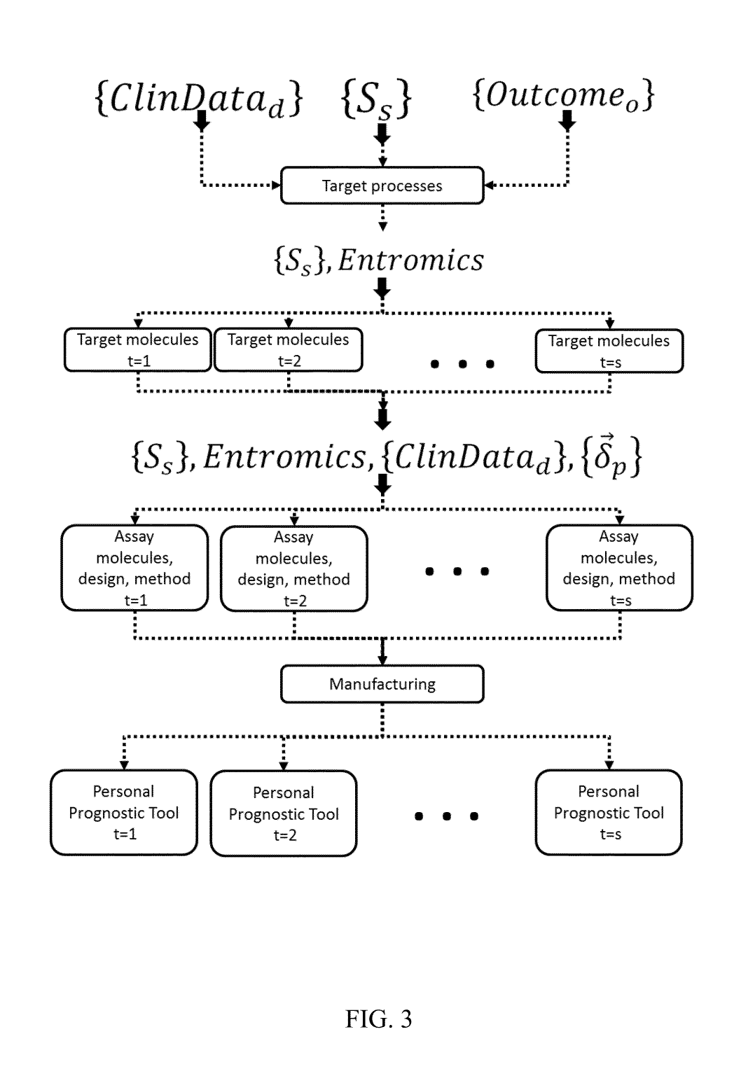

In further aspects, as illustrated in connection with FIG. 3, showing a flowchart 300 of employing NPS techniques in connection with entromic data to optimize and manufacture personal prognostic tools for heterogeneous subgroups previously identified via NPS techniques. Entromics applies physical principles to genomic information to quantitatively characterize important properties of genomes, identify different but functionally similar genetic expressions, etc. Entromics and applications thereof are discussed in pending U.S. patent application Ser. No. 13/063,832, entitled “DISCOVERY OF τ-HOMOLOGY IN A SET OF SEQUENCES AND PRODUCTION OF LISTS OF τ-HOMOLOGOUS SEQUENCES WITH PREDEFINED PROPERTIES” and filed Mar. 14, 2011, the entirety of which is incorporated herein by reference. In aspects, systems and methods of the subject innovation (e.g., system 100, etc.) can include an entromics component that can characterize genetic variants via deterministic state-function defined descriptors. Entromically-characterized genetic variants can be incorporated as genetic information in graphs and reference profiles constructed via NPS techniques of the subject innovation. This information can provide for personalization of diagnostic and prognostic aspects of the subject innovation based on patient profiles incorporating both clinical and genetic information.

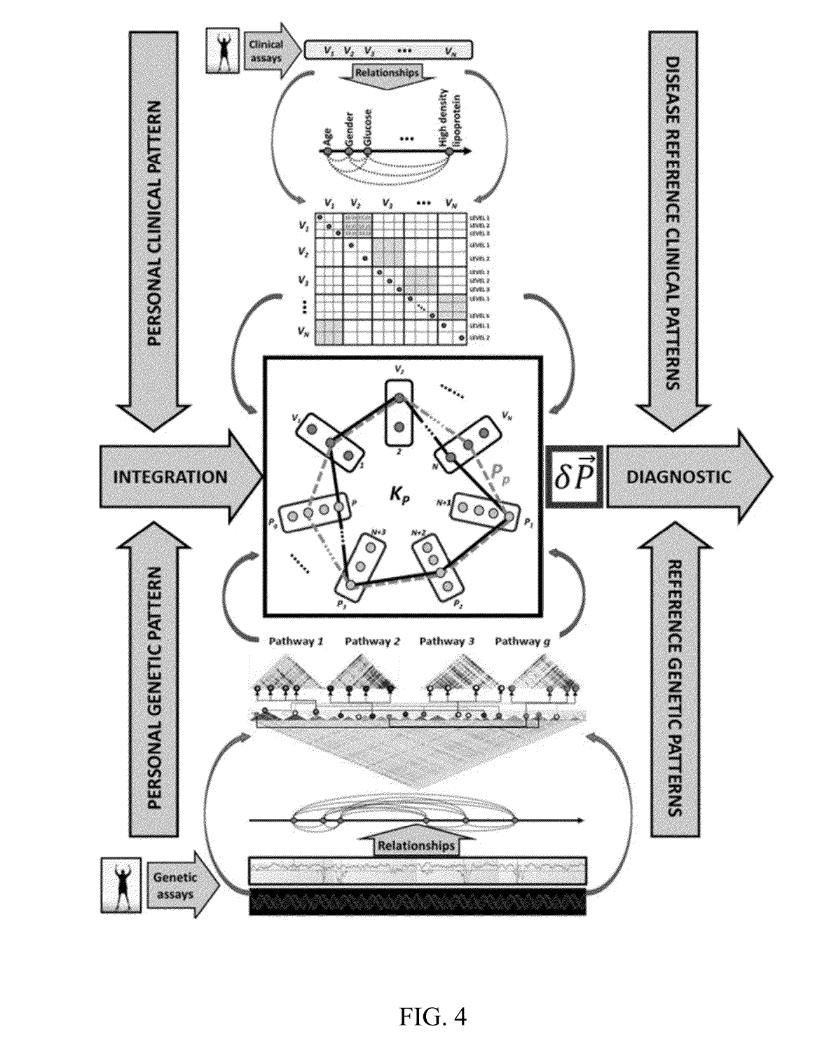

In aspects, FIG. 4 illustrates a method of applying NPS techniques to data sets involving both genetic assays and clinical assays. Data associated with patients in the data set can, in general, include both clinical parameters and genetic parameters. Genetic parameters can be analyzed (e.g., via entromics) and incorporated into the same graphs via NPS techniques described herein, such that reference profiles can be identified that can, in general, include both genetic and clinical patterns in the same profile. These profiles can be used for diagnostic or prognostic purposes as described herein, for hypothesis generation (e.g., of disease causation, progression, etc.), etc.

The ability of NPS to combine diverse types of informations into workable models can combine clinical or environmental parameters with the genetic information for a patient and can be thus used as the part of the multi-dimensional characterization of patient's clinical status and for diagnosis of personal disease subtypes such as described herein.

In some aspects, the genetic information can be combined into NPS in the “conventional” present/absent genetic variant style, such as described in connection with an example below. However, in aspects, entromics techniques can be employed as a tool to process the genetic information, which can broaden how the personal genetic information can be included into the clinical relationship pattern based NPS processing and diagnosis tools.

Entromics techniques can be used to process personal genetic information before it becomes part of the NPS-transformation into diagnostic tool. Entromics techniques can characterize every variant by numerous deterministic state-function defined descriptors. These can include: (1) the sequence-context computed change (difference) in the incorporation entropy induced by any assayed variant in the personal genomes or their assayed parts (e.g. single genes, gene segments, chromosomes etc.)—this is a difference vector (e.g., which can have as few as six and as many as several 10⁶ incorporation differences—differences can be computed relatively to the entropy of the consensus genome, which has in all positions major alleles, and the results do not depend on the particular choice of the reference genome); (2) the sequence-context computed change (difference) in the incorporation entropy coherence network induced in this whole-genome spanning network by all assayed/identified variants in the personal genomes.

One advantage of entromic pre-processing of the genomic information is that these entropy and entropy coherence differences are additive. All personal differences can be collected in genome regions where it is known that genes of particular pathways or biological, disease-related function are localized. At the same time, if the information about these pathways or processes is missing or includes just one or few variant, the network of strongest incorporation entropy coherences, computed for the reference genome (which is 99.9% identical for all humans) can identify additional, previously unknown genome regions and genes, about which the disease-related information is missing, not yet studied, etc., but for which assayed personal genomic data is available for them (from whole genome microarrays, whole genome sequencing etc.).

The differences in the incorporation entropy and incorporation entropy coherences in these entromically-linked (by coherence) regions can then be additively combined into descriptors of selected pathways functions, comprising the personal descriptors of the genome variants in the genes included in these groups. The genes included in these descriptors can be the “targets” in NPS techniques of the subject innovation.

Thus, once all the data from personal genotyping assays is transformed into entromic-based differences between the pathways and functions (e.g., using a particular biological functional model that is tested for optimal performance against numerous alternative ones), these differences can be used in connection with NPS techniques, allowing the further personalization of these individual patient's characteristics by considering them in the contexts of their classical clinical, demographical etc. states and relationship patterns.

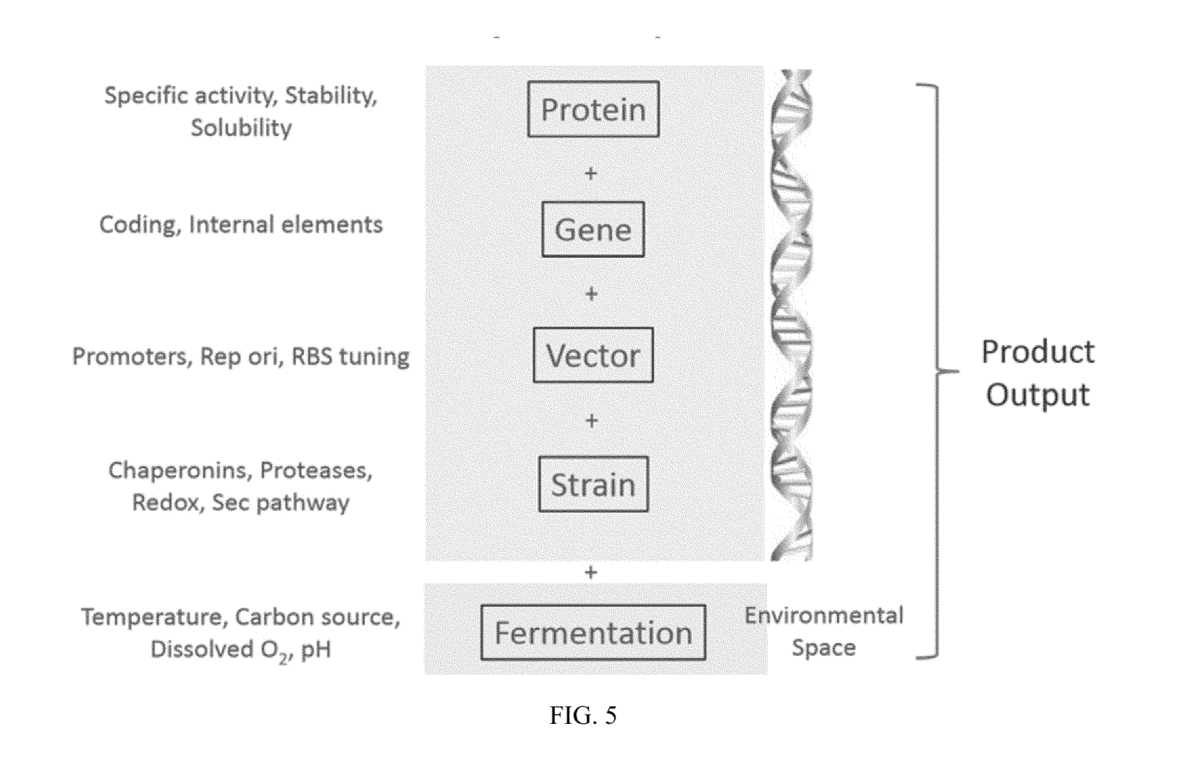

In some aspects, NPS techniques can be employed for optimization of the production of biologics in bio-reactors. FIG. 5 illustrates considerations in an optimization procedure, which in conventional methods are linearly performed steps. In accordance with aspects of the subject innovation, NPS techniques can be employed in connection with entromic techniques to efficiently and effectively obtain biologics.

Entromics techniques can be employed to characterize various variants of the biologics gene/vector, and their (relative) impact on the function of the cells or the organism(s), that are used in the fermentation production of biologics. NPS techniques can allow integration of that cell-based information with information about the parameters of the fermentation process. The NPS/Entromics integrated and processed data can then be used in optimization of the vector composition of matter and simultaneously in the biological context considered fermentation parameters, to obtain the (generic) biologics protein within the specifications of the original biologics drug, so the manufactured generic product can be cost-effectively approved and sold.

In aspects, the subject innovation can apply entromics and NPS techniques to optimize production of biologics. Entromics can be used to quantify the biosystem perturbation that an introduction of the (foreign) vector causes in the host cell genome optimal status. This perturbation impacts the stabilized coherence network of incorporation entropy, used for long-range communication between the genes through controlling their expression rates. These networks include genes active in the post-translational processing of the desired biologics product. It is therefore possible to characterize and computationally optimize the vector-incorporation impact on these genes in the host genome in the full context of the rest of the genome.

Entromics allows for real time in silico characterization and optimization of the various choices of the vector coding in the complete host genome, and in particular of genes/pathways responsible for the post-translational modifications (such as protein kinases and phosphatases, cyclases and synthases in the phosphorylation pathway), via the proven additiveness of the perturbations in the network. This feature allows for construction of sensitive and informative descriptors of regulation and expression rates, and for determining the impact of the vector on the production cell.

The combination of NPS and entromics techniques can enable quantification of the impact of the vector incorporation on the production cell biosystem in the context of one or more sets of technological parameters (e.g., “Fermentation” in FIG. 5).

For E encodings, the ranges of the differences in the coherence network blocks for the phosphorylation and glycosylation factors can be divided into sub-intervals, which can be used as the vertices in the NPS graph.

The same procedure can be done (e.g., utilizing expert knowledge) with the parameters describing the fermentation technology. Integration of these partitions (genetic and fermentation) into one NPS graph provides the integrated phenotype/genotype personalized characterization of the biologics production system.

This integrated NPS graph can be processed using the same NPS techniques described herein in connection with other applications (e.g., disease diagnosis, etc.). In particular, the phenotype patterns (PP) for different in silico generated sets of fermentation parameters together with entromic ally-characterized descriptors of the vector influences on the biological purity and status determining pathways can be combined into a “process graph”, with vertex potentials and edge weights defined analogously to other weighted graphs representing data sets discussed herein.

This “process graph” can be decomposed into reference subgraphs (process heterogeneity landmarks (pHL)) and the distances from all identified pHL's of every PP, each characterizing a specific combination of fermentation parameters and cell biosystem perturbation, can be computed. The vectors of these distances represent the NPS transformed data, which can be entered into an optimization algorithm, to determine the best output, defined by the desired purity/quality parameters of the biologics product.

In various aspects, embodiments employing entromics data can characterize target processes or target molecules for various disease, outcome, or treatment subtypes. Additionally, such embodiments can facilitate design of subgroup-specific personalized computational, molecular and experimental protocols associated with the disease, outcome or treatment assay, developed separately for all identified heterogeneous subgroups.

### Mathematical Foundations of Network Phenotyping Strategy Techniques

Understanding the roles of genetic, clinical, personal, environmental and other health-related factors of risk of disease or treatment outcome requires a quantitative, personalized approach to capturing information about often heterogeneous and complex disease phenotypes from available clinical data. One consideration in developing adequate analytical methods suitable for this purpose is defining a descriptor with the ability to capture the complex sets of interactions between the clinical data. These interactions are responsible for multi-parameter contexts in which the actual data values are providing relevant prognostic or diagnostic information. Problems with proper elucidation of actual role of biological, genetic, demographic and other factors, underlying the disease processes and associated complexity can arise when underlying factors are assumed to interact with each other in unpredictable ways. With such a premise, the associations between the phenotype and any single factor taken without the full context may be imperceptible. Uncharacterized interactions (e.g. epistasis and genotype by environment interactions) could cause the phenotype to be inaccurately predicted from knowledge of the individual effects of each of the component factors when considered alone, no matter how well understood the separate components may be. Without tools capable of capturing the architecture of complex phenotypes in the context of all available biological as well as clinical information, the progress towards functional understanding of this complexity and ultimately towards personalized medicine might be intractably difficult.

The development of a model (e.g., quantitative, mostly empirical) is a highly informative step in clinical data analysis, allowing prediction of the dependent variable (such as disease risk, or disease/treatment outcome) from the rest of the clinical data, considered as independent variables or variable constructs (vectors). Development of these models can be seen (e.g., in terms used in artificial intelligence, neural networks, etc.) as optimizing the model function parameters by some algorithm, using the paired independent—dependent parameter variables in the reference data (training set). This optimization is improved when there are no empty areas in the training data space.

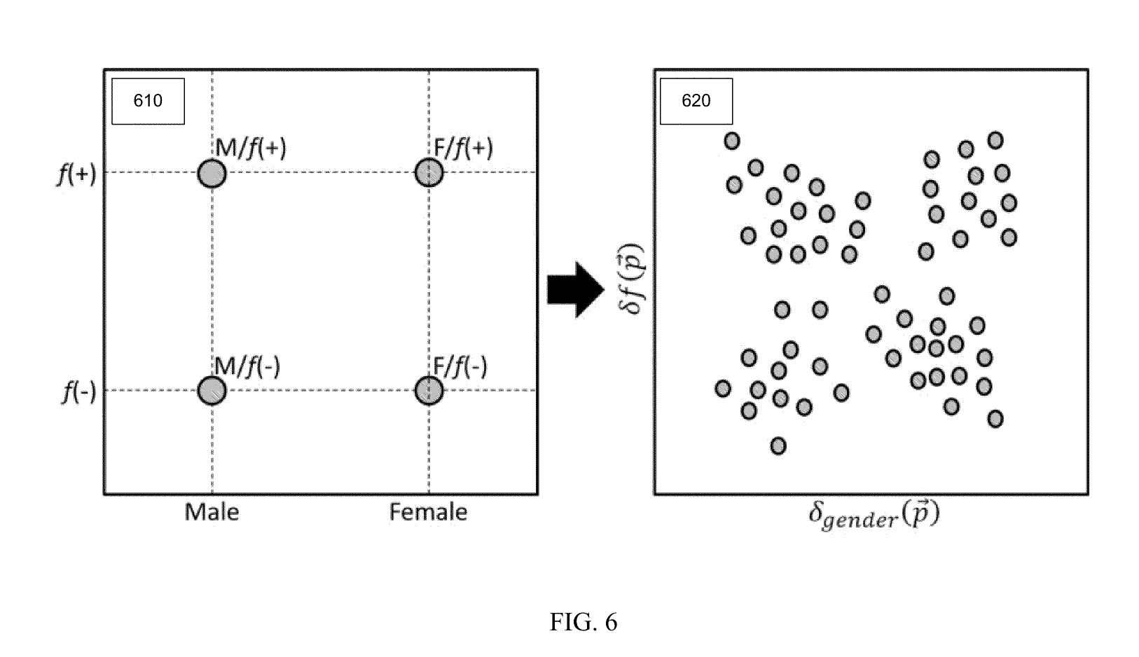

FIG. 6 illustrates a conceptual scheme showing the effect of clinical context on personalization of patient information in clinical data processing. As can be seen at 610, for paradigms with independent data, the information space is effectively empty when, for example, male and female patients with (+) or without (−) some syndrome are considered independently. However, at 620, in the more realistic actual situation, achievable in personalized paradigms such as generated via NPS techniques of the subject innovation, where the networks of other, functionally relevant relations, differentiate individually between the originally “sharp” gender and presence/absence values of clinical variables. This generates a better coverage of the information space, but depends on deriving the personalized distances δ(\vec{ξ}) from the parameter relationship networks.

Non-informative areas in the training data spare are regions of the parameter-parameter relationship (projected into the lower-dimensional basis-vector defined plane) where there is no information, either due to sparsity of the training data (there are not enough patients in the study who would have all possible combinations of parameter values) or because of the very nature of the data, such as in 610, which considers the very common example of a relationship between two categorical variable such as male(M)/female(F) gender and low/high dichotomized level of some clinical factor f (where f high present=f(+), f high absent=f(−)). Both parameters have only two discrete levels, and the projection of their relationship into gender/factor plane includes just 4 discrete point in that plane (M/f(+), M/f(−), F/f(+) and F/f(−)).

In accordance with aspects of the subject innovation, NPS techniques discussed herein can quantitatively derive the new “dispersed” positions of 610 representing the patient's clinical vectors in the complete clinical status space. Using the information available in the tables of raw clinical data, this resource can be used to recover the necessary “dispersing” information not directly from these data vectors, but from the complete set of (generalized) relationships between them.

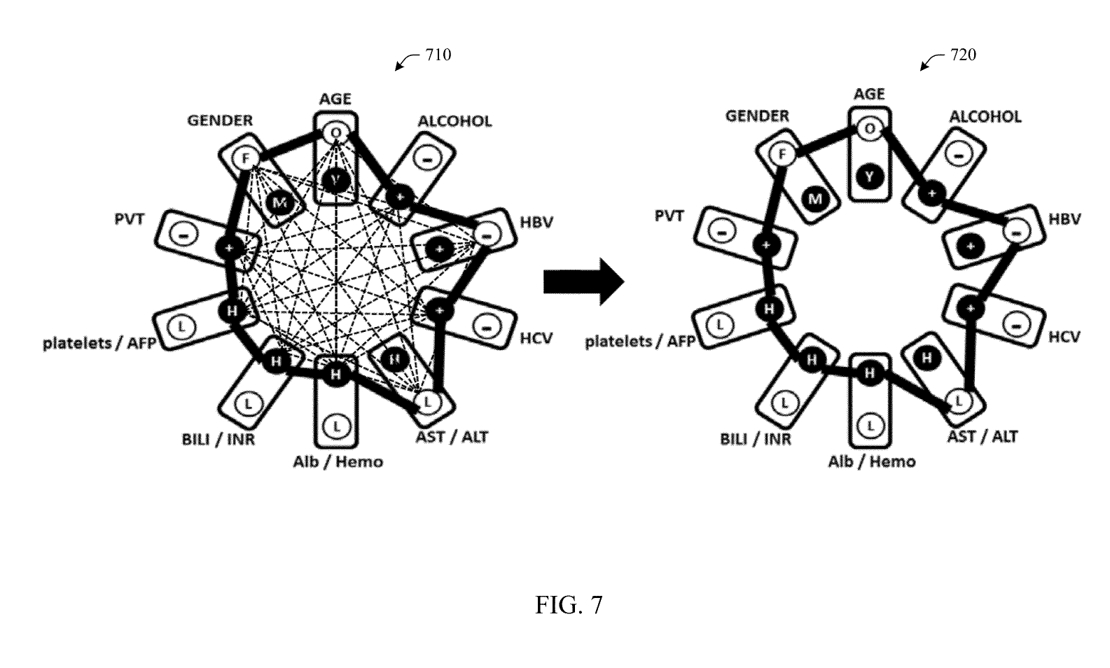

This leads to the graph scheme G, illustrated in FIG. 7, showing an example 10-partite individual clinical profile of a patient at 710, and associated cycle graph, in accordance with some embodiments, at 720. In FIG. 7, F=female, M=male, O=age>55, Y age<55 years, +/−presence/absence of indicated parameter, and H/L—correlated parameter pair levels. The patient's clinical profile can be recovered from this scheme by following the black line. BILI=bilirubin, Alb=albumin, Hemo=hemoglobin. 710 shows the complete (clique) graph G, capturing the full network of the relationships between the clinical data, and 720 shows an associated representation of G by the cycle Pₖ^{p}. All parameter relationships shown by dashed edges in G are implicitly captured by simplified representation via Pₖ^{p}.

Clinical parameter types are represented by partitions in G, and clinical parameter levels are represented by vertices in a specific partition, with each generalized relationship between parameter with clinically relevant level quantification represented by an edge in G. In some embodiments, the subject innovation can represent the group via an associated cycle. The choice of a cycle in an m-partite graph to describe a patient's clinical profile is not only the visually concise representation (so much desired in applications) but can also provide a theoretical advantage. The use of a cycle can link the NPS approach to at least two areas of combinatorial research in discrete mathematics: theory of packing and extremal graph theory. The following is a brief overview of this relationship and its relevance to NPS techniques in general, presented through examples related to clinical data analysis.

In terms of relevance to extremal graph theory, assume there is a data matrix (e.g., received, constructed, or modified as described herein, etc.) consisting of m clinical parameters for t patients. For a given patient, individual clinical data represents

$$( \begin{matrix}m \\ 2\end{matrix} )$$

binary parameter-parameter relationships. These relationships can be represented by a complete graph (i), i=1, . . . , t. These complete graphs can be combined into an m-partite graph H, containing many Kₘ and with every edge of H belonging to a Kₘ. The clinically relevant information can now be collected with a small (or even minimal) number of reference clinical states that carry large (or maximal) useful information. H can be greedily decomposed into edge-disjoint copies of Kₘ. For the case of a simple graph, H may have at most

$$( \begin{matrix}N \\ 2\end{matrix} ) ( 1 - \frac{1}{m + 1} )$$

edges (where N is the total number of vertices in H, N=a•m, where a is the (common) number of levels, considered in a-chotomization for any of the m clinical parameters), the greedy algorithm, which extracts the canonical set of (multi) cycles with consecutively largest weight (i.e., presence multiplicity in H), can be applied to achieve a decomposition of H. Its efficacy in information gathering about context relationships between the parameters and their level can be best understood by analysis of the worst case scenario, that is, of a completely random set of mutual parameter relationships. What will remain in this practically non-informative case is a graph with at most

$$( \begin{matrix}N \\ 2\end{matrix} ) ( 1 - \frac{1}{m} )$$

edges. Thus, the greedy procedure can cover a positive fraction of at least

$$( \begin{matrix}N \\ 2\end{matrix} ) ( 1 - \frac{1}{m ( m + 1 )} )$$

of all the relationships between the clinical parameters, represented by the edges in H.

A notable result of this extremal theory analysis is that, even in the worst case scenario, a positive fraction of covered edges are arrived at, which can be used in various embodiment as the idealized reference clinical profiles (“landmarks” in the clinical parameter space). This result is a strong indication of the efficiency of the greedy algorithm for NPS purposes.

Theory of packing provides further insight into NPS techniques, answering the question about dependence or independence of NPS transformation of the original clinical data on the choice of their ordering in the graphs Kₘ and H. Consider a single subject characterized by m clinical parameters, with mutual quantitative relationships represented by edges between all partition vertices (clinical parameter levels) in the complete graphs (i), for i=1, . . . , t patients. The question is under what conditions NPS results derived from operations on H will and will not be dependent on the order of parameters in the representation of Kₘ simplified into a cycle (i). Combining all t cycles (i) into a graph G (it is actually a multi-graph, or a graph with edges weighted by their multiplicity), the resulting graph is connected and is therefore Eulerian. In NPS data analysis, this m-partite Eulerian graph G will be decomposed into a minimal number of edge disjoint cycles, covering either completely or at least the largest fraction of the parameter inter-relationships, captured by the edges in G. Trivial decomposition of G into multiple copies of selected original patient cycles Kₘ fails the efficient dimensionality minimization condition. The number of Kₘ can be larger than or equal to 2^{m}, so the number of complete parameter relationship types can be much larger than number of patients, resulting in no significant re-occurrences of individual clinical profiles.

There is no known algebraic solution to the problem of generating canonical set of multi-cycles that would guarantee a complete decomposition of an arbitrary (general) G. Thus, to reduce optimally the number of these canonical multi-cycles that will then serve as idealized reference clinical profile landmarks in NPS, G can be greedily decomposed by selecting and sequentially removing the canonical cycles with the largest common weight of all their edges. This need not produce necessarily a complete decomposition of G into m-cycles. To get an insight into this issue, consider the worst case scenario when data are unstructured, i.e., when there is no significant clustering of patient clinical profiles in the study. In this case, the greedy approach to decomposition results in at least 30% coverage of all inter-parameter relationships. However, in the practical examples of data from well-designed clinical studies, complete coverage of the parameter relationships by the greedy-algorithm derived canonical cycles is achieved. Thus the interval of the 30-100% coverage can be considered as a graph-theoretical measure of the degree of coherence and information completeness in the analyzed clinical data.

It is also found that the inter-parameter relationships that remain in G after greedy removal of all most frequent canonical m-cycles contains cycles of length 2m, 3m, . . . , pm, where p is the number of clinical parameter levels. These longer canonical clinical profile cycles may be regarded as a more detailed and informative measure of stability of G. Alternatively, a leftover cycle of length a•m, (a≦p) may be converted into a cycles of length m by switching the certain number of parameter level relationships (“imputing” the presence of a patient with the clinical profile \tilde{K}ₘ that would provide the missing connection) needed for decomposing the a•m cycle into canonical m-cycles, which can be used as clinical landmarks for studying the region of clinical data that have more complicated (or incompletely covered by the study subjects) parameter relationship structure. This phenomenon can be rigorously studied in the context of knot theory, and research in this direction associated with the subject innovation is in formulating an analogy of the cycle double cover conjecture here.

What follows is a more detailed discussion of certain systems, methods, and apparatuses associated with aspects of the subject innovation. To aid in the understanding of aspects of the subject innovation, theoretical analysis and experimental results associated with specific experiments that were conducted are discussed herein. However, although for the purposes of obtaining the results discussed herein, specific choices were made as to the selection of various aspects of the analysis—such as specific clinical parameters available, or application to phenotypic categorization relative to diseases—the systems and methods described herein can be employed in other contexts, as well. For example, various aspects of the subject innovation can be utilized to optimize production of biologics via quantification of the impact of the vector incorporation on the production cell biosystem in the context of one or more sets of technological parameters. In some embodiments, different selections of applications, data sets, clinical parameters, etc. can be selected than those used in the experiments discussed herein, and may have differing characteristics, as explained in greater detail below.

### Example 1

### Phenotypic Categorization and Profiles of Small and Large Hepatocellular Carcinomas

A database of 4139 Taiwanese Hepatocellular Carcinoma (HCC) patients was used to apply NPS techniques to HCC subset identification. Individual parameters for liver function tests, complete blood count, portal vein thrombosis, alpha-fetoprotein (AFP) levels and clinical demographics of age, gender, hepatitis or alcohol consumption, were considered within the whole context of complete relationships, being networked with all other parameter levels in the entire cohort. Four multi-parameter patterns were identified for one tumor phenotype of patients and a separate 5 multi-parameter pattern were identified to characterize another tumor phenotype of patterns. The 2 subgroups were quite different in their clinical profiles. The means of the tumor mass distributions in these phenotype subgroups were significantly different, one being associated with larger (L) and the other with smaller (S) tumor masses. These significant differences were seen systematically throughout the tumor mass distributions. Essential and common clinical components of L-phenotype patterns included simultaneously high blood levels of AFP and platelets plus presence of portal vein thrombosis (PVT). S-phenotype patterns included higher levels of liver inflammatory parameters. The 2 different parameter patterns of L and S subgroups suggested different mechanisms; L, possibly involving tumor-driven processes and S more associated with liver inflammatory processes.

The prognosis and choice of treatments in patients who have hepatocellular carcinoma (HCC) has long been recognized to depend both on tumor factors as well as liver factors and was the basis for the first published classification scheme. This is because HCCs usually arise in a liver that has been chronically diseased (hepatitis or cirrhosis from hepatitis or other causes, or both). Many more complex classification and prognostication schemes have since been published, all of which take these 2 broad categories of factors into account, and patients can die either from tumor growth or liver failure. However, there are additional layers of complexity that need to be taken into consideration. Thus, quite large HCCs can arise in apparently normal (non-cirrhotic liver). Furthermore, many small HCCs do not seem to grow into large HCCs, whereas others do so. Thus, some small HCCs may stay small and others are precursors of larger HCCs. Since a patient can present at any random part of their HCC disease growth process, it is usually difficult to know at what point in their disease process they have been diagnosed. Given the suspicion that the diagnosis of HCC carries within it several subsets of disease, a tercile approach was recently used in connection with earlier experiments to identify HCC subsets at the extreme wings of an HCC patient cohort that had been ordered according to tumor size and then trichotomized into tumor size terciles. On the extreme terciles, a relationship was found between plasma platelet numbers and HCC size. This likely reflected that small HCCs arising in cirrhotic liver for which thrombocytopenia is a surrogate and a larger tumor size tercile without thrombocytopenia. However, it still left the central part of the tumor/disease continuum uncharacterized and unordered into subsets. Furthermore, these results showed a relationship between blood alpha-fetoprotein (AFP) levels, a marker of HCC growth, and blood total bilirubin levels, in a large part of the cohort. This lends support, along with other evidence, to the theory that HCC may not only arise and grow in a cirrhotic milieu, but may even depend on signals from that micro-environment for its biology. Given this clinical HCC heterogeneity, it seems that a single approach does not work for individual prognostic factors, probably because of the absence of significant sub-subset patient separation. In addition, some parameters such as AFP can be elevated in either small or large HCCs.

It was reasoned that attempts to extract new information cannot rely only on standard clinical data, but rather upon processing relationships between the data. In this experiment, an NPS approach was taken to identify phenotypically different HCC patients groups. The raw clinical screening data was first transformed into a new form, considering in full the individual parameters within the whole context of complete relationships to all other parameter levels. After this transformation, individual parameters were not treated as single entries into the analysis, but were each considered as a parameter within the whole clinical context (liver function tests, presence of cirrhosis or hepatitis, inflammation and different manifestations of tumor growth-size, number of tumor nodules, presence of PVT), with consideration of age and gender.

Clinical practice data, recorded within Taiwanese HCC screening program, was prospectively collected on newly-diagnosed HCC patients and entered into a database that was used for routine patient follow-up. Data included: Baseline CAT-scan characteristics of maximum tumor diameter and number, presence or absence of PVT; Demographics (gender, age, alcohol history, presence of hepatitis B or C (HBV or HCV)); Complete blood counts (hemoglobin, platelets, INR (international normalized ratio (prothrombin time))); blood AFP and routine blood liver function tests, (total bilirubin, AST (aspartate transaminase) and ALT (alanine transaminase), albumin) (as seen in Tables 1 and 2, below). HCV patients had HCV serum antibodies. HBV patients had HBV serum antigen. Alcohol was determined as daily consumption >10 years. The retrospective analysis was done under a university institutional review board (IRB)-approved analysis of de-identified HCC patients. In Table 1, PVT, hepatitis B and C antigens (HBV, HCV) absence/presence and self-not/reported alcoholism are shown as [−]/[+]. Concentration units are: albumin [g/dL], hemoglobin [g/dL], bilirubin [mg/dL], platelet [10³/dL], AFP [ng/dL], INR [r.u.], AST [UI/L], ALT[UI/L].

TABLE 1
Demographic and clinical characterization of patients

| | | | percent | | | percent |
|---|---|---|---|---|---|---|
| | | Number | in study | | Number | in study |
| Gender | Female | 1033 | 24.9% | Male | 3106 | 75.1% |
| Age | Younger <55 | 1432 | 34.6% | Older >55 | 2707 | 65.4% |
| Alcohol | [−] | 2950 | 71.2% | [+] | 1189 | 28.7% |
| HBV | [−] | 2010 | 48.6% | [+] | 2129 | 51.4% |
| HCV | [−] | 2520 | 60.9% | [+] | 1619 | 39.1% |
| PVT | [−] | 3187 | 77.0% | [+] | 952 | 23.0% |
| AFP | Low Low <200 | 2671 | 64.5% | High >200 | 1468 | 35.5% |
| Bilirubin | Low <1.2 | 2618 | 63.2% | High >1.2 | 1521 | 36.8% |
| ALT | Low <40 | 1693 | 40.9% | High >40 | 2476 | 59.1% |
| AST/ALT | Low <1.0 | 1344 | 32.5% | High >1.0 | 2795 | 67.5% |
| Albumin | Low <3.0 | 951 | 23.0% | High >3.0 | 3188 | 77.0% |
| Hemoglobin | Low <13.0 | 2236 | 54.0% | High >13.0 | 1903 | 46.0% |
| Platelets | Low <125 | 1603 | 38.7% | High >125 | 2536 | 61.3% |
| INR | Low <1.0 | 1355 | 32.7% | High >1.0 | 2784 | 67.3% |

TABLE 2
Ref. profile ID and coefficient in the classification
logistic regression model

| | | | | | Std. |
|---|---|---|---|---|---|
| # of | Patients (% | Size range | Mean | Median | Deviation |
| tumors | of cohort) | (cm) | (cm) | (cm) | (cm) |
| 1 | 2147 (51.9%) | 1-27.7 | 4.9 | 3.2 | 4.1 |
| 2 | 575 (13.9%) | 1-22.2 | 4.4 | 3.3 | 3.3 |
| 3 | 178 (4.3%) | 1-15 | 3.9 | 3.0 | 2.5 |
| >3 | 1239 (30%) | 0.9-26.0 | 7.9 | 8.5 | 4.3 |

NPS techniques were applied to this dataset, allowing personalized processing of complex phenotypes, with explicit consideration of functional parameter correlations and interdependencies. NPS was applied here to integrate the data of all 4139 HCC patients.

There were no missing data in this data set. Individual patient profiles were created in which each of 15 parameters was assessed in the context of all the other parameters for that same patient and processed by NPS techniques. The following is a summary of the concrete steps and their results:

In the first step, correlations were considered between clinical (blood liver function test and hematological) parameters. This had two ramifications. First, in a formal, statistical sense, any significant inter-correlation between individual parameter values represented a simplification of the analysis complexity (dimensionality reduction, taking into account that any two significantly correlated parameter pairs carry similar information). Second, any such significant correlation might indicate a functional relationship of the underlying processes. Therefore, building the NPS transformation of a study data, which explicitly considers such relationships, allows a simplified and more clinically intuitive processing of the extensive patient information such as in this study.

For logarithmically transformed values of eight plasma hematological and liver test parameters (AFP, total bilirubin, ALT, AST, INR, albumin, platelets, hemoglobin) all (8²−8)/2=28 pairwise correlations were considered and characterized the extent of (linear) proportionality between all possible parameter pairs by 28 linear regression coefficients. These 28 correlation coefficients were arranged into an 8×8 symmetrical correlation matrix. This matrix represented at the same time an adjacency matrix, defining a complete weighted graph (clique). In this clique, 8 liver test parameters were completely connected by strengths of their 28 co-linearities, quantified by the pairwise correlation coefficients.

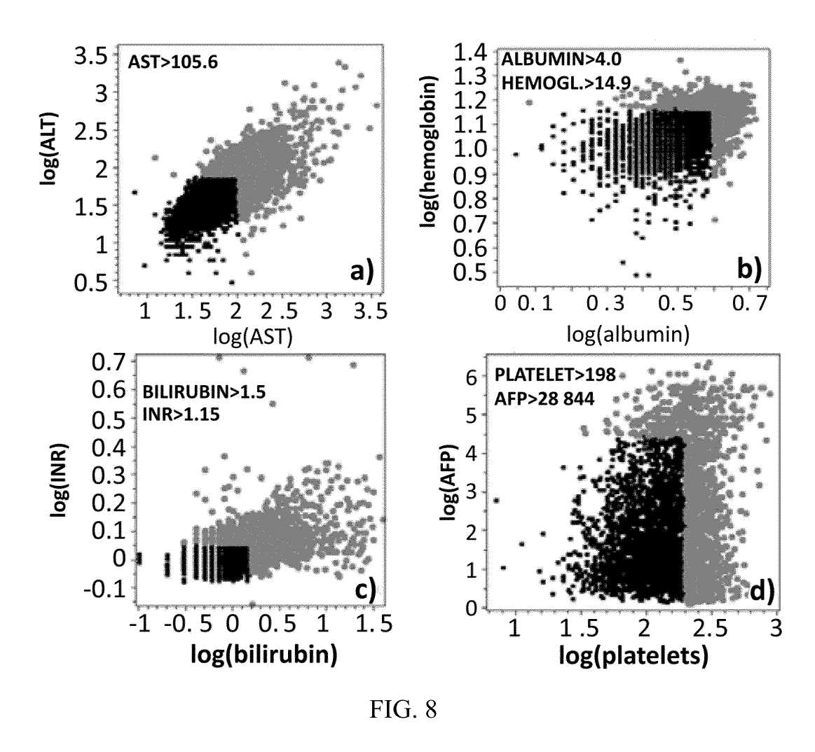

The maximal cut graph theory theorem was then used, defining a non-parametric algorithm, finding in this complete weighted correlation graph the set of 8/2=four liver test parameter pairings that were unique: all correlations in these pairs were individually significant (using the statistical significance test for the correlation coefficient on 0.99 significance level.) More importantly, these four selected pairs, illustrated in FIG. 8, also had the absolutely largest sum of their respective 4 pairwise correlation coefficients out of all possible 20,475 selections of such 4 pairs. Because no other information but the complete correlation matrix between the full sets of actual parameter values was used in this analysis step, the resulting unique pairing represented very important information encoded in the actual data set. It was therefore interesting to formulate the possible functional mechanisms and factors underlying these four highly significantly co-linear parameter pairings.

The second step involved transformation of the original patient clinical data and their conversion into a common form of “levels.” This step allowed for unification of the demographic (categorical) parameters with liver function (real value) parameters and allowed for consideration of their inter-relationships within a common, explicit, quantitative, but still directly clinically interpretable framework. Considering the established practice in HCC diagnostic evaluation, a common approach to determine levels of each individual parameter can be tercile-based dichotomization. For gender, reported alcoholism, evidence for hepatitis B and C and presence or absence of portal vein thrombosis (PVT) the dichotomization was natural.

For the rest of parameters, several alternative dichotomizations (50%:50%, quartiles) were tested, but it was found that tercile dichotomization with ⅔ of patients with the lowest parameter levels designated as “Low” phenotype and ⅓ of patients with the highest parameter levels designated as “High” phenotype was optimal for further processing. Also, the resulting thresholds, splitting the 4139 patients into 2759 subjects in “low” sub-group and 1380 patients into a “high” sub-group were comparable with values used in established HCC classification schemes. For age the “old” tercile was separated from the lower 2 “young” terciles by 55 years. For the four parameter pairs that were found as significantly correlated, the two-threshold method shown in FIG. 8 was used.

For these pairs, the upper tercile was defined by the 2 individual thresholds of the individual parameters that separate High from Low values. This resulted in clinically familiar value cutoffs, such as bilirubin of 1.5 mg/dL, AST 200 IU/L and ALT 105 IU/L. Another advantage of this approach is that the outliers from these trends, with the very high values, do not impact significantly the values of the tercile-based thresholds. It was shown that inclusion or exclusion of these outliers in all trends, both individually and simultaneously from analysis did not change the final NPS representation of patient's data and did not affect steps in further processing. Thus, NPS techniques are very robust and optimally sensitive to coherent as well as insensitive to stochastic components of raw HCC data.

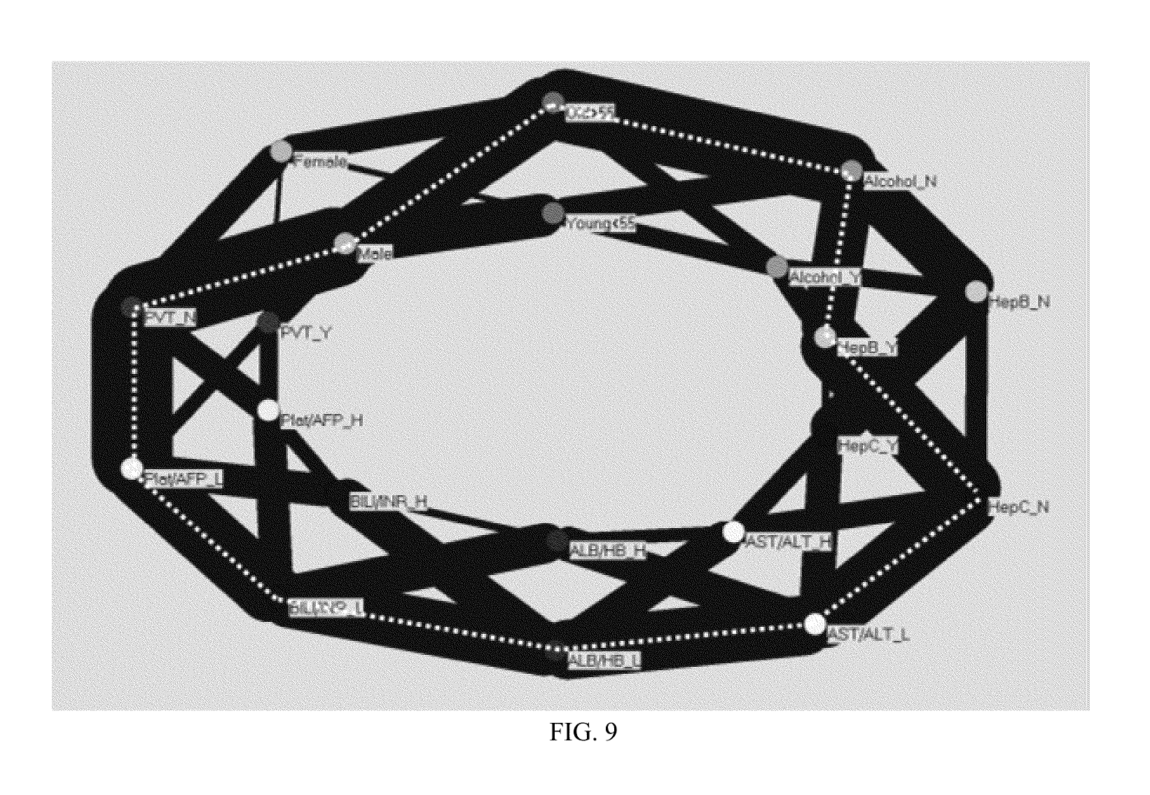

In a third step, using actual data for each patient, an individual clinical profile was created by connecting all the actual parameter high, low, + and − levels into a representation of their complete networked relationships, as shown in FIG. 7. As illustrated in FIG. 9, all these 4139 individual profiles were unified into a single schema, which carries new information about co-occurrence frequencies of all parameter levels. Line thicknesses in FIG. 9 are proportional to co-occurrence frequencies of various parameter levels. Although FIG. 9 shows a cycle graph for ease of illustration, in various embodiments, graphs including all parameter-parameter relationships can be used. The white dotted line in FIG. 9 follows the most frequent parameter level combination. Thus, as an illustrative example, it can be directly infer from FIG. 9 (following the dotted edges) that the majority of the cohort had low platelets, low AFP levels and no portal vein thrombus and also had more males than females. The next step ensured that the data transformation was not dependent on the order in which the parameters inter-connected in this unified profile.

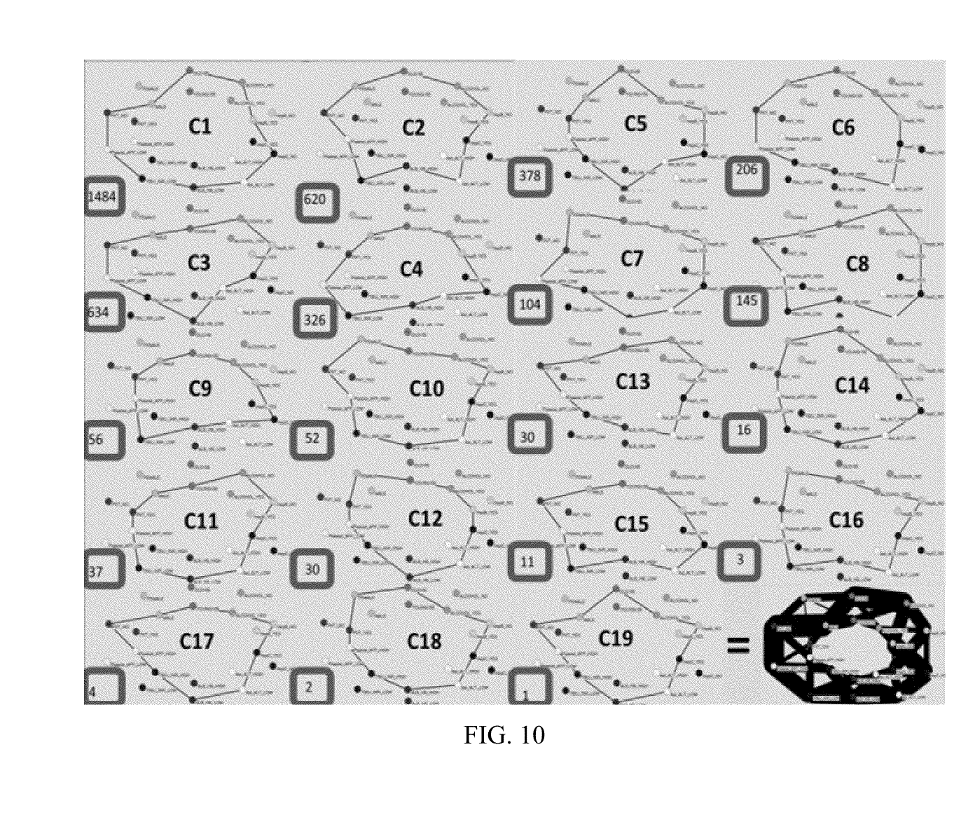

In a fourth step, using a greedy algorithm (extracting sequentially the co-occurrence relationship profiles that had the highest frequency in the dataset and repeating this process until there was no relationship left), the unified profile was decomposed into 19 reference profiles in such a way that all co-occurrence frequencies between all the parameter levels in a reference profile were identical. This generated unique, data-determined reference clinical profiles with equal frequencies of co-occurrences of all parameter pair levels. FIG. 10 illustrates the full decomposition of the single schema of all networked context relationships in the study data into reference clinical profiles C₁-C₁₉. Numbers in rectangles are multiplicities of every reference clinical profile in the decomposition. By dividing these multiplicities by 4139, the total number of patients in the study, the relative frequencies of each reference profile's occurrence in the HCC study can be obtained.

The identity of co-occurrence frequencies also ensured that the resulting reference profiles and the data transformation, which uses them as “triangulation points” in the space of all clinical data relationships, were independent of parameter ordering in the scheme. From the statistical point of view, it can be shown that the pair-wise relationships that constitute the reference clinical profiles were also unique by being independent of each other.

In a fifth step, the 4139 individual profiles were then compared in turn to each of the 19 idealized reference profiles and the differences were recorded between the relationships in an individual actual patient profile to those in each of the 19 reference profiles. There were 10 parameters or their pairwise trend constructs in the processed data and also on each reference profile (4 liver function blood pairs and 6 other parameters). Therefore, each individual profile could differ in 0, 2, 3, 4, 5, 6, 7, 8, 9 or 10 relationships from those recorded in each reference clinical profile. The number of these mismatches between an individual patient clinical profile and an idealized reference profile defined the “distance” of the actual individual patient's clinical state from the idealized reference clinical state. These 19 distances localized the precise position of each patient in the clinical landscape of HCC. This transformation of raw data into 19 distances contained information on trends and co-occurrences in terms of their clustering by closeness to the reference clinical profiles, serving as the “triangulation points” in the clinical data relationship landscape. A formal advantage for further statistical processing was also observed: namely, that the distributions of 19 distance vector components for all patients were Gaussian, while raw data often exhibited multimodal, nonsymmetrical histograms/distributions.

In a sixth step, logistic multiple regression was applied, with a variable selection algorithm (SigmaPlot11), using patient's 19 differences d₁-d₁₉ as independent variables, to predict whether an individual had a tumor mass (product of maximum tumor diameter and number of tumor nodules) smaller than 5.5 (1826 individuals, 44%) of larger (2313 subjects, 56%).

Only the differences between patient actual clinical profiles and 9 reference clinical profiles out of 19 contributed significantly to the tumor mass classification. Of these, small differences (<6) from the 5 reference clinical profiles (C₁, C₃, C₆, C₈ and C₁₆) resulted in high odds for a S-phenotype tumor mass and small differences (<6) from the 4 reference clinical profiles (C₅, C₉, C₁₂ and C₁₈) resulted in the high odds for L-phenotype tumor mass. This logistic regression model correctly predicted 70% of the tumor mass categories in a 10-fold cross-validation (ROC area 0.78). The logistic regression equation was used to identify 2034 patients as S-subgroup and 2105 patients as L-subgroup. The distributions of tumor mass in these 2 subgroups had their means, (13.0 for L and 4.4 for S) significantly statistically different, p=10⁻²⁴⁰, t-test. The significant differences were also seen systematically throughout the L and S tumor mass distributions.

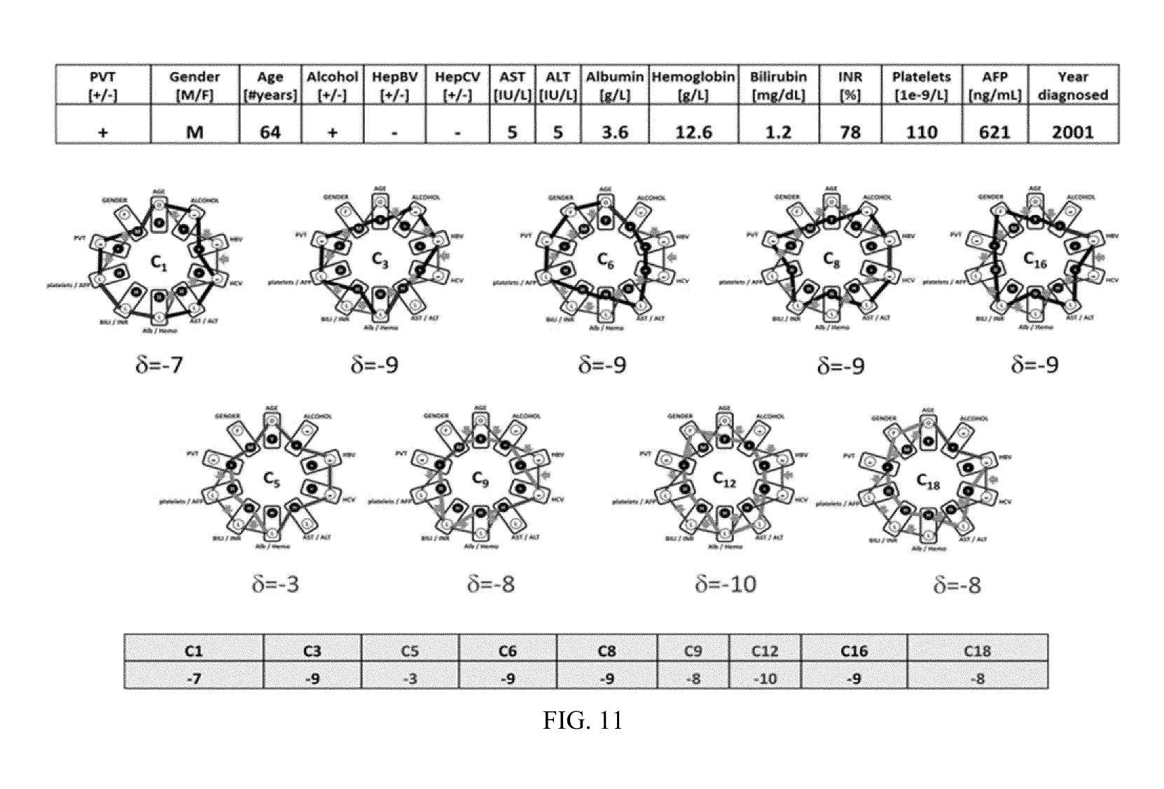

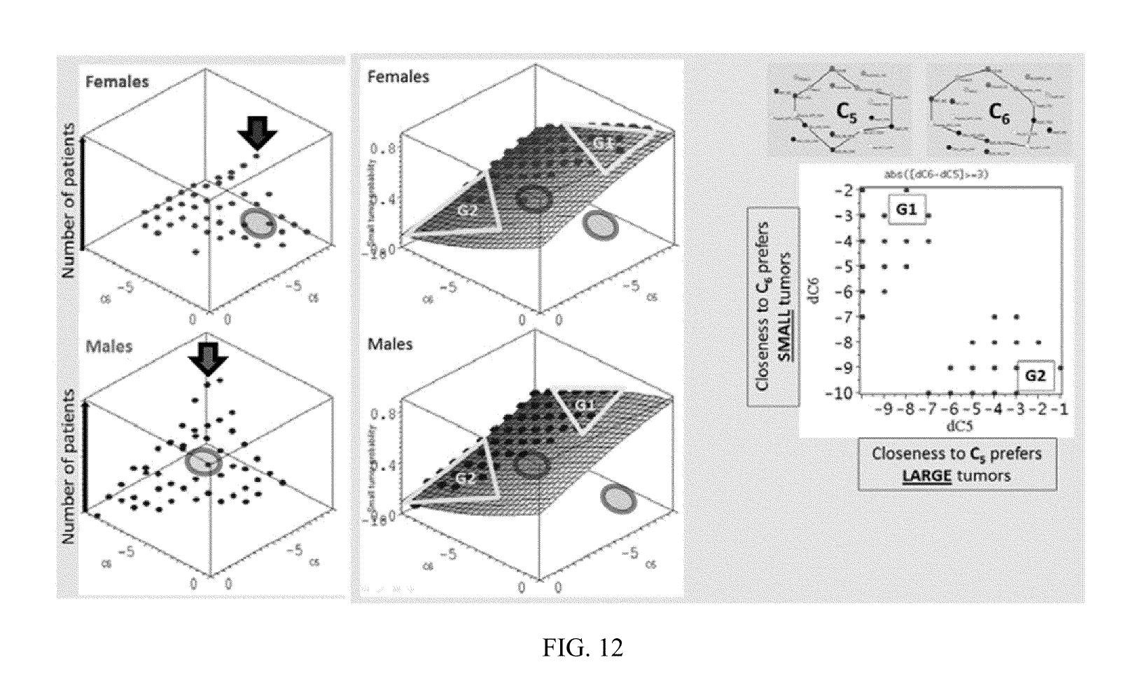

FIGS. 11 and 12 show details of the NPS procedures—determination of the personal distance vector [δₚ¹, δₚ², . . . , δₚ^{c}] (an example is illustrated in FIG. 11) and using projections of multidimensional clinical information into 2-dimensional projections in coordinates from respective pairs of the [δₚⁱ, δₚ^{j}] distance vector components with clear separation of tumor size phenotypes into heterogeneous subgroups {Ss} is illustrated via an example shown in FIG. 12. FIG. 11 shows an example of one possible implementation of derivation of a patient's distance vector (bottom table) from raw clinical screening data (top table) using the 9 reference relationship subgraphs of the full disease-characterizing 10-partite edge-weighted graphs constructed from hepatocellular cancer screening data. FIG. 12 shows an example of using projections of the all-level multidimensional clinical parameter relationship networks into 2D components defined by selected pairs of personal distance vector components from specific reference relationship subgraphs of the full disease-characterizing k-partite edge-weighted graphs. The multi-modal histograms of patient numbers at respective distances from specific reference relationship patterns identifies heterogeneous subgroups (the arrows identify distribution maxima) with different tumor grow mechanisms. The gender specificity of this liver cancer heterogeneity is clearly recognized in this projection.

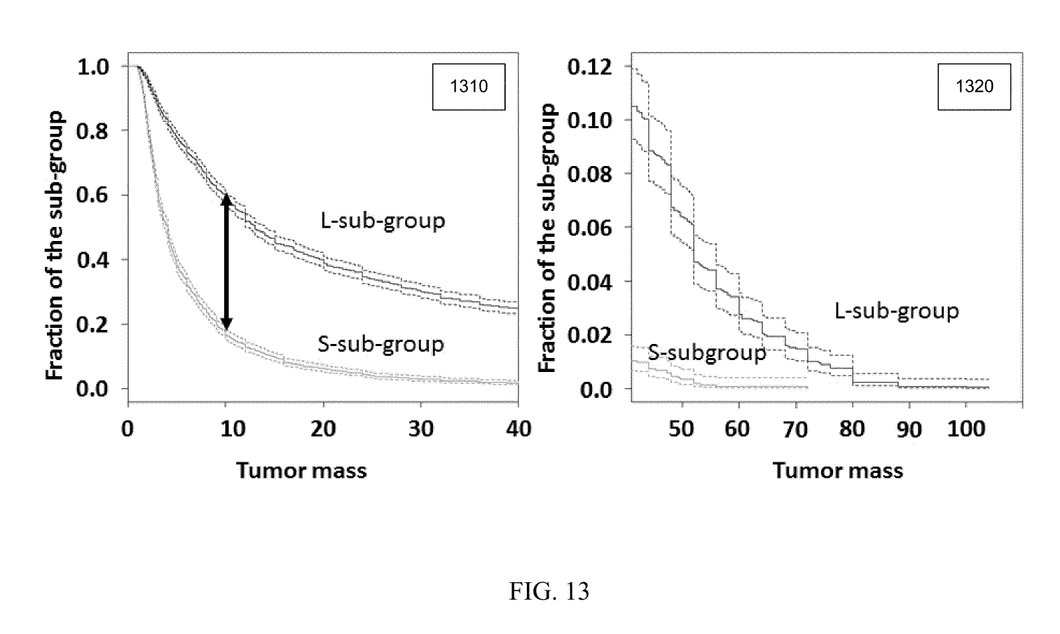

FIG. 13 illustrates the modified Kaplan-Meier (KM) characterization of odds for a given tumor mass in S- and L-subgroups. The dotted lines are 95% confidence intervals for the respective odds curves. The double arrow in 1310 indicates 3-fold odds difference. 1310 and 1320 use different scales for the largest tumor masses. As seen in FIG. 13, the Kaplan-Meier formalism has shown with strong statistical significance that patients in the L subgroup had a 2-4 fold greater odds of having a larger tumor. Equivalently, once the patient has been categorized in S or L-subgroup, then the odds of finding a given tumor mass were-3 fold higher in the L-subgroup, compared with S-phenotype patients. This indicated that the findings were independent of specific choice of tumor mass threshold in optimization of the logistic regression classification model. The main result thus far was that liver function tests and patient demographic descriptors identified S and L-phenotypic groups with strongly statistically significant separation of their tumor masse distributions.

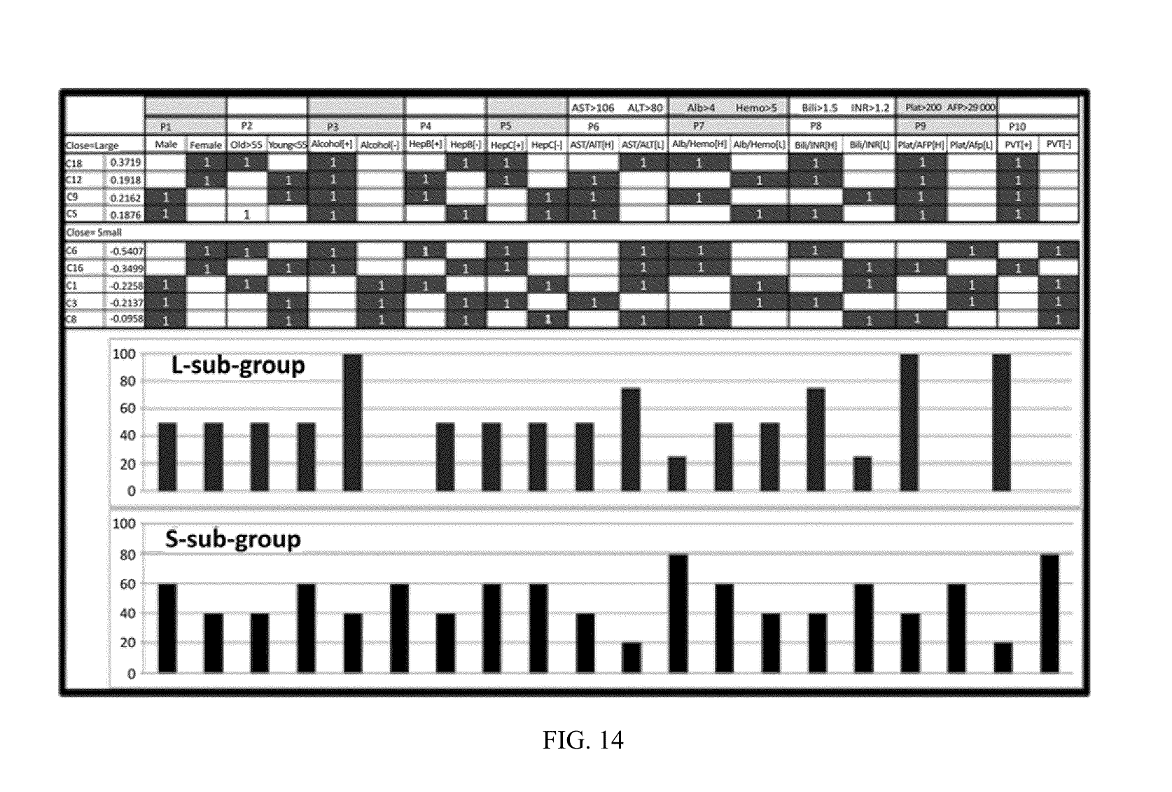

FIG. 14 illustrates clinical profiles associated with the S and L-phenotypic groups and results associated with the associated parameters. In the spreadsheet in FIG. 14, columns P1-P10 correspond to the 10 parts of the clinical profile shown in FIG. 7. The two sub-columns indicate one of the two levels for the respective parameters. The actual levels for given reference clinical profiles are shown by a “1” in black field. In the left columns, Reference profile IDs and coefficients in the classification logistic regression model are provided. In the charts below, reference clinical profiles associated to the L-subgroup and reference clinical profiles associated to the S-subgroup are shown, with the percentage of commonality of all reference clinical profile levels in respective sections P1-P10. As seen in FIG. 14, logistic regression identified L-phenotype-associated reference profiles C₅, C₉, C₁₂ and C₁₈, having in common high platelets/high AFP levels, accompanied by the presence of PVT and self-reported chronic alcohol consumption. The S-phenotype had 2 associated subgroups of reference clinical profiles: C₁, C₃ and C₆ on the one hand, and C₈ and C₁₆ on the other. The former had in common low platelets/low AFP and absence of PVT. The latter had in common low AST/low ALT, high albumin/high hemoglobin, low bilirubin/low INR and high platelets/high AFP.

L-phenotype associated reference profiles C₅, C₉ were male-related and C₁₂, C₁₈ were female-related. C₉ described younger and C₅ described older (>55 years) patients. For the female-associated profiles, C₁₂ described younger and C₁₈ older patients. S-phenotype associated reference profiles C₆ (young) and C₁₆ (older) were for female patients and C₁ (older), C₃ and C₈ (older) for male patients.

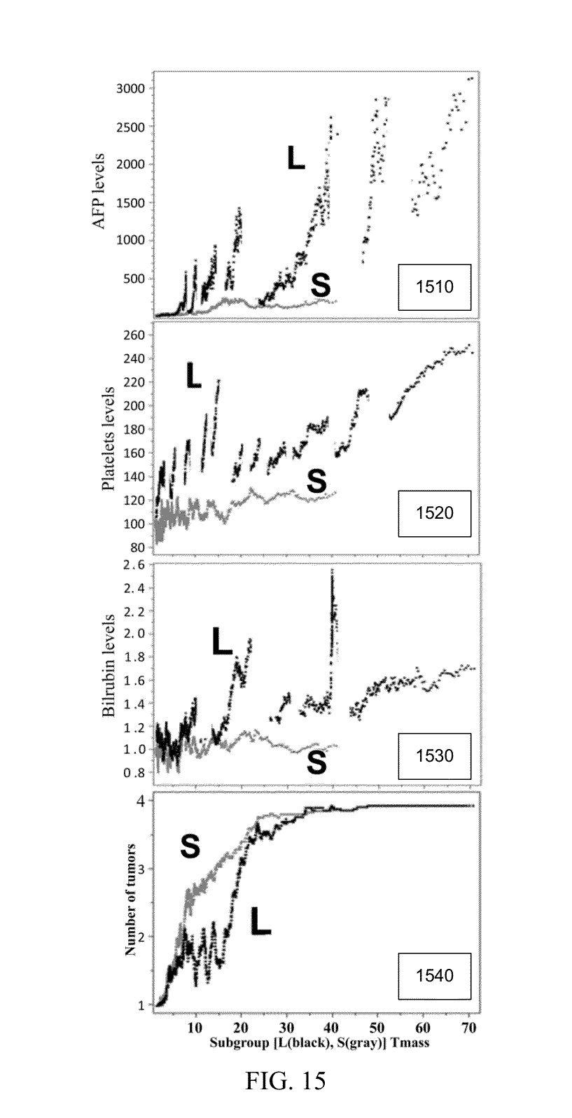

The networked characteristic profiles for the L-subgroup were more homogeneous than those in the S-subgroup. Analysis examined whether there were significant differences in typical parameter values for the same tumor mass that might be found in each of the S/L-subgroups. As seen in FIG. 15, illustrating typical parameter levels as function of tumor mass in S- and L-subgroups, a moving average filtering was used where any tumor mass was characterized by the average of the clinical parameter values of 61 patients with the closest tumor masses. The analysis examined these trends in AFP (reflective of tumor growth) and platelet values and found increasing AFP and platelet counts with increasing tumor mass in S- and L-subgroup with different rates and magnitudes, as seen in FIG. 14. The L-subgroup displayed a pattern of AFP/platelet level oscillations that were not observed in the S-subgroup Importantly, these L-phenotype unique oscillations were characteristic for the same tumor masses in both AFP and platelet trends, as seen in 1510 and 1520, respectively.

The analysis of typical tumor-mass-related bilirubin level changes also showed differences in the 2 subgroups, as seen in 1530. In the S-subgroup, there was a shallow bilirubin increase as the tumor mass increased. In the L-subgroup, oscillations were found below tumor mass 20, which were not seen in the S-subgroup. The oscillations in bilirubin levels in the L-phenotype cohort occurred at the same tumor masses as those in AFP and platelet values in the L-subgroup. Additionally, there was a steady increase in bilirubin levels for increasing tumor mass beyond 20.

The mechanisms underlying the oscillations did not seem to have an obvious explanation from clinical practice. However, possible clues came from analysis of the number of tumor nodules typical for the given tumor mass, shown in 1540. Analysis processed the data for tumor numbers in the same way as for other parameters and it was found that oscillations in tumor numbers corresponded to spikes in the parameter trends, especially seen for tumor mass <30.

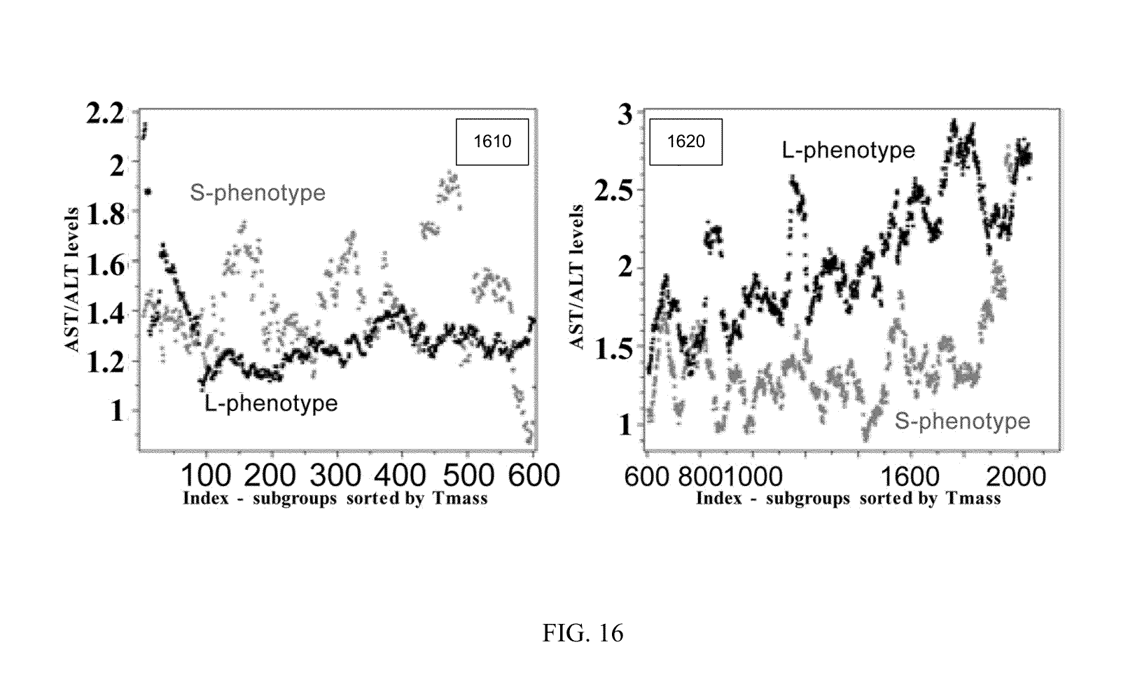

As seen in FIG. 16, illustrating typical levels of AST/ALT ratio for the S- and L-subgroups (rank ordered by tumor mass), examination of AST/ALT trends showed that they were steady in the S-subgroup and at higher levels than in the L-subgroup in the smallest tumors of equivalent mass <30 (FIG. 6). In the L-subgroup, there was a steady increase in AST/ALT levels as tumor mass increased above 30. 1610 shows the first 600 patients with tumor masses 1-2.5 in the S-subgroup and 1-7 in the L-subgroup, and the remaining patients with larger tumor masses are shown in 1620.

The analysis used the results from a database constructed from HCC patients who were newly diagnosed by surveillance screening. All parameters used were standard liver and blood count blood tests, which were already “processed” in the clinical practice. To find anything novel from these data, the approach to reanalyzing these highly informative, but complex data in our meta-analysis was fundamentally modified by applying NPS techniques in accordance with aspects of the subject innovation. Instead of the standard liver test parameter values, the analysis used relationships between the value levels of these parameters and considered any one of them in their complete context, in which every standard parameter level was evaluated in the full set of relationships to all other patient parameter levels. Instead of dealing with many complicated relationships between simple parameter values, the raw liver test parameter data was first transformed into differences between networked clinical profiles that contained, in manageable form, all the information about the clinical parameter interactions and parameter level relationships. These transformed data were then used as input into simple models separating two significantly different tumor phenotypes.

The simplicity of quantitative reconstruction of the real patient clinical outcome measure (tumor masses) from real-patient (input) data (which were personal differences in relationships between the real-world standard liver test data), showed that HCC is manageably heterogeneous, exhibiting two distinct series of liver test parameter relationship patterns for 2 very distinct subgroups of tumors.

The finding that there were just two distinct subgroups of relationships between the real-world liver test parameter levels, each associated with a different tumor phenotype was not trivial or associated to arbitrary selection of just one tumor mass threshold for training classification. The significance of finding the 2 tumor mass distributions S and L with markedly different liver test parameter relationship characteristics distributions is primarily derived from p=10⁻²⁷⁰ quantified statistical significance of differences in the S and L tumor mass distribution means. Such extremely strongly significant separation of the outcome phenotype into two categories leaves little space for error and for having many other subgroups to consider.

Thus, the meta-analysis, which used just slightly more complicated data (parameter network graph distances) instead of just simple parameter levels, revealed a relative simplicity of the HCC overall patterns. The two tumor subgroups, though, were not entirely-simply related to the liver test parameter relationships, but had manageable complexity. Analysis found a total of 19 observable liver test parameter-level relationship types, for the extensive 4139 patient data. Out of those, 5 relationship types were associated in unity as a weighted-combination with one tumor phenotype (S), and 4 others were associated in unity as another weighted-combination with the second tumor type (L). Because the 5+4 reference clinical profiles were idealizations of the S and L clinical phenotype characteristics, an individual patient characterization involved a quantitative description of how close the actual pattern of relationships between parameter values were for an individual patient from all significant reference clinical profile patterns. In this approach, the single value of a parameter cannot change the classification. Rather, it was the majority of the parameter relationships matching the S or L-associated patterns that determined the classification.

One significant result is the showing that even with routine clinical patient parameter combinations, the added functionally relevant information about the disease can be extracted from trends and inter-dependencies of parameter values in a total parameter context. Additionally, the analysis shows that the complexity of HCC personalization is manageable and possible to treat in a few independent sub-dimensions of liver-test parameter level relationships, which however, must necessarily be treated together in the full context of all the other parameters of an individual patient.

There were two specific findings from the analysis. First, as seen in FIG. 13, there were always 2-4 times higher odds for larger tumors in the L than in the S phenotype group. The differences in the tumor mass trends in the two subgroups were significantly separated, showing the efficiency of the NPS approach.

Second, in the 2 phenotype groups, there was much greater homogeneity in the characteristic parameter patterns in L than in S. The rate of change for typical parameter values per unit change of tumor mass was always significantly higher for L-phenotype patients compared to S-phenotype patients, excepting the AST/ALT ratio, which was higher in S for tumor masses below 10 than for the same size tumors in L. One possible interpretation of these observations is that in S-phenotype patients, small tumors are associated with processes producing higher levels of the inflammatory markers, AST/ALT. One hypothesis is that this might reflect the inter-connectedness of hepatic inflammation with tumor growth in the small tumors in this phenotype group. In L-subgroup, the simplest explanation of parameter levels oscillations might be consideration of the number of tumor nodules that composed the tumor mass. A relationship between platelet numbers and tumor size has been recently reported. Low platelets were interpreted to be a consequence of the portal hypertension that is secondary to liver fibrosis. The analysis found that most small HCCs in 2 large western cohorts occurred in the presence of thrombocytopenia, whereas the largest tumors occurred in patients with significantly higher, but normal platelet values. By contrast, in the L-phenotype, the AST/ALT ratio only really increased as the tumor masses became quite large. This may reflect the parenchymal liver damage that occurs when a large tumor replaces underlying liver. Also in the L-phenotype, but not in S, several additional liver parameters showed oscillations in their typical values as the tumor mass increased. A relationship between these oscillations and the number of tumors is shown in 1540.

Given the lesser association of changes in inflammatory markers in the L-phenotype, other factors, likely tumor-related, may be more important on the growth of these tumors. Such factors likely include genetic drivers of HCC cell growth. In the L-phenotype, the observed higher levels of various parameter contributions from multiple nodules to the total parameter levels could be additive.

The recognition that patients with newly diagnosed HCC can be identified with either of 2 different phenotypic subgroups based on common clinical parameters, each subgroup having distinctive biological characteristics, provided a training set to be used for future validation of its clinical and prognostic usefulness.

### Example 2

### Independent Validation of Phenotypic Categorization of Small and Large Hepatocellular Carcinomas (HCC) and Application for Survival Prognosis

In the second example, standard liver function parameter levels and tumor indices were analyzed using NPS techniques, which can compare personal patterns of complete relationships between clinical data values to reference patterns with significant association to disease outcome. This example built on the application of NPS to Taiwan hepatocellular cancer (HCC) patients and recognition of two clinical phenotypes, S and L, differing in the size and tumor nodule numbers. The goal was to validate the applicability of the NPS-based HCC S/L classification on an independent European HCC cohort, for which survival information was additionally available.

Without reference to the actual tumor sizes, patients were classified into subgroups with S and L phenotypes. These two phenotypes were recognized using just the liver screening test results, combined with patient's age, gender and self-reported alcoholism, by the same data processing as previously. Analysis subsequently validated (using actual CT/MRI scan data) that patients in L phenotype group had 1.5× larger mean tumor masses relative to S, p=6×10⁻¹⁶ Importantly, with the new data, liver test pattern-identified S-phenotype patients had typically 1.7× longer survival compared to L-phenotype. NPS integrated the liver- and tumor factors. Cirrhosis associated thrombocytopenia was typical for smaller S-tumors, but without correlation to tumor mass. In L-tumor phenotype, typical platelet levels increased with the tumor mass. Hepatic inflammation and tumor factors contributed to more aggressive L tumors, with parenchymal destruction and shorter survival. NPS techniques provided integrative interpretation for HCC behavior, identifying by clinical parameter patterns two tumor and survival phenotypes. The NPS classifier was provided as an Excel tool. The NPS techniques illustrate the importance of considering each tumor marker and parameter in the total context of all the other parameters in an individual patient.

The first example showed that 2 general processes contribute to HCC prognosis. They are liver damage indices, such as bilirubin, prothrombin time and AST, as well as tumor biology indices, such as tumor size, tumor number, presence of PVT and blood AFP levels. These 2 general processes may affect one another. Additionally, non-disease factors such as gender and age can also influence HCC outcomes, suggesting that any individual disease parameter needs to be considered within a total clinical context. Prognostically significant factors may actually function in part through interaction with multiple other tumor and host parameters, as the basis for this context. This context might even provide personalization of the prognostic meaning for every patient given his individual pattern of measured parameters. Thus, a given level of bilirubin or tumor diameter might have a different significance in different personal total clinical contexts.

Standard liver function parameter levels and commonly assessed tumor indices were thus considered as a pattern, allowing quantification of the impact of the total context of the relationships between all of the parameters together on the characterization of the HCC for individual patients. The net result, obtained using a large cohort of Chinese HCC patients in Taiwan (n=4139) in a training set was that individual patient parameter relationships between the results of standard blood-based liver test, which are relevant for prognosis of the HCC outcome were actually not so complex, with the relevant information captured in just 9 relationship patterns. Important insight into the clinical significance of these 9 relationship patterns was revealed, when the similarity of all individual patients' patterns to those 9 was quantified. The patients' profiles exhibited clear heterogeneity: clinical profile patterns of one subgroup were distinctly similar to four and those of another to five of those 9 “landmark” patterns (important and clinically significant patterns are referred to as heterogeneity landmarks (HL)) Importantly, closeness or large difference from these two landmark sets has been associated with significantly different tumor masses. These two phenotype subgroups of HCC patients with different clinical characteristics were called ‘S’ and ‘L’, for ‘exhibiting small’ and ‘exhibiting large’ tumor mass, or for short S and L tumor phenotype. The classification of a patient as having S or L tumor phenotype did not include any information about the tumor size and nodule numbers. The pattern-based tumor phenotype identification was solely based upon the result of standard blood liver test, including testing for hepatitis, portal vein thrombosis presence and absence and basic demographic information (gender, age, alcohol history). In this second example, further insights into the clinical relevance of pattern based characterization of HCC are presented. In the first example, survival data was not available for that analysis. However, this second example used an Italian database of 1619 HCC patients with known survival outcomes. There were two main goals of processing these independently collected Italian test data through the same diagnostic scheme, which was developed on the Taiwan training data set of example 1. The first goal was to validate that these 2 characteristic pattern sets of blood based liver test results and the personalized characterization of the closeness and differences from these clinical patterns can identify the same S and L tumor phenotypes, and the second goal was to show that blood-test pattern based identification of the S and L tumor phenotypes also identifies patients with significantly different survival outcomes.

Prospectively-collected data in the Italian Liver Cancer (ITA.LI.CA) study group database of HCC patients accrued at 11 centers was retrospectively analyzed. 2773 newly diagnosed HCC patients had full baseline parameter data, including radiology of maximum tumor diameter (MTD), number of tumor nodules and presence of PVT; demographics (gender, age, alcohol history, presence of hepatitis B or C); blood counts (hemoglobin, white cells, platelets, prothrombin time); blood AFP and routine liver function tests, (total bilirubin, AST, ALKP, GGTP, albumin) ITA.LI.CA database management conforms to Italian legislation on privacy and the study presented in this second example conformed to the ethical guidelines of the Declaration of Helsinki. Approval for the study on de-identified patients was obtained by the Institutional Review Board of participating centers.

The clinical parameter data were processed exactly as in the first example. Primary data were pre-processed in the same way as the training Taiwanese data. Concretely, analysis of complete set of all pairwise correlations between these data was first performed and it was confirmed (using the representation of the full correlation matrix as a complete weighted graph and identifying the maximal cut in this graph) that in the Italian data the same optimal pairing of the variables as in the previous study was found. Thus, the blood counts and routine liver function test variables were grouped into AST/ALT, albumin/hemoglobin, bilirubin/INR and platelet/AFP pairs, that had—as in the training set—the unique property that all these pairs were statistically significantly correlated and, simultaneously, the sum of their pairwise correlation coefficients was the largest of all other alternative pairings and groupings possible. In the next methodology validation step, it was independently confirmed that the two variable thresholds for each of these four blood test pairs, which were derived by the tercile-based training set processing, sub-divided also the Italian test cohort into subgroups consisting of one tertile of patients with the highest paired parameter levels (high level-subgroup) and two tertiles of patients (low level-subgroup) with the lower levels of the paired parameters. After these details of the data pre-processing steps were independently validated, all patients' raw data were converted into the high and low blood test subgroups. By adding the remaining information, the personal relationship pattern (PRPᵢ) was constructed for each individual patient. This was followed by computing the edit-distance δₖ(PRP,HL[k]) between these PRP's and the nine landmark patterns HL[1], HL[2], . . . HL[9] determined by the NPS processing of the Taiwanese training set in the first example. As a result, the clinical status of each patient, explicitly incorporating the information about the individual clinical context pattern, was represented by a series of nine values of δₖ. These nine values were entered as input variables into the logistic regression equation, which was optimized using the training Taiwanese set, to compute the odds for classification of every individual patient as having S- or L-tumor phenotype. For the second example, there was re-optimization of the set of nine HL's or the coefficients of the diagnostic logistic regression equation. This blood liver test plus demographic based identification of the two patient subgroups (one with high odds for S-, the other with high odds for L-tumor phenotype) was used in all subsequent validation and interpretive steps in the second example. The data processing summary and parameter-relationship pattern based classification model is discussed above.

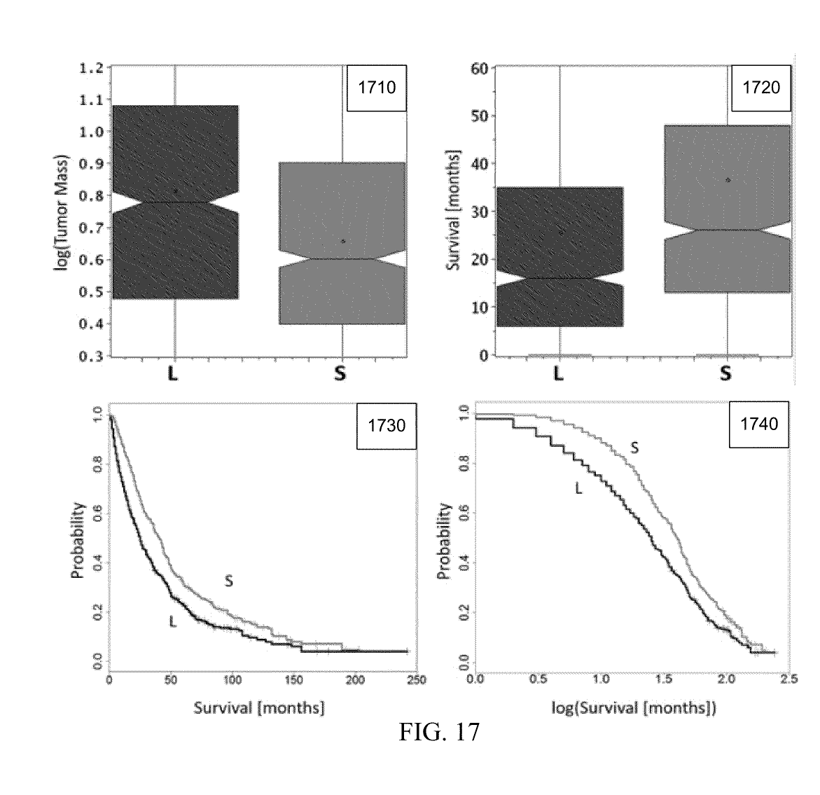

FIG. 17 illustrates box plots of tumor mass and survivability for the S- and L-subgroups, along with plots of survival probabilities. FIG. 17 shows validation of HCC outcome differences for patients with S and L tumor phenotypes, identified by NPS analysis of standard screening results. Boxplots show the differences in the tumor masses at 1710 and in the overall survival for patients with the S and L-tumor phenotypes at 1720. Kaplan-Meier plots show the significant differences between the probabilities to find equivalent tumor masses at 1730 and overall survivals for patients with the S and L-tumor phenotypes at 1740.

1710 presents the box plots of the distributions of the tumor masses for patients from the test set, recognized by the odds computed from the differences of their standard screening result personal relationship patterns from the nine HL's as having the S and L tumor phenotypes. The means of these distributions were significantly different, p=6×10⁻¹⁶. The statistical significance as well as the mean differences of the tumor mass distributions of this outcome of the two standard screening identified HCC groups were comparable to the tumor mass differences between these two HCC tumor phenotypes, identified by the relationship pattern analysis in the Taiwanese patient training dataset.

These box plots show that while the difference of means was highly statistically significant, there was still significant overlap in the distributions of the tumor masses in the 2 groups. The overlap reflects the complexity of the HCC phenotype together with the unknown point on the course of the HCC development at the point of any individual patient diagnosis. Nevertheless, having the complete patient cohort independently subdivided into 2 subgroups with markedly different clinical patterns allows the NPS techniques to overcome this general problem by inspecting these distributions separately in S and L phenotype subgroups much better than by analyzing the complete cohort. In this way, it was found that probability of finding the same tumor mass in the S- and L tumor phenotype HCC groups was significantly different, as seen in 1730, showing the differences between the probabilities are larger than 2 times the 95% confidence interval of the respective probability estimates. It was therefore conclude that, for a given pattern obtained from the standard screening results, patients identified as being from the S tumor phenotype group were significantly more likely to be in a more advanced phase of HCC progression than those whose standard screening test identified them as members of the L-tumor phenotype group.

Survival was also analyzed in two ways. First, the statistical significance of the differences in means of the survival distributions, computed separately for the two groups, was tested, and patients were identified from the results of their standard screening tests as S- and L-tumor phenotype phenotype patients, as seen in 1720. The mean overall survival for S-tumor phenotype patients was 24 months, and for L-tumor phenotype patients the mean survival was 14 months (difference statistically significant, p=10⁻²¹). Thus S-tumor phenotype patient, identified by the standard screening had 1.7 times longer mean survival compared to L-tumor phenotype. Second, the Kaplan-Meier survival analysis was performed, based on the standard-screen results identification of the S- and L-tumor phenotype patients and significantly different probabilities of survival in these S and L HCC tumor phenotype patient subgroups were found, as seen in 1740. The typical separation of the S- and L-tumor phenotype survival probability curves was statistically significant, exceeding double of the 95% confidence interval of the two estimated survival probabilities.

The standard screening-based identification of S and L-tumor phenotype subgroups, differing in the survival, resulted from the analysis of relationship patterns between clinical liver function, which here independently provided the significantly different tumor and survival parameters. This provided the basis for analysis of the functional differences between the two phenotypes, because the patients from the two well defined phenotypic groups could be analyzed separately, characterized solely by the characteristic patterns of easy to obtain standard screening results, into S and L-tumor phenotypes. To visualize the dominant trends in relationships between the screening and outcome clinical variables, moving average processing of biologically interesting parameter pairs was used. In the first part of this analysis step, relationship between screening clinical parameters and tumor mass were inspected. Patients were first ordered according to tumor mass, separately in S and L-tumor phenotype groups and then the screening clinical parameter and tumor mass values were processed by the moving average to reveal dominant trend between the data in the pair. The relationships between tumor mass and both internal tumor factors (AFP) and liver factors (bilirubin, AST, GGTP) were studied. The typical trends between bilirubin and tumor mass are different between S and L-tumor phenotypes. Overall, there were higher typical bilirubin levels in S-tumor phenotype subgroup than in L, for a given tumor mass. For both groups, bilirubin increased with increasing mass for small tumors. However, with increasing tumor mass, there appeared to be no further relationship between increasing mass and bilirubin levels, accompanied by a lowering of typical bilirubin levels. This transition in the relationship between mass and bilirubin occurred at smaller tumor masses in S compared with L-tumors. This lack of further increase in typical bilirubin levels as the tumors continued to grow, suggested that factors internal to the tumor were dominant in the increasing tumor growth. This looked like a plausible functional hypothesis, but evidence from just one (bilirubin) clinical variable is insufficient. The novelty of the characterization of S and L HCC tumor phenotypes is in recognizing them from the differences in the standard screening clinical data relationship patterns in the two groups, instead of from the conventional normal/elevated clinical variable level approach. Thus, any functional interpretation of what is observed for single clinical variable in relationship to the tumor characteristic or disease outcome has to be contrasted and confirmed by examining the trends in other liver parameters. Following these novel ideas, trends revealed by the moving-average processing for AST and GGTP were examined with respect to increasing tumor mass, and showed remarkable similarities to the trends for bilirubin.

These results also showed that beyond a certain small tumor mass, continued tumor growth was not accompanied by increased evidence for tumor damage. In this multi-variable context, it was interesting that the examination of AFP trends showed increased levels with increasing tumor mass and was comparable for both S and L-tumor phenotype groups. AFP thus appears to monitor tumor growth through its full range, unlike the changes in liver function parameters. Another observation was that beyond a certain point of tumor growth, further increase in tumor mass was associated with a lesser increase in AFP per unit increase in tumor mass. This change in the slope of the tumor mass—AFP trend occurred at the same tumor mass as the decrease in related trend for both bilirubin and AST. All these results combined and interpreted in mutual context are consistent with the hypothesis that with further tumor growth, the contribution from liver factors decreased and the internal tumor factors regulating growth remained increasing, reflected in the lesser response of AFP to further increase in tumor mass. An analysis was done for trends of liver parameters for increasing AFP instead of increasing tumor mass. The results were very similar.

Given the finding of AFP as a monitor of HCC growth, above, next the typical levels of liver function parameters for patients with comparable AFP levels were analyzed separately for S and L-tumor phenotype groups. This analysis focused on patterns in bilirubin, tumor numbers and survival with respect to AFP levels. It was found that tumor numbers increased with increasing AFP levels in both screening-based phenotypes. However, there were typically a smaller number of tumors in S compared with L-tumor phenotype, for patients with comparable AFP levels. Furthermore, beyond AFP log 2.5 levels, tumor numbers increased at a greater rate in L patients than in S-tumor phenotype. Thus, the increase in tumor mass from AFP log 0 to 2.5 is likely due to increase in tumor size alone, but above this AFP level, the increase in tumor mass also has a contribution from increased number of tumor nodules, mainly in L-tumor phenotype group. The increase in numbers of tumors in S-tumor phenotype group was only modest. Increasing AFP levels were associated with decreasing survival. Thus, for a given similarity of survival, screening identified L-tumor patients had higher AFP than S-tumor phenotype patients. Given the importance of both liver and tumor factors in HCC, the trends in bilirubin levels as a function of increasing AFP levels were plotted, and found incoherency between bilirubin and AFP typical levels up to log AFP 2.0. Thereafter, this trend continued for screening identified S-tumor phenotype patients, but not L, in whom increasing AFP was followed by increasing bilirubin levels. Increase in tumor mass was not associated with increase in bilirubin levels in S-tumor phenotype patients. This transition in AFP levels around log 2 corresponds to the change in the rate of increase per unit of tumor mass and also to the point at which bilirubin/tumor mass level changes diverged between S and L-tumor phenotype.

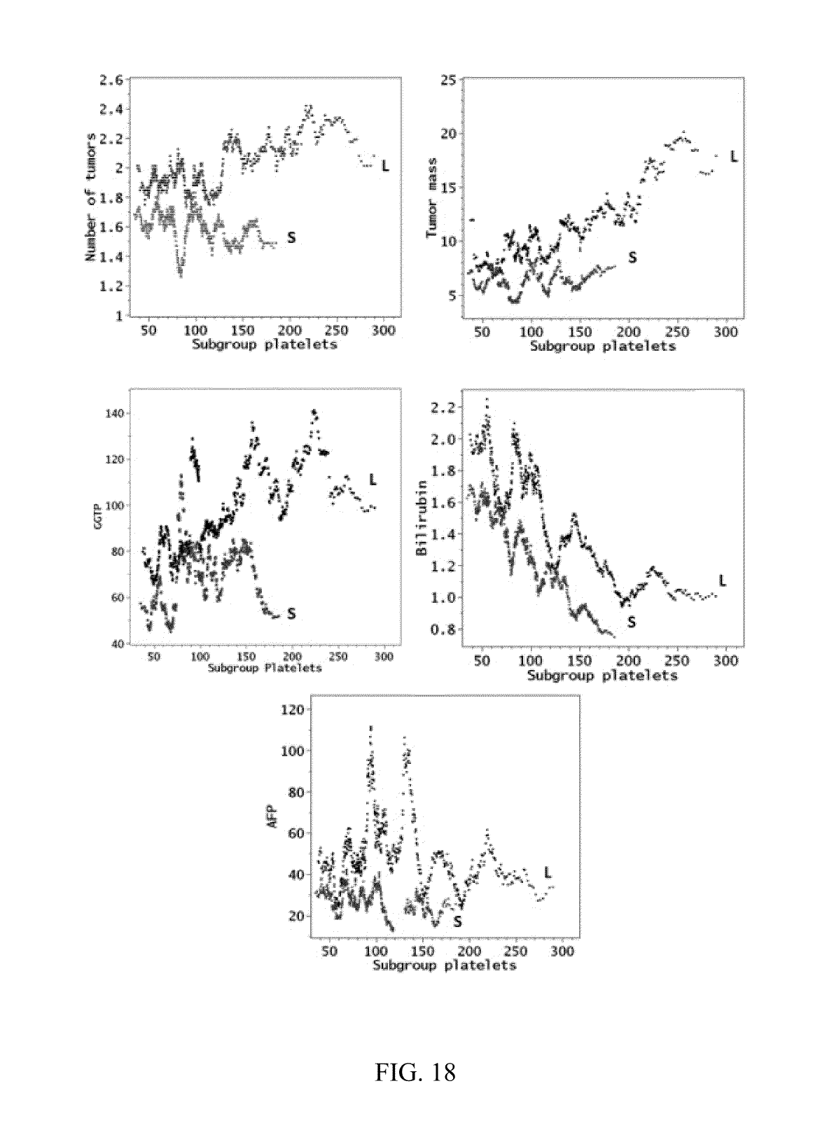

After the initial analysis of complete correlations between all parameters, platelets and AFP were part of the set of 4 pairs with highest correlations. FIG. 18 illustrates the results of examination of patterns of trends between platelets and other parameters. No correlation of platelets was found with tumor mass or number for screening identified S-tumor phenotype patients. However, for L-tumor phenotype patients there was a linear trend between typical platelet values and tumor mass or number of nodules in L-tumor phenotype patients. A U-shaped pattern in the trends was found for platelets with increasing AFP, with a turning point at log AFP 1.5 to 2. In addition, platelet levels were systematically lower in S- than L-tumor phenotype patients. This transition point also corresponds to transitions in other parameters. In the majority of the AFP range, from log 1.5 to log 3 levels, there was an increase in platelets with increase in AFP. At the highest AFP levels at >log 2.5, where bilirubin levels also are increasing, the platelets start to decrease, consistent with the bilirubin/platelet relationship of liver failure.

Network phenotyping strategy (NPS) techniques were used in the first example on a large cohort of Taiwanese HCC patients, to show that analysis of standard screening parameter relationship patterns could identify 2 sets of HCC patient phenotypes, called S and L-tumor phenotype groups. The results showed that if the individual standard screening parameter values were considered in the context of all other parameters, NPS techniques could identify independently 2 possible sets of tumor phenotypic patterns. Survival data was not available for that analysis. This second example examined whether this approach could be used to examine a large and completely different HCC cohort amongst another ethnic patient HCC group, using the identical method of standard screening data processing and the same quantitative model. It was again found that with the use of standard screening result patterns, the total cohort could be clearly separated into S and L-tumor phenotypes, each associated with significantly different tumor masses and survival.

This example provided a functional insight into survival factors deduced from relationships between various standard screening parameter patterns and total tumor mass in the two recognized tumor phenotypes. Three screening parameter trends in relation to tumor mass showed distinct differences between S and L-tumor phenotypes: Trends for bilirubin, AST and GGTP showed an increase with increasing tumor mass for L, but not for S patients, beyond limited tumor mass. However, the trends for AFP were different, since there was a general non-linear increase in AFP with tumor mass for both S and L-tumor phenotype patients. This was interpreted to signify the direct importance of AFP in growth of both S and L tumors. By contrast, it was supposed that involvement of bilirubin, AST and GGTP with tumor mass is more indirect. Thus, AFP could be a mediator of internally-derived growth of HCCs (oncogenes, growth factors), whether of S or L-tumor phenotype. By contrast, the other 3 liver parameters in the screening result repertoire might reflect the tumor micro-environment that permits or modulates HCC growth and behavior. It was found that trends for bilirubin, AST and GGTP were all higher for the larger and more aggressive HCC L phenotype tumors that were associated with shorter survival than S-tumor phenotype patients. This NPS approach thus synthesized and integrated both liver and tumor factors.

The analysis based on the patterns instead of standard screening parameter values revealed both characteristic pattern and complexity in HCC phenotypes. Both liver and tumor factors are well-described in HCC prognosis. The relationship pattern based processing of the standard screening data permitted the NPS techniques to discern 2 distinct clinical HCC tumor phenotypes. Inspecting typical trends between different parameters, findings included increasing trends in L-tumor phenotypes for several parameters, but constancy in parameter trends for S phenotype, which suggests some possible mechanistic interpretations. Most HCCs arise on the basis of hepatic inflammation with some degree of associated cirrhosis, and are consistent with elevated bilirubin, AST and GGTP for the S and L tumors. The portal hypertension and splenomegaly associated thrombocytopenia appeared mainly as a feature of patients, which screening identified as having S tumors, reflecting small HCC development in cirrhosis. As S tumors grew, they did not appear to further worsen the liver function parameters, possibly due to their significantly smaller size compared to L tumors. The parameter trends were more complex in L tumors, likely due to multiple factors, including hepatic inflammation and endogenous tumor factors. Unlike S, the L-tumor phenotype patients, identified by NPS processing of screening data, predominantly did not have thrombocytopenia. It was hypothesized than in L, unlike S-tumor phenotype patients, the known platelet-derived tumor growth factors and inflammation-associated cytokines may play a role in the expansion of the growing tumor mass. There is an inverse relationship between bilirubin and platelet levels in portal hypertension, and the patients in the data set were no exception, as seen in FIG. 18. However, there are also other causes of elevated bilirubin levels, which must be involved to explain the increasing bilirubin levels associated with large tumors. These include both inflammation as well as parenchymal liver destruction by larger tumor masses. S and L differ in the relative contributions of these mechanisms, recognizable by their different patterns.

### Example 3

### Macro- and Micro-Environmental Factors in Clinical HCC

This third example used NPS techniques to independently validate results discussed above on 641 HCC patients from another continent. The same HCC subgroups were identified with mean tumor masses 9 cm×n (S) and 22 cm×n (L), p<10⁻¹⁴. The means of survival distribution for this new cohort were also significantly different (S was 12 months, L was 7 months, p<10⁻⁵). Nine unique reference patterns of interactions between tumor and clinical environment factors were characterized, identifying four subtypes for S and five subtypes for L phenotypes, respectively. In the L phenotype, all reference patterns were PVT (portal vein thrombosis) positive, all platelet/AFP levels were high, and all were chronic alcohol consumers. L had phenotype landmarks with the worst survival. S phenotype interaction patterns were PVT negative, with low platelet/AFP levels. It was demonstrated that tumor-clinical environment interaction patterns explained how a given parameter level can have a different significance within a different overall context. Thus, baseline bilirubin was low in S₁ and S₄, but high in S₂ and S₃, yet all were S subtype patterns, with better prognosis than in L. Gender and age, representing macro-environmental factors, and bilirubin, INR and AST levels, representing micro-environmental factors, had a major impact on subtype characterization. Clinically important HCC phenotypes were therefore represented by complete parameter relationship patterns and cannot be replaced by individual parameter levels.

The idea that tumors grow in part due to the influence of their environment is not new. Tumor clinical environment as used herein refers to any aspect of the milieu in which a tumor arises that can potentially influence its behavior. Thus, age and gender can influence the hormonal milieu of the liver. Such clinical factors are regarded as macro-environmental. The altered liver function that is part of the changed cytokine and inflammatory marker cascade resulting from alcoholism or hepatitis and that is reflected in blood bilirubin, albumin, INR or ASL/SGOT levels, are considered to be clinically micro-environmental. Both the processes of hepatocarcinogenesis and growth of hepatocellular carcinoma (HCC) involve a 2-way influence of the effects of hepatitis viruses, alcohol or carcinogenic mycotoxins on the liver, as well as the reaction of liver components to these chronic and damaging agents. At the level of tissue organization, there are changes in extra cellular matrix components, as well as angiogenesis and chronic inflammation, that are both consequent on the damage and then become necessary components of the developing tumor environment. Some of the biochemical processes have been identified to include oxidative stress, apoptosis, autophagy and the immune system. The tumor stroma and micro-environment has been shown to have both characteristic and prognostic molecular signatures, but its components are also seen to be an attractive target for the new molecularly targeted therapies. Some of the cell types that are involved, and their products, are now becoming identified. The effects of clinical environment (macro and micro) on tumor biology are not simple, nor are the studies and questions and tools for finding answers. At the same time, novel experimental methods bringing detailed insights about the micro-environmental contributions to disease mechanisms are increasingly powerful. A methodology is needed for finding the optimal intersection of the clinical and molecular directions in tumor-environment research and its clinical interpretation and application. Ideally, tumor-environment models and their diagnostic and prognostic results should use these two information resources simultaneously, in the full mutual context. Applying NPS techniques to this, opens a clinical direction towards this unification with an approach prepared for incorporating both avenues. If the standard clinical characterization of the patient in terms of the understanding of micro- and macro environmental clinical factors and the disease status can bring new insights, that can allow direct integration of the results of novel experimental and molecular biology studies with clinical practice and improve the “bedside translation.” With better characterization of the clinical disease heterogeneity, it is more likely that relevant hypotheses can be formulated and tested through complex studies with better design and patient status identification.

This example further validated the Network Phenotyping Strategy (NPS)-based classification model discussed above. This model was applied without change from the first example, to independently collected data from another continent, and confirmed that the same HCC subtypes and the characteristic patterns of relationships were also identified. Since survival data was available for this new data set, the data again showed that the identified HCC subtypes had significantly different survival prognosis. With this additional validation, the clinical and relationship pattern-based characteristics of the identified HCC subtypes were analyzed, providing their interpretation in terms of the tumor-clinical environmental interactions.

The extraction of novel information from a standard set of baseline clinical parameter data at diagnosis, used in standard clinical practice clinic of hepatocellular carcinoma (HCC) evaluation was approached in a way that allowed for better characterization of HCC clinical heterogeneity. As before, this can be done by application of graph theory tools via NPS techniques. Mathematical graphs, when properly selected, can capture what at first sight are complicated relationship patterns, in an elegant, manageable and clinically understandable way. NPS transformation of clinical practice data enabled adoption of a new paradigm in which the levels of individual typical parameters used in standard baseline evaluation and clinical categorization of HCC can be examined within the context of all the other identified clinical parameters.

In the concrete application of this general approach to problems of HCC, the changed paradigm allowed for the use of common clinical blood test parameters together with demographic descriptors, and provided novel information from analyzing the relationship patterns by considering their values and levels simultaneously. This novel paradigm is a mathematical incarnation of the common clinical question of the following type: a single 8 cm HCC mass in an apparently normal liver carries a quite different prognosis and treatment approach from a similar 8 cm mass in the presence of multiple cirrhotic nodules, elevated bilirubin and/or ascites. The analysis took all these important inter-relationships simultaneously into account and determined their impact on the prognosis or treatment of a concrete patient. This example demonstrated that NPS transformation of the data enables not only high level analysis of information in the relationship patterns between all used clinical variables, but it also provides results in a form that is directly and simply interpretable in clinical terms.

The NPS approach can use the clinical study and/or clinical practice data along with the consideration of all available clinical information that is relevant for the disease. This pre-processing of the data allows for encoding the standard clinical information in a consistent manner for very diverse data types as the partitions and vertices of a network graph that, in turn, can represent complete relationship patterns between the clinical data levels and types. Once this is done, NPS techniques can represent a personal relationship pattern for every patient, as a k-partite graph is generated in which the actual clinical variable levels, found through the baseline diagnostic tests and data collection for an individual patient, are represented by separate vertices in the respective partitions. These actual levels are then connected by edges (lines), representing all co-occurrences of these levels in the concrete personal clinical profile.

One advantage of NPS techniques is the simplicity of the next step, in which the relationship pattern information is captured from an entire cohort into a “study graph.” The study graph is simply a union (generated by addition of all personal clinical profile relationship networks) of all personal k-partite graphs. In the study graph, the numbers of co-occurrence edges between respective levels of clinical variables carries information about the frequencies of the relationship. In the next step, with the use of graph theory mathematics, the complete decomposition of the study graph into the linear combination of reference relationships patterns (RRPs) was found. These RRPs represent unique clinical profiles, which characterize the typical collective relationships between all considered variables, occurring frequently and with clinical significance in the original data. The RRP's were then used as “landmarks” in the disease clinical profile landscape, relative to which an individual patient's clinical profiles were measured.

To that effect, in the last NPS step, the personalized information for characterization of an individual patient's relationship pattern was extracted using the “closeness” between an individual's clinical pattern and all those RRPs, characterizing the HCC type heterogeneity. This closeness was computed as a vector of graph-graph distances between a personal relationship profile of an individual patient and all respective RRPs. With this definition, the graph distance had a simple and clear clinical interpretation, namely, it was the total number of mismatches between the individual patient and the reference relationship profiles. The number of mismatches from one RRP defined one element of the personal distance vector. It was found in the first two examples that 9 RRPs were necessary for characterization of HCC tumor phenotypes, which was validated in this example using a different dataset.

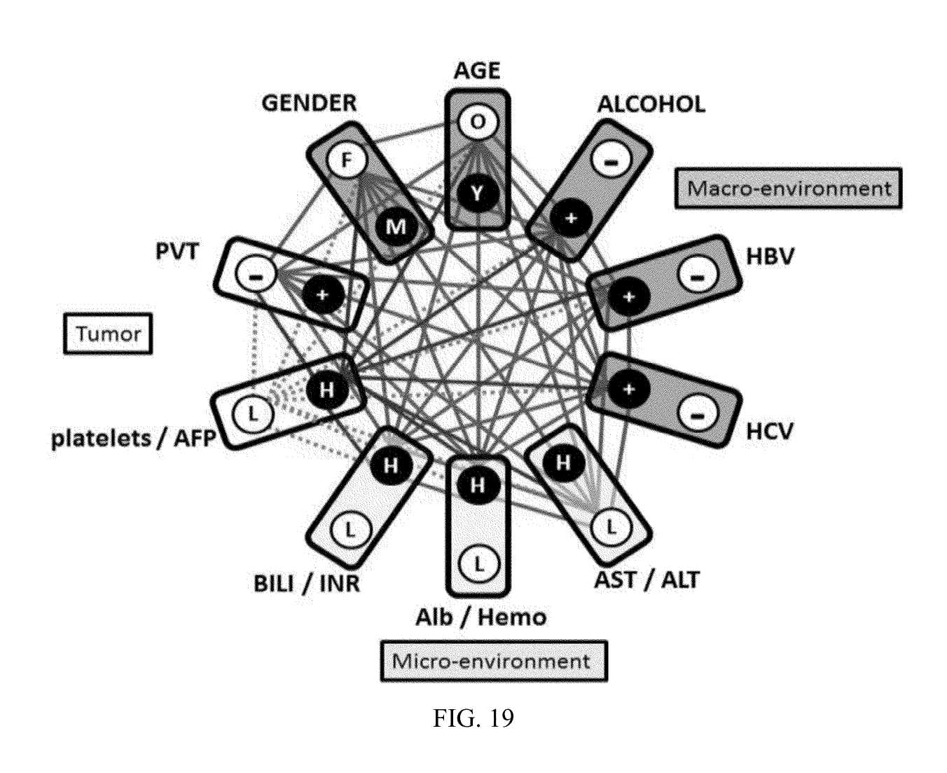

The NPS transformation of the HCC patient baseline variables thus constitutes a 9-element vector with element one indicating how a patient actual relationship profile is different from RRP₁ and element two indicating how a patient actual relationship profile is different from RRP₂, etc. In this way, through the NPS transformation, the original “raw” clinical data are transformed into simple numerical form that unifies encoding of variable levels with the actual pattern of the variable level relationships in every individual patient's clinical profile. FIG. 19 illustrates an example of how parameter change impacts the relationship pattern. The lines (graph edges) are relationships found in one of the HCC-specific RRPs. While this RRP considers platelets with levels higher than 195×10⁹/L, a concrete patient had platelets level lower than this threshold with all remaining variable levels identical to the RRP. This single parameter level difference between individual and reference clinical profiles (7%) caused a change in 9 out of 45 (20%) relationships captured by NPS transformation of the HCC screening data.

The baseline clinical presentation data of 641 U.S. patients presenting for treatment of biopsy-proven unresectable HCC in an unscreened population was examined in this third example. On initial clinical evaluation, all patients had: baseline complete blood count, blood liver function tests, blood alpha fetoprotein (AFP) levels and hepatitis serology, as well as physical examination, liver and tumor biopsy, and a triphasic helical computed axial tomography (CAT scan) scan of the chest, abdomen and pelvis. The data and CT descriptors were prospectively recorded and entered into an HCC database intended for follow-up and analysis. This analysis was done under a university IRB-approved protocol for the retrospective analysis of de-identified HCC patient records.

This third example provides independent validation of the previously discussed results obtained by NPS analysis of HCC screening data from another HCC cohort that was not part of a screening program. With these independent clinical data, all the previously used steps in preparation for NPS transformation and analysis were followed without any modification. The first step was the definition of the partitions in the k-partite graph. That included a data-driven approach that simplified the relationship patterns to be analyzed. For this purpose, a special algorithm of graph theory was used, which found the maximal cut sub-graph in the complete weighted graph, representing all possible statistically significant (p<0.01) correlations between eight blood test parameters. This algorithm is mathematically proven to find a single unique set of clinical variables that are all statistically significantly correlated and the sum of their correlation coefficients is maximal compared all other possible combinations. This step was used to optimally represent by a single partition the two variables that carry equivalent information. These uniquely correlated pairs were: AST/ALT, AFP/platelets, albumin/Hb, and bilirubin/INR.

By repeating the identical procedure with new data, it was shown that this unique, informationally optimal pairing of clinical variables was found without change and with preserved statistical significance of correlation coefficients also in the cohort studied in this example. This validated a design feature of the NPS graph used above for HCC analysis—that it was and is the 10-partite graph in which each partition represented one clinical component of the analyzed information. In addition to the 4 blood test pairs identified above, the remaining 6 graph partitions represented age, gender, alcoholism, hepatitis and portal vein thrombosis (PVT) statuses.

The next step of the clinical definition of the 10-partite graph needed for the NPS transformation of HCC screening data was defining the thresholds, allowing for discretization of the ranges of real valued clinical variables into low and high categories. In the previous examples, a tercile approach to find these thresholds was used. The low category represented two terciles of original cohort patients, all having both levels lower than given threshold, and the high category represented the upper tercile of patients with at least one variable level above the threshold. With the new data it was found that all thresholds from the previous study also sub-divided the U.S. cohort into the terciles. This was evidence that the distributions of the collected clinical variables were equivalent in the two data sets and consequently that parameters selected for discretization of the clinical information in the NPS analysis were justified and independently valid in each of the cohorts. With validated thresholds, the high and low levels of clinical variables were then represented by the vertices in the respective partitions. Then the actual data for every individual from the validation cohort was used personal 10-partite graphs were constructed, representing the complete patterns of relationships between patient's clinical profile levels.

With this example's validation set, with substantially less patients compared to the first example's training set, the stringent validation approach was implemented, confirming that the reference relationship patterns (RRPs) which were found by a special graph theory algorithm, which decomposed the training study graph, representing the union of 4139 individual relationship patterns into a linear combination of RRP's, were valid landmarks in the HCC clinical landscape of this example's validation cohort. The similarity and dis-similarity of a patient's individual clinical profile was defined by the number of personal screening data relationships identical to or different from the respective reference relationship patterns. The total number of these differences for each of nine RRPs, defined (through the 9-variable logistic regression model) the odds that a given individual patient's clinical screening profile was representing an S-tumor or L-tumor HCC subtype.

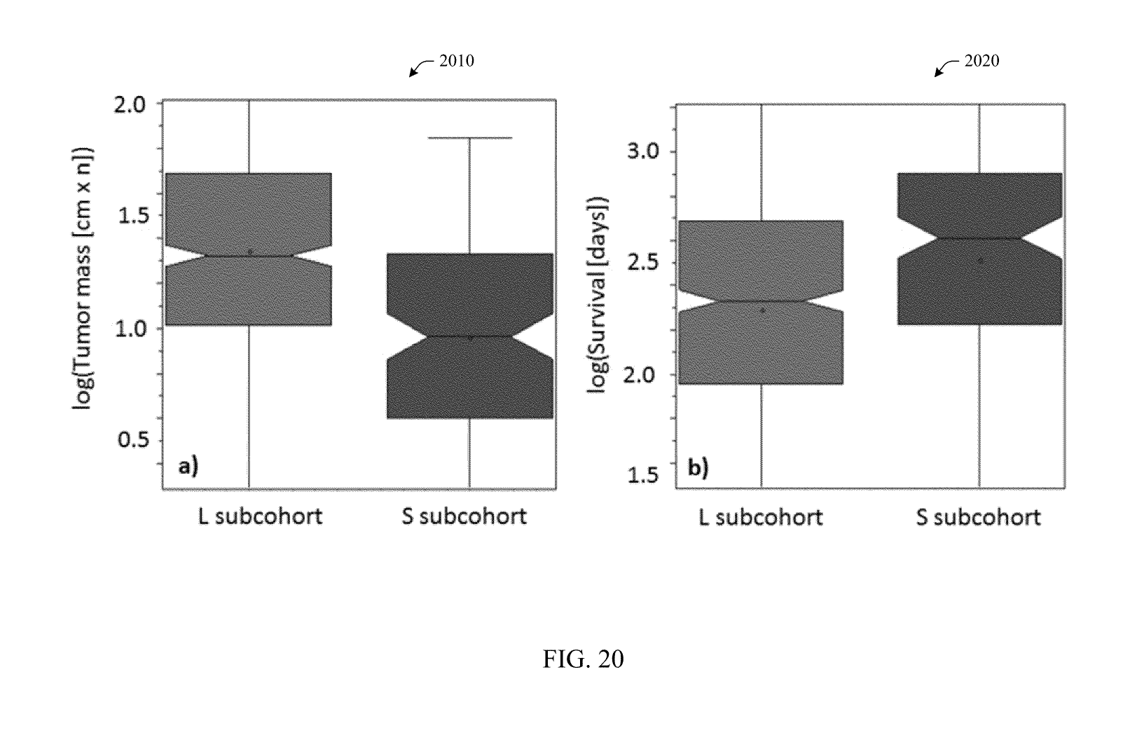

Therefore, the RRPs from the training set were directly used to generate the input of individual graph-RRP distance vectors with nine components for patients from the validation set. These were used as input into the S- and L-classification logistic regression equation, optimized in the training set. The computed odds to recognize two subgroups of the patients with predicted small (S) and large (L) tumor masses were used. With this strategy, the patients from the validation set were classified into HCC subtypes S and L directly by their relationship patterns derived from personal screening data. This was done independently of the information about the actual tumor masses. This analysis found 80.6% patients in L and 19.4% patients in S subgroup. The validation was then finalized by comparing the distributions of the actual tumor masses in the S and L identified patient subgroup, shown at 2010 in FIG. 20, which illustrates box plots of the distributions of tumor masses for the two subgroups at 2010 and the overall survival in days for the two subgroups at 2020. The two means of tumor mass distributions were 22 [cm·n] for L and 9 [cm·n] for S patients. These means of tumor mass distributions in the two categories were significantly statistically different (p<10⁻¹⁴).

In addition, since there was survival data for this set that was not available for the training dataset, additional independent validation of clinical relevance of the NPS-recognized S and L subgroups of HCC patients was performed. As seen in 2020, there was significantly different survival between the 2 groups, S and L (mean survival in L subgroup was 7 months, mean survival in the S subgroup was 12 months. This 1.7 fold difference in means of the survival distributions was again strongly statistically significant, p<10⁻⁵).

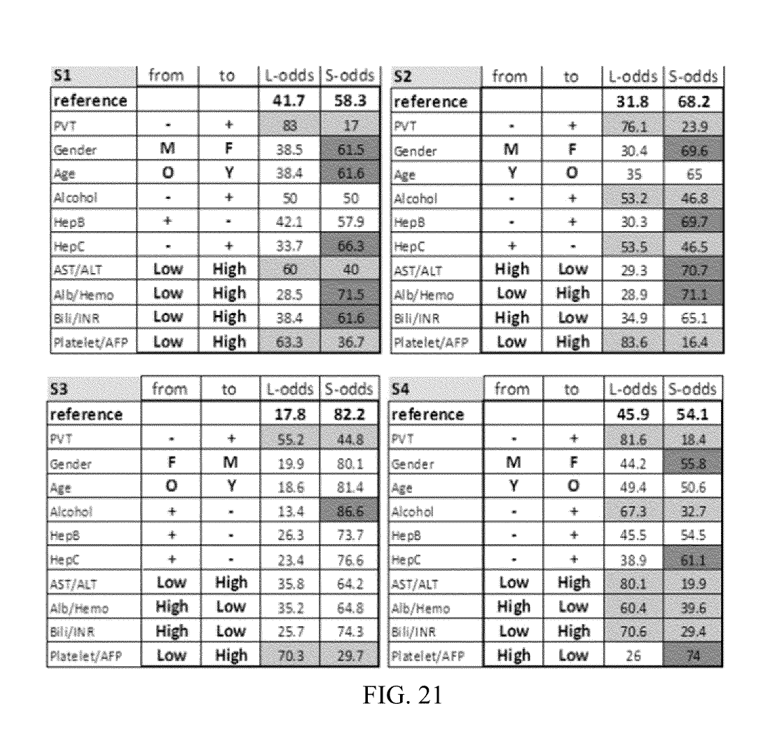

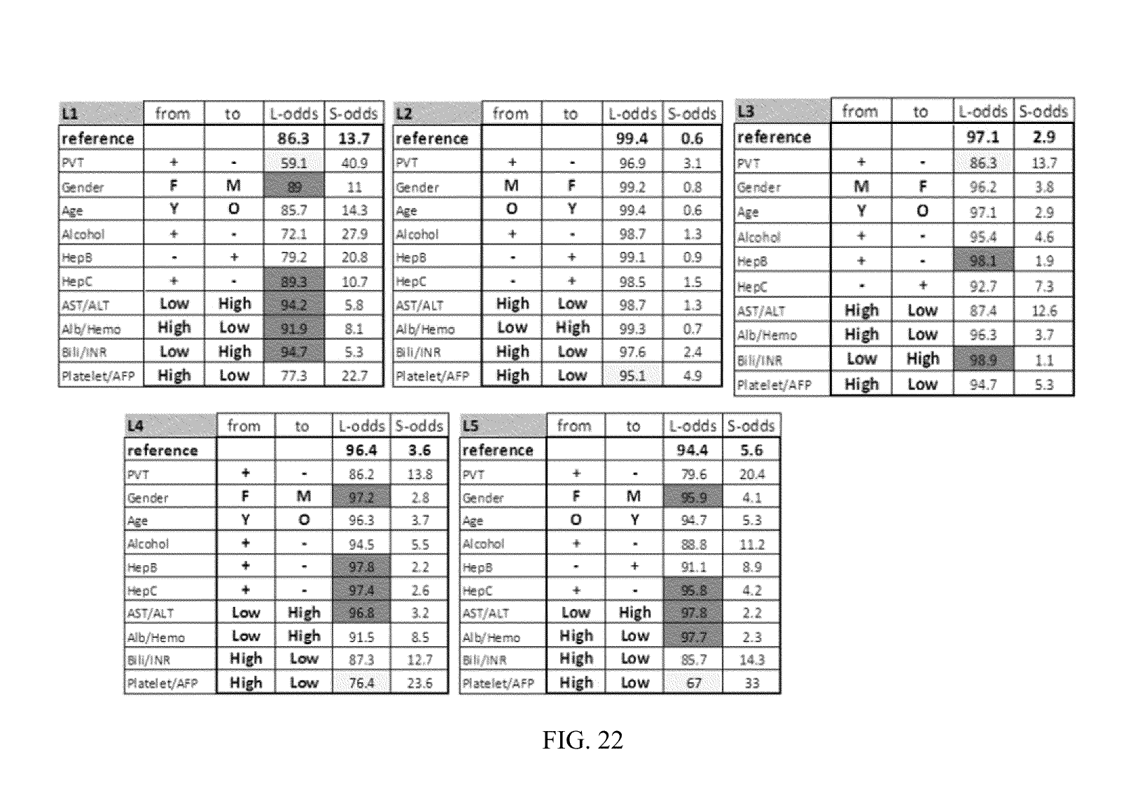

With these results validating the NPS results and identifying HCC subtypes in terms of the clinical tumor biology and disease outcome characteristics (prognosis), more detailed insight was gained into the HCC heterogeneity, its factors and the role of the clinical environment interaction with the tumor by probing the clinically relevant details of the NPS classification model. The actual patient allocation into S or L HCC subtypes and the survival prognosis were derived by the 9-variable logistic regression model, which processed differences between the patients' relationship profiles and respective RRPs. Previous NPS analysis in the above examples of the tumor and clinical environment interaction had shown that the HCC clinical landscape is separated into two main regions. One was (S), with smaller tumors having more variable relationship patterns of clinical parameters, and the other was (L), with more stringent clinical parameter relationship characteristics. In addition to this basic differentiation, the analysis provides further differentiation of these two subcategories, which was defined by the clinical landmark statuses of two classes of the nine RRPs. FIG. 21 shows the results of systematic analysis of single-parameter change in S-tumor RRPs on the odds used to diagnose phenotypes, and FIG. 22 shows similar results for L-tumor associated RRPs. As shown in FIG. 21, there were four RRP's, which were located in the S-tumor region, and as shown in FIG. 22, there were five RRPs associated with L-tumors. Here “location” or “association” of RRP with a particular clinical state of RRPs is understood as the data-driven feature of the patient's clinical data, revealed by the pattern-based information processing introduced through NPS techniques. The actual clinical profiles of HCC patients are unevenly distributed for subjects with typically S- or L-data patterns. In addition to the primary S/L division, there are additional heterogeneities in patient clinical data relationship patterns within these two main subcategories and RRP's represent the “focal points” of them. This role of RRPs, as validated here to be well-defined and characteristic descriptors of the tumor and clinical environment, provided further insight via detailed analysis of the response to single parameter changes into the NPS-derived subtype assignment of ‘S’ or ‘L.’

The advantage of this novel pattern-based NPS analysis paradigm is that single parameter changes induce extensive variation of the original relationship pattern, which bring a new level of clinical information and can be traced to the functional aspects of the environment-tumor interactions. Full results of this analysis are summarized in FIG. 21 and FIG. 22. Next, two representative examples are presented demonstrating that there are three basic types of clinical consequences of these variations in patient tumor phenotype subgroup and hence in prognosis.

In a first example, the first panel of FIG. 21 defines the S₁-subtype of the S-tumor phenotype. The clinical meaning of the RRP, that is, the clinical pattern serving as a focus for the cluster of patients with this HCC subtype is found in the first (“from”) column of the S₁ sub-table. This is a male patient, older than 55 years, with no self-reported alcoholism, Hep B antigen positive, Hep C antigen negative, AST <4 IU/L and ALT <3.23 IU/L, albumin <4.0 g/dL, hemoglobin <14.9 g/dL, bilirubin <1.5 mg/dL, INR<77, platelets <195×103/dL and AFP <29 000 ng/dL, PVT negative. The “reference” column of the panel indicates that for a patient whose actual clinical profile would be exactly identical with this S₁ RRP, the odds for diagnosis of the S- and L-HCC tumor types are 58.3% for S and 41.7% for L, respectively. This parameter pattern defines the association of S₁ with S-tumor phenotype.

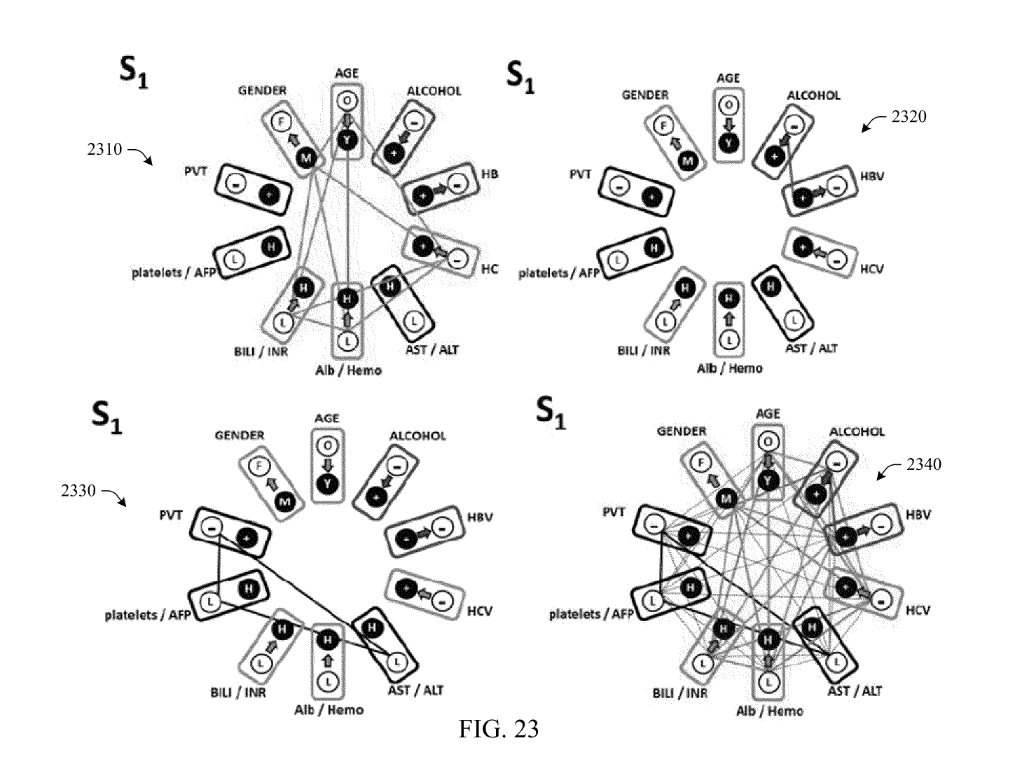

The second column (“to”) identifies a single clinical parameter state change from the original S₁ level to the level indicated in this column, which was tested. Note that all remaining nine parameters were kept on their original levels in the S₁ RRP. In the last two columns are reported the odds for L and S tumor subtypes, as they are computed after the tested clinical variable level change. This process was repeated systematically and independently for all ten single clinical variable level changes (these results are shown in the variable-labeled rows, below the reference rows of FIG. 21 and FIG. 22). Three types of response of the HCC classification to any single parameter change were found. FIG. 23 illustrates the three types of response of the S₁ RRP to a single parameter change. The first category is shown in 2310. These are changes that strengthen the identification of the S-tumor relative to the clinical pattern status identical to the RRP S₁. For patients similar to S₁ subtype of S-tumor and in the order of improving the odds of an S-diagnosis, these changes are a) either increase hemoglobin level above 14.9 g/dL, or increase of albumin level above 4.0 g/dL or having both these levels high; b) hepatitis C antigen changing from negative to positive; c) individual changes from male to female, from patient older than 55 years to younger and levels of bilirubin and INR from levels lower than the above presented thresholds to levels higher in either of them or both, also increase the S-diagnosis odds in comparable manner. Thus, both macro-and micro-environmental changes in a single parameter change the odds of such a patient being in the S or L phenotype.

The second category of odds responses to a single parameter change are shown in 2320. If, in contrast to the original relationship pattern in S₁, patient reports alcoholism or hepatitis B is not diagnosed, that decreases the odds but still identifies a patient as having S-tumor subtype.

The third category is shown in 2320. These are changes, which are interpreted as forbidden, because they change the reference relationship pattern S₁ in the HCC clinical landscape populated by actual personal clinical relationship patterns characteristic to S-tumor in such a way that the distances from this altered RRP are suddenly wrongly described by higher odds for the L-tumor subtype. These three “forbidden” single parameter changes (from absence to presence of PVT, the AST/ALT inflammation markers and platelet/AFP markers increasing from low to high levels) thus have to stay in the original S₁-RRP defined levels. This category of single parameter changes therefore represents a relationship sub-pattern, which is the most characteristic for the S₁ subtype of S-tumor.

In 2340 these responses of the S₁-S-tumor subtype prognosis changes are integrated into a complete scheme and additional relationships were added that go beyond the single-parameter ones to pair-wise and higher order ones (this is possible because of additive terms in logistic regression equation computing the odds).

A second example is from the S2 subtype of S-tumors, with properties shown in FIG. 21. For this S-tumor subtype, there are only two characteristic parameters which are forbidden (from absence to presence of PVT and platelet/AFP markers changing from low to high, shown in red). Only a change of reported alcoholism to no alcoholism increases the S-tumor odds relatively to original S₂-pattern result. All remaining allowed changes decreased the S-tumor odds, with micro-environmental inflammatory marker AST/ALT change from low to high and albumin/hemoglobin change from high to low, having the largest impact. Note that absence of PVT is a common non-variable and therefore the most characteristic feature of S-tumors (this emerged directly from the data relationship analysis). The low platelet/AFP levels are required for three out of four S-tumor subtypes.

Results of the systematic single parameter level variations for the five L-tumor subtypes shown in FIG. 22 can be summarized as follows: the 10-variable relationship patterns associate with these more aggressive and worst survival prognosis tumors are very characteristic, resulting in a very clear diagnosis (all reference odds are close to 90% and higher). With such very structured relationship patterns (out of many and many theoretically possible) that were identified in the NPS analysis, single parameter changes do not induce significant changes in the L-tumor characterization. Thus, in contrast to S-tumors, L-tumors are not amenable to subtype change as a result of single parameter changes.

It has been long-recognized in HCC studies that unlike many other tumors, prognosis depends upon both tumor and micro-environment factors (liver inflammation), as well as macro-environmental factors such as age and gender. In order to discuss these combinations of various factors, a variety of approaches have been taken, such as multivariable regression, principal component analysis or neural networks. Regression methods become too complicated for considering complete tumor-environment interactions; and the principal component and neural network analyses provide statistically significant associations for diagnosis and prognosis, which are difficult to interpret in simple clinical terms.

Utilizing NPS techniques of the subject innovation can concentrate on tumor-environment interactions by a) designing an NPS to characterize these interactions using the correct number of RRP's and b) extracting the diagnostic and prognostic information individually and quantitatively by comparing personal patterns of these interactions for individual patients to reference relationship patterns that have clear clinical interpretation. This approach showed in the first example that the HCC patients in that cohort could be described within 2 broad phenotypes, S and L, which differed significantly with respect to tumor mass. The significance of these two HCC phenotypes was validated here in two ways. First, without any change of the NPS model, the means of tumor mass distributions in this cohort were different with significance p<10⁻¹⁴. Second, the clinical importance of this is that overall survival was also significantly different between the 2 groups p<10⁻⁵. This significance of the two phenotypes for disease outcome allowed for interpreting the results in more detail.

Within these 2 phenotypes, 4 patterns were recognized within S and 5 patterns within L phenotype. Each phenotypic pattern comprised unique combination of relationship between the levels of 10 clinical parameters, which in turn represent different interactions between the tumor and environment factors. The NPS results showed that patient relationship patterns are unevenly distributed in the tumor-environment landscape with RRPs' landmarks, such that there were patient that were by the nature of the complete relationship between their tumor and clinical environment interactions are related to one, but distant to most or all other reference relationship patterns. It is this heterogeneity that underpins the functionality of the NPS approach and allowed for even more detailed testing of the clinical significance of this result. Individual single parameters were systematically changed in each of the 9 subgroups and then the clinical consequences were examined in terms of the resultant phenotypic assignation that resulted from the complex change in pattern of relationships between all the tumor and clinical environment parameters, consequent on that minimal level change in any one of them. This computational exercise provided interesting insight into the different nature of the two tumor phenotypes.

For each of the S phenotype patterns clinical parameters were found that cannot be changed from the original, reference levels defined in RRPs, together with clinical parameters whose levels can be varied to alternative levels. For example, presence of PVT+ was invariable or inadmissible in all four S subtypes, since its presence resulted in a relationship between the tumor and environmental parameters that were not observed within the training nor validation HCC patterns. By contrast, change in micro environmental parameters such as bilirubin (S₁, S₂ and S₃) or AST(S₂, S₃), resulted in a change in the odds ratio within the S phenotype in some of the 4 S phenotypes.

By contrast, the characterization of L tumor phenotype did not require any invariable levels of any clinical parameter. It is solely the unique relationship patterns between majority of the clinical parameters, captured by the unique patterns L₁-L₅, that characterize the L-phenotype. This importance of tumor-clinical environment relationship pattern is such that change in an individual parameter had no significant effect on the L phenotype recognition.

A main result of this approach, by examining micro- and macro-environmental interactions using not arbitrary but the data- and disease defined RRPs, allowed for thorough clinically exactly defining of the impact on the large number of tumor-clinical environment interactions just in the limited number of patterns. Most importantly, it was demonstrated that tumor-clinical environment interaction patterns explained how the same level of an individual parameter can have a different diagnostic and/or prognostic meaning within a different overall context. As an example, the baseline bilirubin level is low in S₁ and S₄, but high in S₂ and S₃, yet all of these are S subtype patterns. By careful analysis of these different relationship contexts, it is obvious that there is no simple (binary) clinical association to other parameters that would link the both high and low bilirubin level to the same tumor phenotype. It therefore appears that minimal meaningful clinical information for recognizing HCC phenotypes needs to use the complete parameter patterns and not individual parameter levels or their simple combinations.

Returning back to the actual reference patterns, they also comprise previously known facts. For example, in the L phenotype, all reference patterns L₁-L₅ are PVT+, all platelet/AFP levels are high, and are all alcohol self-reporting, so that the tumor factors contributing to these phenotype landmarks with the worst survival prognosis are the most aggressive in the conventional clinical sense. Another example uses the fact that it has previously been shown the female gender macro-environmental influence is associated with a less aggressive HCC phenotype. This is fully compatible with the pattern based result for S phenotype RRPs single-parameter changes. In the S phenotype, only S₃ incorporated female gender and the reference odds for S phenotype were the highest among all four S sub-phenotypes. In the remaining S characteristic patterns S₁, S₂ and S₄, the impact of change in gender from male to female on the complete pattern of the tumor—clinical environment relationship pattern resulted in increasing S odds. Thus, PVT, platelets and female gender seem to have an overwhelming influence on phenotype.

If the biology underlying the levels of the assayed screening panel of clinical parameters includes processes that are clinically relevant for the status of the tumor microenvironment, then the change of paradigm in how the “conventional” information is processed will change how these apparently “simple” but extensively used information resources can start contributing to a “higher level” tumor microenvironment understanding. Using clinical profile patterns, removing the obscurity from them, having a non-statistical tool for how to take the standard screening data and convert them (without losing the study statistical power) into a new form of information, where the internal tumor growth factors are directly considered in the deterministic number of clinically well-characterized microenvironment context, provides just that necessary clinical landscape, from which more detailed and complex tumor microenvironment research (and its translation to bedside) can benefit most. After validating these insights in terms of the patient's clinical relationship profile distances from the RRP's landmarks, more detailed analysis of just that limited, but optimal number of landmark clinical statuses, around which patients with a given HCC subtypes are clustered, is possible. Then, instead of reporting on the significance of age or gender or alcoholism, studies can investigate the different prognostic and clinical impact on the patterns of all of these 3 parameters together as contributors to tumor biology. This example has done this systematically, which has led to the identification of specific collections of clinical states and relationship sub-patterns that characterize individual sub-states of HCC and the characteristics of associated clinical environments.

There were clinical differences between the training set (from the first example) and the U.S. set of this example. Most patients from the validation study cohort were not diagnosed through screening, so that they tended to have more advanced disease than the training set patients. This clinical difference between the training and validation cohorts is seen in the results. Besides other evidence, it can be seen primarily in the numbers of the recognized the S and L tumor subtypes. In the training set, nearly balanced fractions of patients in the L and S sub-cohorts (50.8% in L and 49.1 in S) were found. In the U.S. patient validation cohort, 80.6% patients were identified with L and 19.4% with S-tumor subtypes.

At the same time, in the U.S. patients used for validation in this example, the same thresholds were used for dichotomization of blood parameter pairs into low and high levels. In the training study, the definition of these parameters was strictly by tumor size terciles. After looking at the distributions of the patients with the high and low levels of all blood test pairs, it was found that with this clinically more progressed disease cohort, the distribution of these low and high levels of the blood parameters are very close to tercile—related proportions of ⅔ patients with low parameter levels and ⅓ of patients with high clinical variable levels for all 4 blood test parameter pairs.

In one clinical micro/macro environment, a single parameter level can have one diagnostic meaning, while in another clinical environment the meaning of the same parameter level is completely different. Only by analyses such as those made possible via NPS techniques of the subject innovation, which brings the blood test levels into the proper context of the data-captured clinical environment interactions, can all these levels be properly interpreted. This, in turn, is one of the main reasons behind the ability of this approach to identify S and L HCC tumor subtypes.

### Example 4

### Implementation of the NPS HCC Analysis Results for Routine Clinical Practical Use

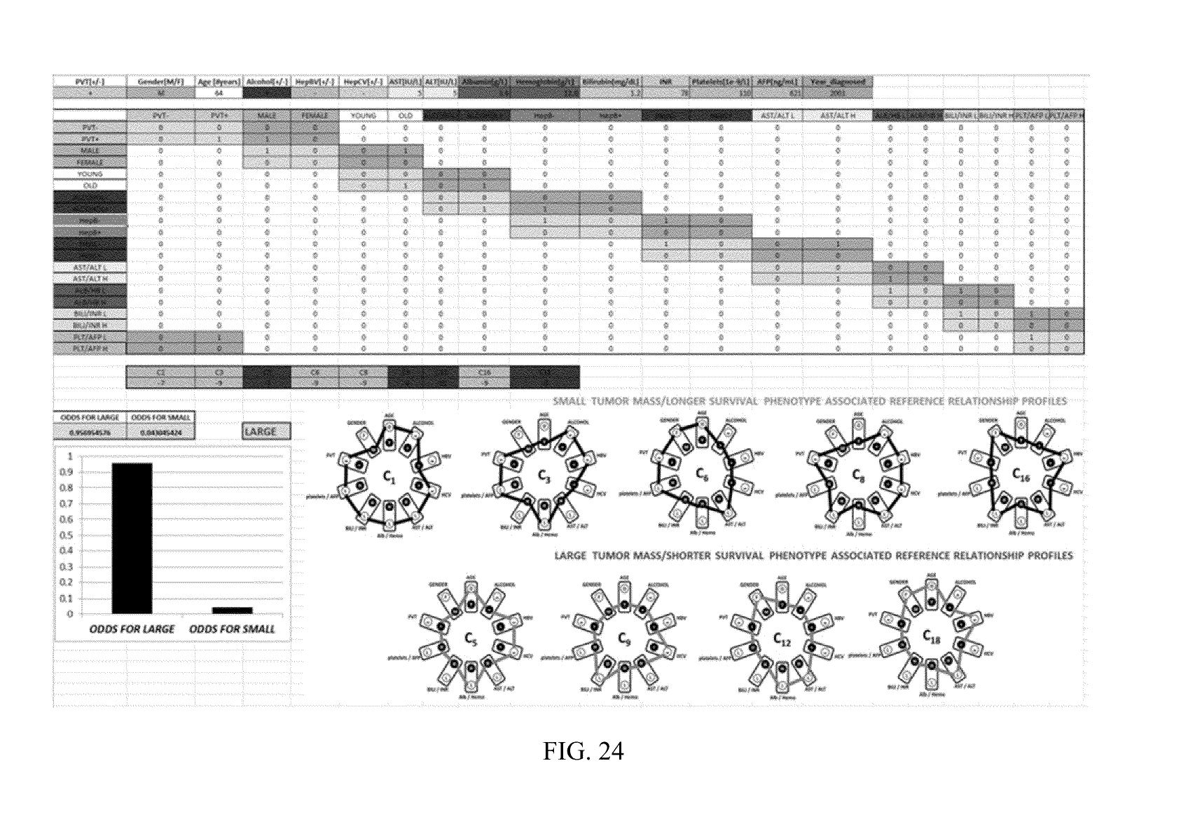

In a fourth example, an actual implementation of the results of the NPS-based examples discussed above for heterogeneity of hepatocellular cancer was developed for routine clinical practical use. While the derivation of the S/L phenotype classification scheme contained an extensive series of interdependent steps, the final result allows for straightforward implementation with standard software tools. FIG. 24 provides a screenshot of an implementation via the Excel platform, which was selected as it is well-accepted in routine clinical practice, together with images of the identified HCC reference profiles. A user or clinician can enters the raw data on the top cells of the worksheet. A classification algorithm can be implemented using Excel functions. The adjacency matrix of the patient's clinical profile Pₖ^{p} can be presented as computed from the input data, and is shown in this example in the main body of the spreadsheet. The personal vector of distances [δₚ¹, δₚ², . . . δₚ^{c}] of Pₖ^{p} from significant reference relationship networks such as those illustrated in the bottom right of FIG. 24 can then be derived and is shown at the bottom of the spreadsheet. A graph can then present the result of optimized logical regression classifier (shown below the spreadsheet), which converts nine distance vector element [δₚ¹, δₚ², . . . δₚ^{c}] values into the odds of patient's hepatocellular tumor phenotype being S and L. The S and L phenotype odds are shown in FIG. 24 both verbatim (“LARGE”, “SMALL”) and as the bar-chart of the two classification odds.

### Example 5

### Application of NPS Analysis in Predicting Response to Chemotherapy for Melanoma Patients, Using Entromics-Processed High-Throughput Genotyping of 384 Polymorphisms in Pathway-Designed 44-Gene Panel

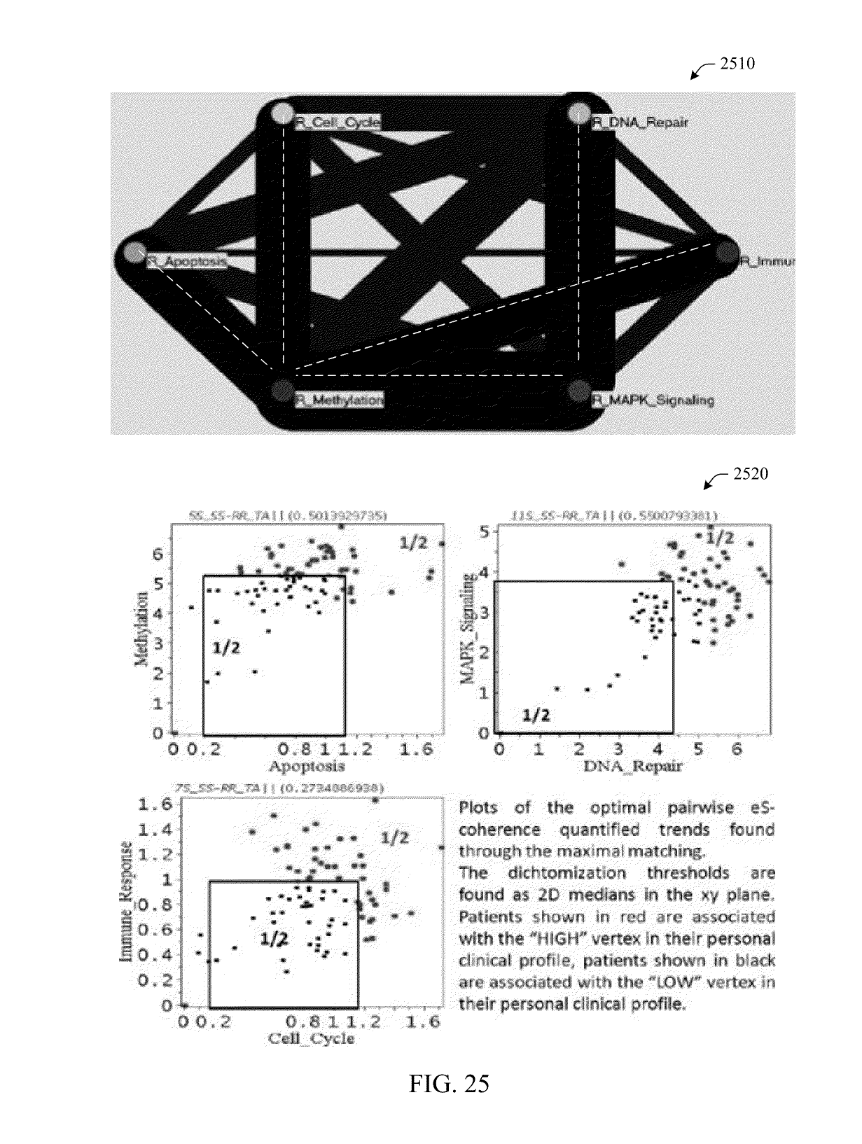

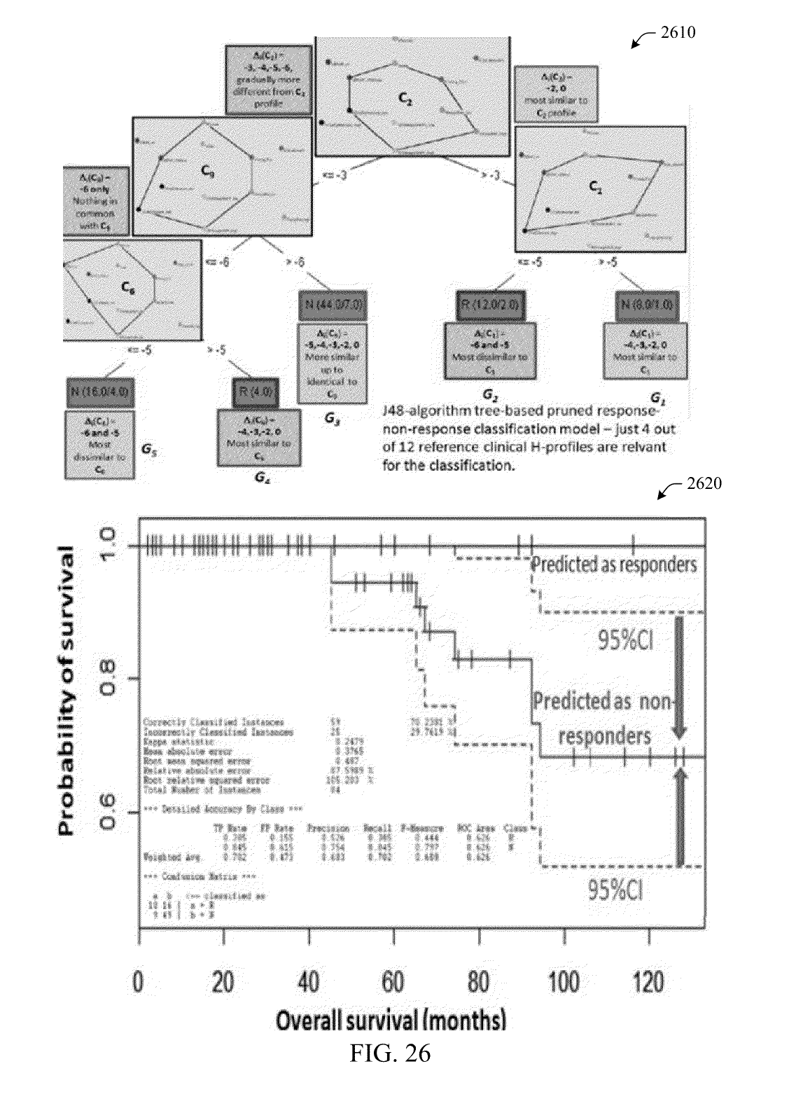

This fifth example demonstrates that NPS principles and steps can be used without modification across diseases as well as for very diverse types of clinical data. This example's design took advantage of the possibility to use entromics conversion of the conventionally categorical genotyping data (polymorphism is present/absent) into values characterizing collective impact of the genetic variations on the gene-gene interaction network, quantifying entromic coherence-relationship in the genome. Entromics converts the individual genotype assay results into differences in the thermodynamic state functions. These can be computed individually, based on each patient's experimentally found genotype (Illumina). This allows simple collection (summation of energy difference contributions from individual polymorphism-associated networks of induced coherence differences). This is characterized by the well-defined (entropy difference based) manner the information about the impact of the personal genotype on the optimal (reference) coherence relationship network from multiple assayed polymorphic genome loci. In this examples design, the different processes in melanoma tumorigenesis, growth and response to chemotherapy (cell cycle regulation, methylation, DNA repair, apoptosis, MAPK signaling and immune response) were considered. After entromic-based design of 384 optimal probes for a panel of 44 genes, the custom-designed microarray was manufactured (Illumina) and genotyping was performed on DNA isolated from 96 tumor biopsy samples from a clinical study targeting chemotherapy outcome. Individual genotyping assay results were processed by the entromics platform and personal differences in coherence entropy networks were computed for every patient. The contributions of differences in coherence entropy were then pooled (summed) from polymorphisms on genes in the six respective pathways into six cumulative pathway-specific network difference entropies. This allowed performing the systematic correlation analysis of the relationships between genomic factors in the six pathways. The same NPS-component algorithm as described elsewhere herein was used—finding the maximal cut in the complete graph edge-weighted by the correlations between the pathway-specific personal differences in coherence entropy networks. FIG. 25 illustrates the maximal cut for this fifth example at 2510 and the resulting pairing of the six pathway-specific data at 2520. Patients were then sub-classified (vertex definition of profile Pₖ^{p}) into high- and low-genetic impact in maximal-cut defined pairs of the respective pathways. (50-50% dichotomization was used for this purpose, as seen in 2520). From individual profiles Pₖ^{p} the 3-partite disease graph was constructed and decomposed by the greedy algorithm into reference relationship networks of paired pathways. Computing distance vector elements [δₚ¹, δₚ², . . . δₚ^{c}] using these reference relationship networks and individual profiles Pₖ^{p} finalized the conversion of the raw genotyping data. The distance vector elements [δₚ¹, δₚ², . . . δₚ^{c}] were then used in a J48-based classification scheme, optimized by pruning to recognizing the melanoma patients known to be responding to chemotherapy from non-responding patients. The significance of this classification scheme was evaluated by 10-fold cross-validation, yielding a significant ROC of 0.63. Additionally, when patient survival was analyzed, classified as responders and non-responders (independently of the actual response or non-response to the study-dependent chemotherapy), nearly ideal separation of their survival odds was found, with better prognosis for patients classified as responders. As the survival was not used in the NPS analysis scheme, this is another example where NPS relationship-based classification of data subset (response to therapy) resulted in correct and independent prognosis of disease outcome. FIG. 26 illustrates the reference relationships and distance vectors classifying responders from non-responders at 2610, and independent Kaplan-Meier survival analysis at 2620 for responders and non-responders.

### Example 6

### Interpretation of Translational Research Evaluating Six CTLA-4 Polymorphisms in High-Risk Melanoma Patients Receiving Adjuvant Interferon

Adjuvant therapy of stage IIB/III melanoma with interferon reduces relapse and mortality by up to 33% but is accompanied by toxicity-related complications. Polymorphisms of the CTLA-4 gene associated with autoimmune diseases could help in identifying interferon treatment benefits. 286 melanoma patients and 288 healthy (unrelated) individuals were previously genotyped for six CTLA-4 polymorphisms (SNP, single-nucleotide polymorphism). Previous analyses found no significant differences between the distributions of CTLA-4 polymorphisms in the melanoma population vs. controls, no significant difference in relapse free and overall survivals among patients and no correlation between autoimmunity and specific alleles. These CTLA-4 genetic profiles were analyzed in this example using Network Phenotyping Strategy (NPS) to analyze the SNP patterns. Application of NPS on CTLA-4 polymorphism captured allele relationship pattern for every patient into a 6-partite mathematical graph P. These graphs P were combined into a weighted 6-partite graph S, which subsequently decomposed into reference relationship profiles (RRP). Finally, every individual CTLA-4 genotype pattern was characterized by the graph distances of P from eight identified RRP's. These RRP's were subgraphs of S, collecting equally frequent binary allele co-occurrences in all studied loci. If S topology represented the genetic “dominant model,” the RRP's and their characteristic frequencies were identical to expectation-maximization derived haplotypes and maximal likelihood estimates of their frequencies. The graph-representation allowed showing that patient CTLA-4 haplotypes were uniquely different from the controls by the absence of specific SNP combinations. Function related insights were derived when the 6-partite graph reflected the allelic state of CTLA-4. It was found that differences between individual P and specific RRPs can be used to identify patient subpopulations with clearly different polymorphic patterns relatively to controls as well as to identify patients with significantly different survival. The example proceeded pursuant to IRB and ethics committee approval.

Adjuvant therapy of patients with stage HB/III melanoma (high-risk) with interferon was approved by FDA (United States Food and Drug administration) and subsequently by regulatory authorities worldwide. Despite the ability of this regimen to reduce relapse and mortality by up to 33%, acceptance has been limited due to toxicity of this regimen. Attempts to identify the subset of patients destined to benefit from adjuvant treatment with IFNa-2b have failed to discover clinical or demographic features of the patient population that are capable of predicting the benefit from high dose interferon (HDI) therapy. Correlative studies have been undertaken over the years, demonstrating a variety of immunological responses subsequent to therapy.

In analysis related to this example, six CTLA-4 polymorphisms were evaluated in a cohort of patients treated with adjuvant interferon. The human CTLA-4 gene is located on chromosome 2q33, in a region that is associated with susceptibility for autoimmune disease and multiple polymorphisms of the CTLA-4 gene have been found to be associated with susceptibility to autoimmune diseases (e.g., the GG allele of the +49 AG polymorphism is associated with decreased expression of CTLA-4 upon T-cell activation and thus a higher proliferation of T-cells).

Genotyping was done on DNA isolated from the peripheral blood of a total of 286 patients with high-risk melanoma who participated in a prospective multicenter randomized phase III trial of adjuvant interferon and a panel of 288 randomly selected healthy unrelated Greek individuals from the Donor Marrow Registry of the National Tissue Typing Center, Athens, Greece that served as a control population for 6 CTLA4-SNPs of potential interest—namely CT 60 (rs3087243), AG 49 (rs231775), CT 318 (rs5742909), JO 27 (rs11571297), JO 30 (rs7565213) and JO 31 (rs11571302). CT 318 is located within the promoter region of the CTLA-4 gene, A/G49 is located at exon 1, while the rest of the SNPs tested are located at the 39 untranslated region of CTLA-4.

High levels of association among the different polymorphisms were found (Fisher's exact p value <0.001 for all associations). Genotypes corresponding to the six CTLA-4 polymorphisms did not significantly deviate from the Hardy-Weinberg equilibrium. This indicated significant linkage disequilibrium among the six polymorphisms. Analysis was performed on the segregation pattern of CT 318, AG 49, CT 60, JO 27, JO 30, JO 31 SNPs on 572 chromosomes and 5 major haplotypes were identified. No statistically significant differences for relapse free survival or overall survival were found for the presence of each of the 3 most common haplotypes. When the respective polymorphisms were considered separately for outcome analysis by the allele status, or when the three most significant haplotypes were considered, two results emerged: (1) No significant differences were found between the distributions of CTLA-4 polymorphisms in the melanoma population compared with healthy controls; and (2) Relapse free survival (RFS) and overall survival (OS) did not differ significantly among patients with the alleles represented by these polymorphisms. No correlation between autoimmunity and specific alleles was evident.

The results reported in the original presentation of this data considered a “dominant model” in which both homozygous and heterozygous copies of the six assayed SNP loci were assumed to have similar effect on altering the CTLA-4 function. The original experimental genotyping results on CTLA-4 genotype profile were used as a risk factor as the basis for the new analysis designed and undertaken in this example. NPS techniques were applied for integrative, relationship-based analysis of clinical data. In this example, NPS replaced analysis of CTLA-4 individual alleles and allele frequencies by the analysis of relationships between CTLA-4 alleles for every individual in the study. Using NPS solved two types of problems: First, the “power” problem was addressed, which complicates the use of methods that approach such complete-relationship based analysis by using large number of interaction terms, which requires large number of subjects for informative statistical analyses. NPS captured instead the actual polymorphism relationship patterns cumulatively into special mathematical graphs. Second, NPS-processing of genotyping data eliminated using an a priori hypothesis about the role of homozygous and heterozygous allelic forms of the studied genomic variants. Graph-theory based representation of the genotyping results through NPS provided unifying quantitative representation of the complete status of all CTLA-4 variants individually for each patient. In the CTLA-4 genotyping data, there is no analysis of independent interrelationships among the 153 possible combinations of AA, AB and BB alleles of the six studied CTLA-4 polymorphism. Instead, the NPS techniques take advantage of the fact that all those 153 relationships can be captured in a single relationship pattern graph. A path in this graph then encodes the actual complete experimental CTLA-4 genotyping results for every studied subject. In this way, the complete information about all allele relationships for an individual can be captured by a single mathematical object. An important property of the NPS analysis is that, from the collection of all individual SNP relationship patterns, the NPS techniques can additionally compute (in a deterministic, non-statistical way) a framework of directly clinically and functionally interpretable reference relationship profiles (RRP). These RRP's represent “landmarks” in the (multidimensional) clinical/genotypic relationship data space. The clinical significance of the RRP landmarks can then be measurable in terms of how many patients have close (but not necessarily identical) personal CTLA-4 genotype relationship patterns to those “landmarks.” For the concrete example of CTLA-4 polymorphisms studied in this example, RRPs represent limiting characterization of the CTLA-4 SNP co-occurrence patterns. One advantage of the NPS approach is its identification of any significant heterogeneity that might be captured in the data from the clinical, or in this case the CTLA-4 based immune regulation mechanism that was focused upon in this study of subjects with and without melanoma. These results can be then used in designing follow-up clinical studies.

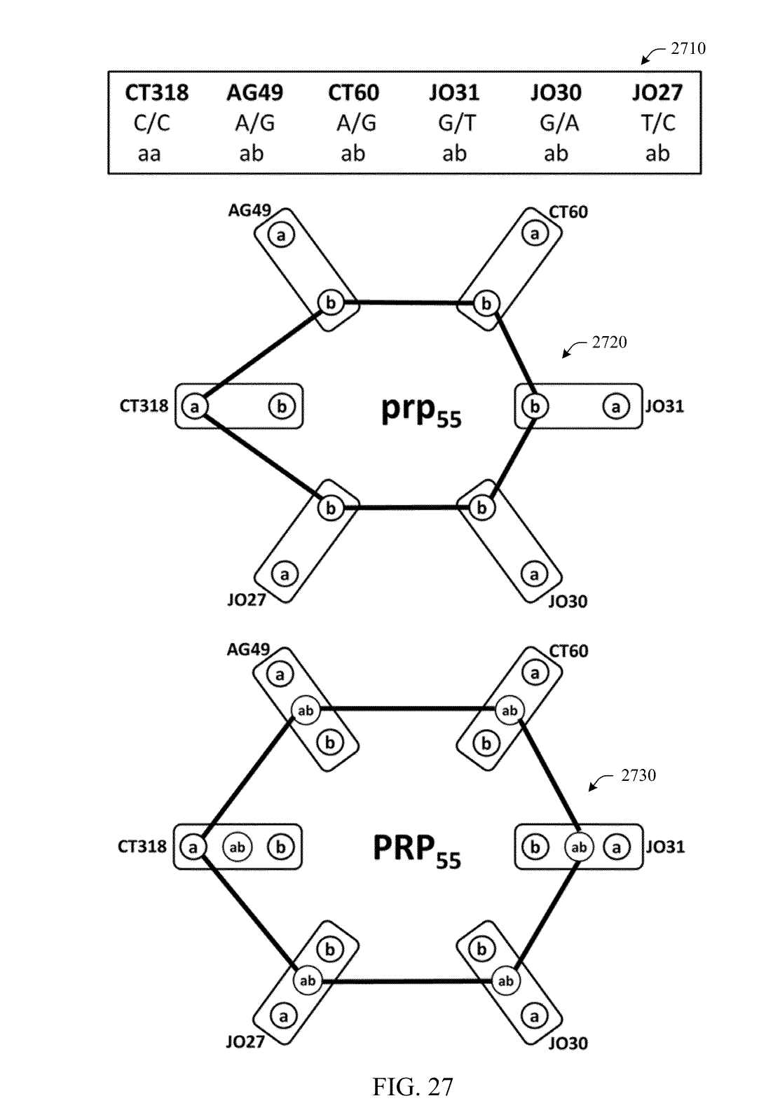

Characterization of personal CTLA-4 genotype relationship pattern by 6-partite graphs: Identifying the part of the study data in which there is maximal information to extract additional components of information: This example presents two levels of CTLA-4 genotype analysis. In the first one, there is no distinction between homozygous or heterozygous status of the six alleles. In the second one, the genotype characterization is expanded using the known zygosity of the six SNP's. FIG. 27 shows an example of an experimentally determined CTLA-4 genotype for a patient 2710 can be transformed into graphs 2720 and 2730 of personal relationship profiles for the patient. In 2720, the observed CTLA-4 genotype for one patient 2710 may be represented by a 6-partite graph that will be called a personal relationship profile prp, which was used for the purpose of the first analysis type, considering the major/minor allele relationships only. At 2720 is shown the second type of personal relationship profile, for which the symbol PRP is used to emphasize that allele relationships include observed allele zygosity. In both these representations, each assayed SNP is represented by one of six partitions in the prp or PRP. Each partition contains two or three vertices, representing the allele for a given polymorphism (a=major allele, b=minor allele in prp, a=major homozygous, ab=heterozygous, b=minor homozygous allele in PRP). Edges in both graphs connect only those vertices in different partitions that represent observed (genotyped) alleles in the two different polymorphic sites. The complete CTLA-4 genotype profile for an individual is then a collection of edge-connected vertices in prp/PRP, forming a cycle in prp/PRP.

Because the edges in prp/PRP represent relationships between the allelic states of the studied SNP's, there is clear meaning for each segment of the CTLA-4 genotype illustrated in the hexagonal cycle. These lines can be understood as conditional relationships such as “if AG49 contains the minor allele then CT60 also contains the minor allele and J031 contains the minor allele and then . . . .” Note that the experimentally defined cycle in e.g., prp represents not only the pair wise conditional relationships shown by lines such as (AG49=b when CT60=b), but also all other co-occurrences such as (AG49=b when J030=b) etc. The prp/PRP cycle representation of the CTLA-4 SNP allele status co-occurrences is the simplest one capturing all co-occurrence relationships while maintaining convenient mathematical simplicity.

Collective characterization of CTLA-4 genotype profile distribution in a cohort by cumulative weighted 6-partite graph G: While PRP's are exact “qualitative” representation of the studied polymorphism relationship patterns in CTLA-4, this qualitative information needs to be converted into a quantitative characterization of these individual relationship patterns. It has been shown by exact mathematical theorem that the maximal quantitative information captured by graphs is obtained when PRPs are compared to one another in graphs of the same type, which are referred to herein as reference relationship patterns (RRPs). Therefore, the next step of NPS transformation of the CTLA-4 polymorphism relationship patterns into quantitative descriptors was to use the actual data to derive the 6-partite graphs, representing the desired RRPs.

For this purpose, the individual prp or PRP graphs, describing the SNP co-occurrences for all subjects were assembled into cumulative 6-partite “study graphs” g and G. By adding every individual patient CTLA-4 genotype profile representation prp to the cumulative g graph, the weightings of every edge in g is increased by one, and similarly but independently for PRPs and G. As a consequence of this construction, these g and G graphs will have weighted edges defined by the co-occurrence frequencies of all SNP pairs. The distribution of all individual CTLA-4 genotype profiles in the case cohort is represented by graph g.

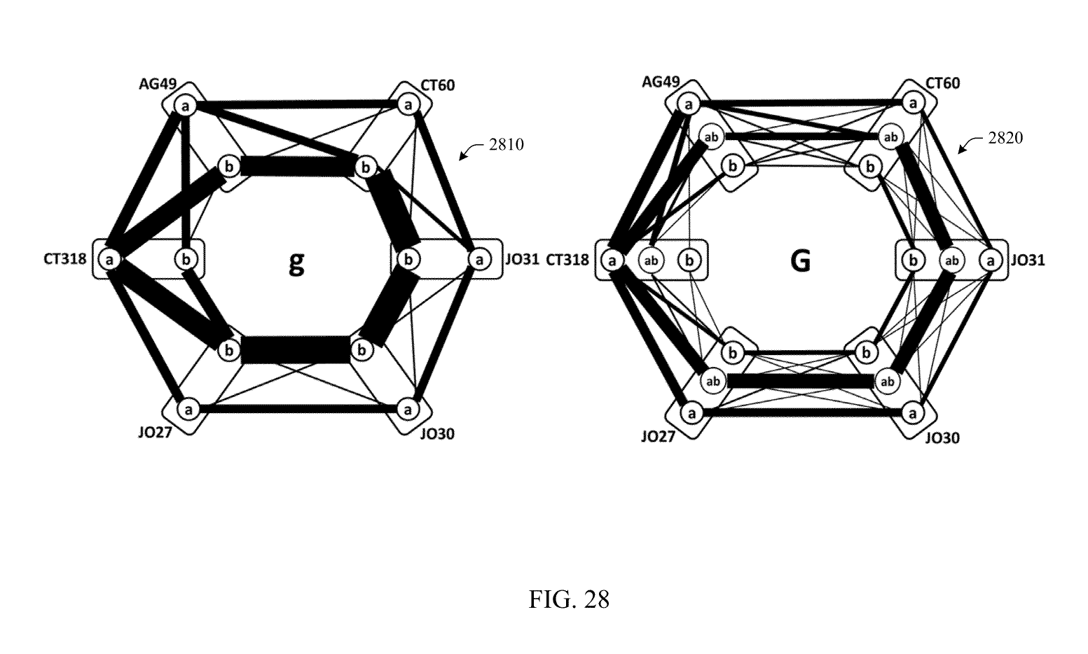

FIG. 28 illustrates the study graphs g at 2810 and G at 2820, constructed as unions of all prps or PRPs, respectively. In FIG. 28, the relative edge weights resulting from adding all individual case graphs prp and PRP to g and G, respectively, are graphically represented by the variable relative thickness of the edge lines. By converting these edge counts to frequencies, statistical interpretation of the basic vertex-weighted edge-vertex (a-b), (a-a), (b-a) and (b-b) motifs in the study graphs was obtained. The weights of the study graph edges connecting, for example, the major and minor allele vertices in the AG49 and CT60 partitions define the estimates of the following conditional probabilities: (1) a-b˜P(AG49→a|CT60→b); (2) a-a˜P(AG49→a|CT60→a); (3) b-a˜P(AG49→b|CT60→a); and (4) b-b˜P(AG49→b|CT60→b).

In the next step, the complete sets of reference relationship patterns for CTLA-4 genotypes in both study graphs g and G were identified and in case of g identified as haplotypes: Haplotype is defined as a series of polymorphisms in CTLA-4 genotype profile that are co-occurring with identical probabilities, P(1)˜P(2)˜ . . . ˜P(6). Using the conditional probability interpretation of edges in the study graphs discussed above, Bayes' theorem can be used to derive that if sub-graphs of the study graph with equal weights (co-occurrence frequency components) are found, the condition of P(1)˜P(2)˜ . . . ˜P(6) is automatically fulfilled. Thus, in this representation, a complete set of haplotypes is represented by all RRP cycle subgraphs with equal weights of all edges, which can be found in g or G by a “greedy” algorithm as described above.

For validation of this study graph-based approach to haplotype identification, established procedures were additionally used where the maximum likelihood estimates of haplotype frequencies given a multi-locus sample of genetic marker genotypes [3 different genotypes of the 6 polymorphisms] were generated using the expectation-maximization (EM) algorithm under the assumption of Hardy-Weinberg equilibrium (HWE). Linkage disequilibrium was explored for each pair of the 6 polymorphisms (PROC HAPLOTYPE). SAS 9.1 (SAS Institute Inc., Cary, N.C., USA), was used for the statistical analysis.

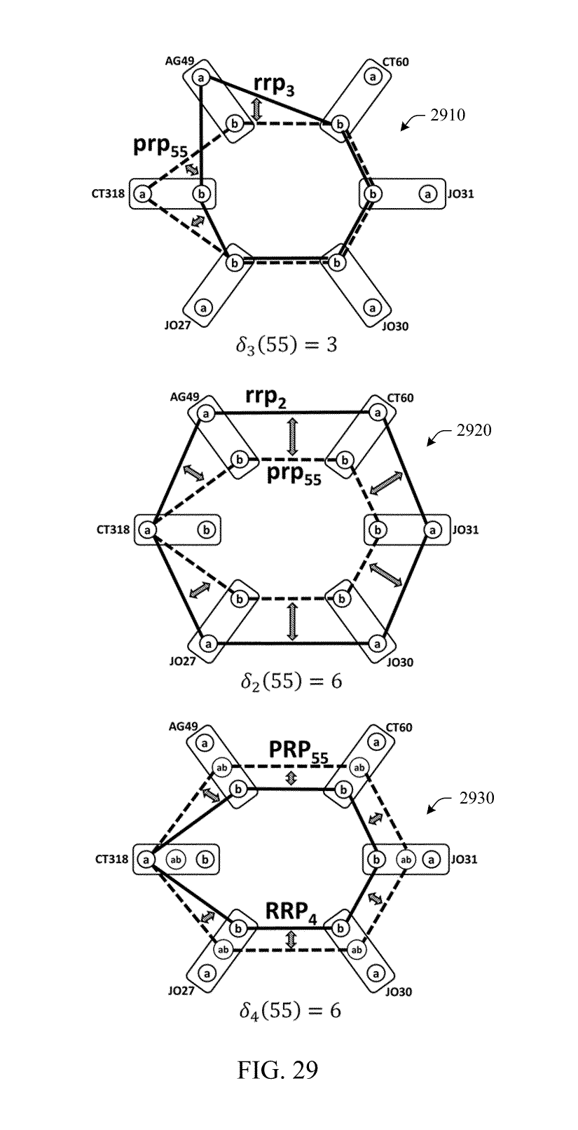

Quantitative characterization of differences of personal CTLA-4 genotype profiles prp and PRP from haplotypes, represented by rrps and RRPs: For the quantification of the graph-graph distances between individual patient relationship patterns and haplotype-reference relationship patterns, mathematical results discussed herein were used, showing that one of the possible definitions of graph-graph distances with all necessary mathematical properties can be obtained simply by counting the number of edge mismatches between the two graphs. FIG. 29 illustrates three examples showing how elements of distance vectors are computed for the same patient, #55. In 2910 and 2920, the dashed line represents the prp for the patient (it and the PRP in 2930), and the solid line represents the rrp in 2910 and 2920 (and RRP in 2930). Double arrows indicate mismatch in SNP co-occurrences. Elements of \vec{δ}ⱼ are sums of these mismatches (in computations, the negative sign is used to make identity (zero mismatches) mathematically the largest). 2910 is a comparison with rrp₃ and 2920 is a comparison with rrp₂, while 2930 is a comparison with RRP₄. As a result, with haplotype decomposition of study graph g resulting in 8 haplotype components, each subject (j) was characterized by an 8-element vector \vec{δ}ⱼ=[δⱼ(1), δⱼ(2), . . . δⱼ(8)] of eight distances of the personal CTLA-4 genotype profile from compositions of all 8 respective haplotypes identified. Difference vectors \vec{δ}ⱼ were computed for all patients and controls using a) the control cohort-defined haplotypes and b) the case cohort-defined haplotypes.

Developing the hierarchical model for differentiating between healthy controls and melanoma cases using the CTLA-4 based personal genotype profiles from haplotypes: the Weka package (v. 3-6-6) implementation of J48 pruned tree algorithm was used to construct an optimal model recognizing the controls from cases using personal difference vectors \vec{δ}ⱼ. Ten-fold cross-validation was used and characterized the model quality by confusion matrices and ROC parameters.

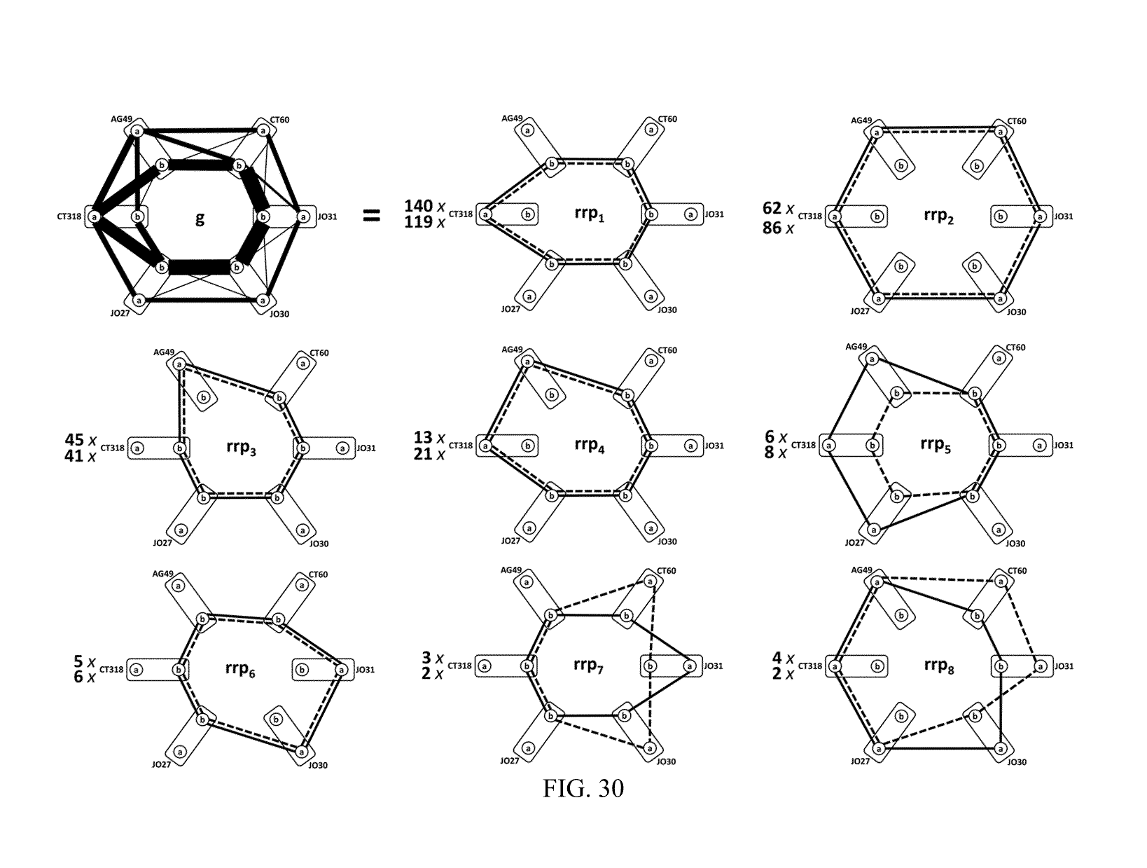

FIG. 30 shows decomposition of the g graphs for healthy controls 2810 and melanoma cases 2820 into component cycles rrpᵢ, representing the haplotypes derived from individual genotyped profiles, containing CT60 (rs3087243), AG49 (rs231775), CT318 (rs5742909), J027 (rs11571297), J030 (rs7565213) and J031 (rs11571302) SNPs.

Decomposing the 6-partite graph G constructed with explicit 3 allele states resulted in 20 RRPs. We then computed a 20-component vector of distances \vec{δ}ⱼ for every personal CTLA-4 genotype relationship pattern from all 20 RRPs.

In both cohorts, the respective g graphs were decomposed into 8 cycles rrpᵢ (i=1 . . . 8). Interestingly (and importantly) the three haplotype graphs with the largest frequency were identical for control and case cohorts. Table 3 shows that the g-based graph algorithm also identified the same dominant haplotypes and comparable frequencies of occurrence as the statistical algorithm in (PROC HAPLOTYPE). SAS 9.1 (SAS Institute Inc., Cary, N.C., USA).

TABLE 3
CTLA-4 most frequent haplotypes identified by two methods - using
HAPLOTYPE procedure in SAS and from multiplicity of rrps in
decomposition of study graph g

| | | | | | | Haplo- | | |
|---|---|---|---|---|---|---|---|---|
| | | | | | | type | | |
| | | | | | | freq. via | | Haplo- |
| | | | | | | prior | | type |
| | | | | | | study | Std. | freq. via |
| AG49 | CT60 | CT318 | JO27 | JO30 | JO31 | (%) | err. | rrps (%) |
| A | A | C | C | A | T | 46.99 | 2.089 | 45.7 |
| G | G | C | T | G | G | 29.34 | 1.91 | 23.0 |
| A | G | T | T | G | G | 9.77 | 1.24 | 10.2 |
| A | G | C | T | G | G | 6.49 | 1.031 | 6.0 |
| A | G | C | C | A | T | 2.81 | 0.69 | 2.5 |

A unique feature of this approach in comparison to the analysis of differences in haplotype frequencies that were tested in the previous analysis of the data set is that the NPS techniques can quantitatively characterize the difference of the individual genotype profile from “averaged” CTLA-4 haplotype profiles. FIG. 29 demonstrates the meaning of the differences. In the example of 2910, patient P₅₅'s CTLA-4 genotype profile captured into prp(55) matched the composition of the graph representation of haplotype rrp₃ in just three edges, thus the δ₅₅(3) was 3. In the second example, 2920, CTLA-4 genotype profile of the same patient is compared to the C₂ haplotype. Here no edges in ppr(55) coincided with those of rrp₂, thus the δ₅₅(2) was 6. This is an example of the maximal difference between any haplotype subgraph rrpᵢ and individual CTLA-4 genotype profile prp(j) that can be found in g.

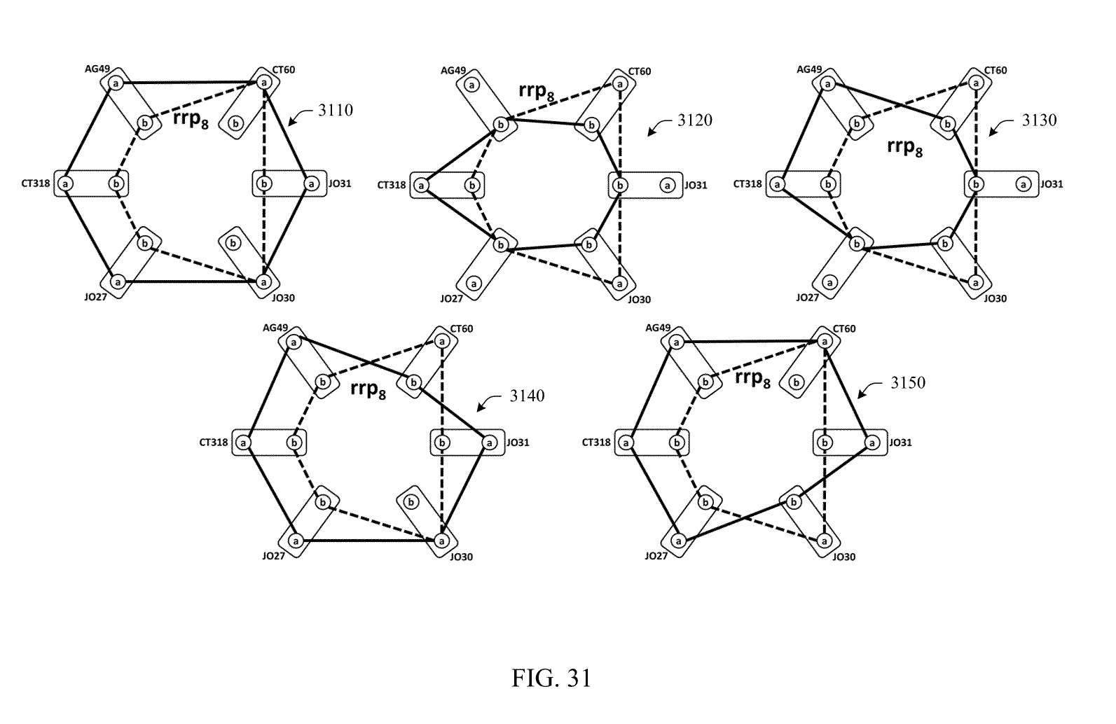

FIG. 31 illustrates case-control discrimination by “missing” CTLA-4 genotype reference profile rrp₈, shown as the dashed lines in all images. The solid lines in images 3110-3150 show five prp CTLA-4 genotype profiles, found exclusively for 219 (77%) patients identified from the complete case cohort by condition that their prp have maximal possible distance from the rrp₈. Top level of CTLA-4 genotype profile-based differentiation between cases and controls is related to SNP pattern rrp₈=(bbabab) for (CT318-AG49-CT60-1030-1027) cycle, as seen in FIGS. 30-31. 77% of melanoma cases (219 patients) were recognized from healthy controls by the absence of the rrp₈=(bbabab) allele pattern for the (CT318-AG49-CT60-JO30-JO027) SNP cycle. By surveying all 219 CTLA-4 individual genotype profiles for patients with δᵢ(8)=6 it was found that all have one of the five co-occurring patterns, shown by solid line cycles in images 3110-3150. By overlaying the rrp₈=(bbabab) case-control differentiating pattern (dashed line cycles) over these actual case-specific genotype profiles it was shown that the rrp₈ pattern did not share any relationship with these 5 melanoma-characteristic CTLA-4 SNP co-occurrence patterns, indicating the possibility of disease risk identification not by presence, but actually absence of a specific genotype profile. Graph mathematics opens the previously overlooked half of the marker identification “universe”—allowing for the study of invariants (such as the personalized differences of CTLA-4 genotype profiles from the haplotype reference) and identifying multiple SNP relationship patterns that share certain properties (simultaneous presence or absence of a specific combination of parameters).

The first information that comes from NPS-graph of the CTLA-4 genotype considering the “collective allelic status” of all six studied SNP's, as seen in 2820. With exception of CT318, there is a strong preference for “allelic state conservation” in all remaining loci: most frequent allelic status for (CT318-AG49-CT60-JO30-1027) SNP is heterozygous (a-ab-ab-ab-ab-ab) profile, the second most frequent is profile with all homozygous wild-type alleles, followed by homozygous (a-b-b-b-b-b) profile. Subjects who had mixed type zygosity (a-ab-a-b-a . . . etc) CTLA-4 profiles were minority in this study cohort. Because it was known that there were no characteristic simple CTLA-4 genotype patterns that would differentiate healthy controls from melanoma cases, the analysis instead looked for differences in distances from the all possible RRP₁-RRP₂₀ pairs that would maximize the separation of the two sub-cohorts. The motivation for this approach is as follows: the pattern-based genotype data transformation captures more details of inter-subject differences in genetic status of CTLA-4 than can be captured by any conventional analytical approach. This information enhancement can be further increased by explicitly considering the actual allele statuses as discussed above, the identification of the clinically relevant context relationship CTLA-4 genotype pattern was obtained by looking for a higher frequency of patients or controls with smaller distances from selected RRPs relative to others.

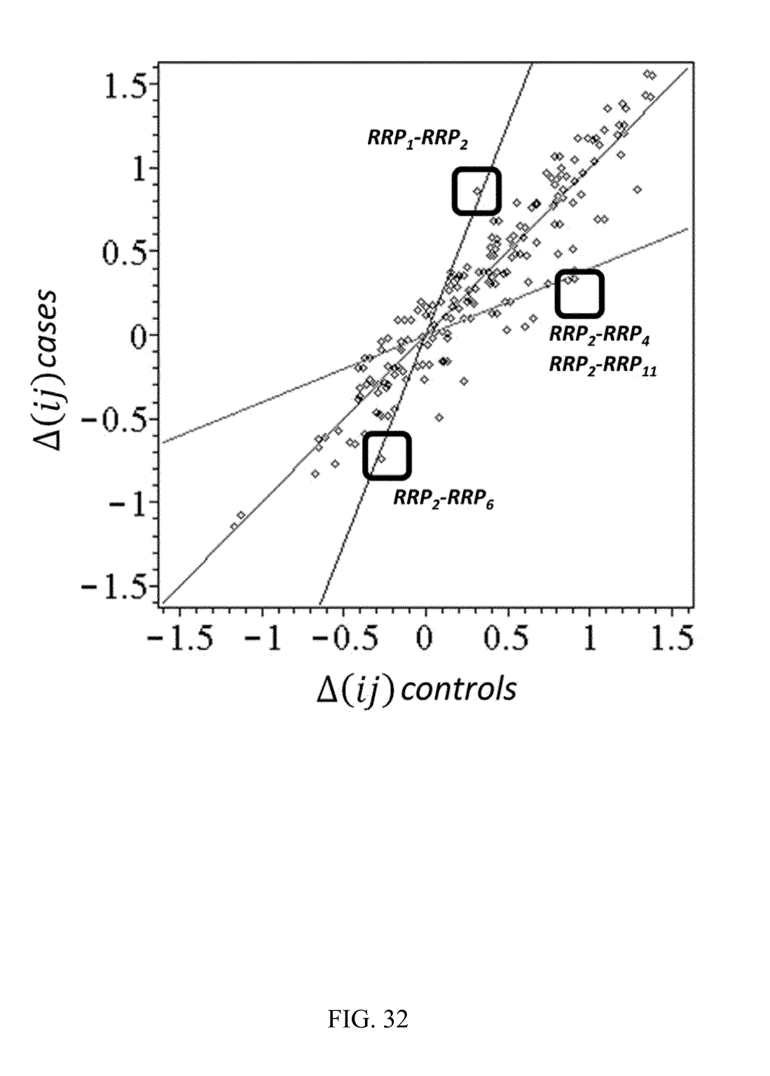

An element of the \vec{δ}ⱼ vector characterizes the distance of the personal CTLA-4 genotype pattern from reference, but does not include directionality and distances of the personal CTLA-4 genotype pattern from other reference patterns. To include that information into processed data, a complete set of 190 pairwise distance differences \vec{δ}ᵢ−\vec{δ}ⱼ was computed, with i and j going through all 20 elements of the CTLA-4 differences from the four maximally case-control biased reference patterns RRPᵢ−RRPⱼ identified in FIG. 32, illustrating selection of the maximally case-control survival discriminating combination of distances from all RRPs. Points in FIG. 32 are defined by the [Δₚ(ij),Δ_{c}(ij)] coordinates computed by averaging the distance differences over all patients separately in case and control sub-cohorts for all 190 possible RRP pairs. In the neighborhood of diagonal line Δₚ(ij)=Δ_{c}(ij) are non-discriminatory combinations. The two lines are used to identify the combinations, with maximal case-control and control-case bias in PRP-RRP distances. The optimal selection is shown by boxes. These differences include directionality of the closeness of the personal genotype to one of the reference genotype patterns: Δ(ij)=δ_{RRP}_{ᵢ}(k)−δ_{RRP}_{ⱼ}(k) can be positive or negative. Assume that δ_{RRP}_{ᵢ}(k)=−7, δ_{RRP}_{ⱼ}(k)=−3. Then δ(ij)=−7−(−3)=−4<0. Thus, Δ(ij)<0 indicates that a personal CTLA-4 genotype profile is closer to RRPⱼ while Δ(ij)>0 indicates that personal CTLA-4 genotype profile is closer to RRPᵢ and Δ(ij)=0 means that the personal CTLA-4 genotype profile has the same number of differences when compared either to reference profile RRPᵢ or RRPⱼ. Δ(ij) was computed using distances from all 190 possible RRP pairs, separately for cases and controls and averaged them for each sub-cohort, obtaining case mean Δₚ(ij) and control mean Δ_{c}(ij) for each RRP pair. Plotting these case and cohort averages against each other in the two-dimensional scheme allows direct identification of the reference CTLA-4 genotype pattern combinations that separate maximally the two sub-cohorts. For uniformly or randomly distributed CTLA-4 genotype pattern positions, Δₚ (ij)=A_{c} (in can be obtained, seen in the 2D plot as the diagonal y=x line. The combinations with maximal Δₚ(ij)>A_{c}(ij) or Δₚ(ij)<Δ_{c}(in, which are the desired clinically characteristic contexts, will be in the 2D plot maximally distant from the diagonal. FIG. 32 shows the resulting 2D plot with the extreme combinations of the references indicated. The region of Δ(ij) in smaller than 0.5 is not considered, as there the subject's CTLA-4 genotype patterns are on average equally distant from both reference pairs.

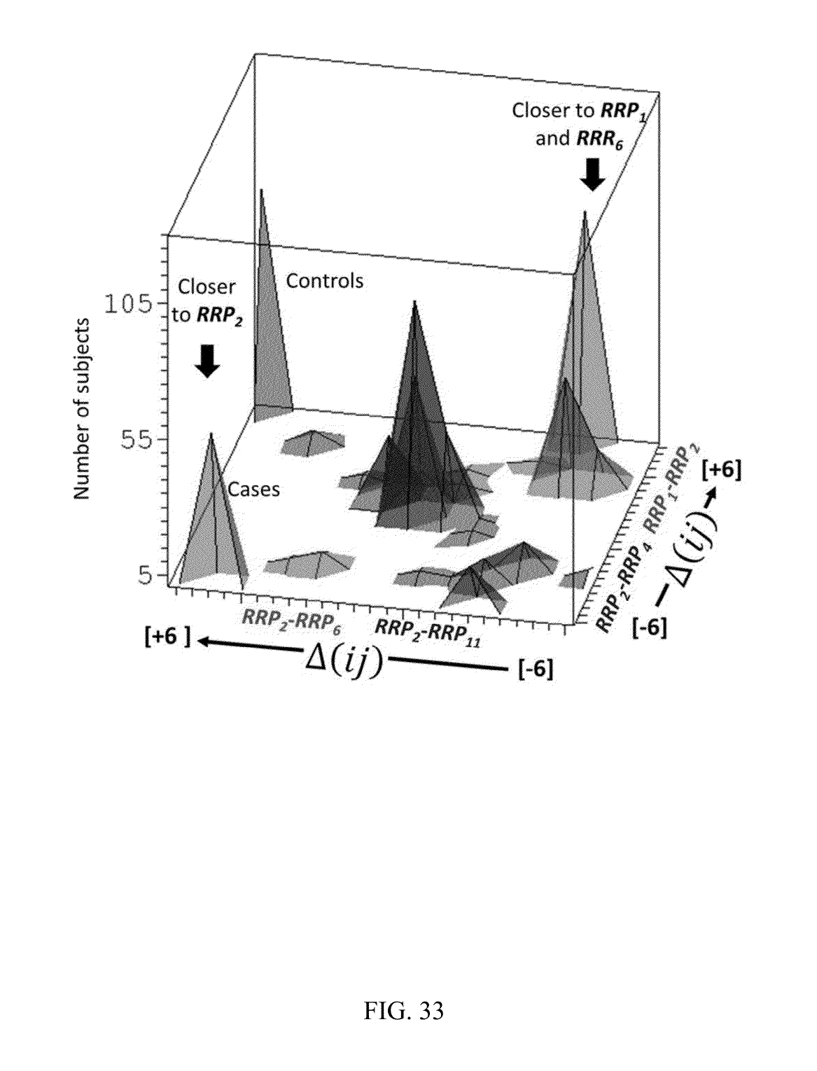

FIG. 33 shows a histogram of patients with observed valued of Δ(ij), showing heterogeneity of distributions of individuals shown in the CTLA-4 genotype landscape, defined by the inter-personal distances in prps for the five most discriminating RRP combinations. Two selected combinations of δⱼ(i)−δₖ(i) distance differences are plotted on x and y axes, and on the z axis are numbers of subjects having a given combination of the distance differences. The patient or control distribution in the CTLA-4 genotype pattern space was not uniform or normal. Clear heterogeneity can be seen: In both groups, there are three main patient subgroups. One, common for cases and controls has CTLA-4 genotypes equally different from all reference CTLA-4 allele relationships (the central peak). Then there are two groups with their individual CTLA-4 genotype patterns significantly closer to one than to the other reference genotype relationship network.

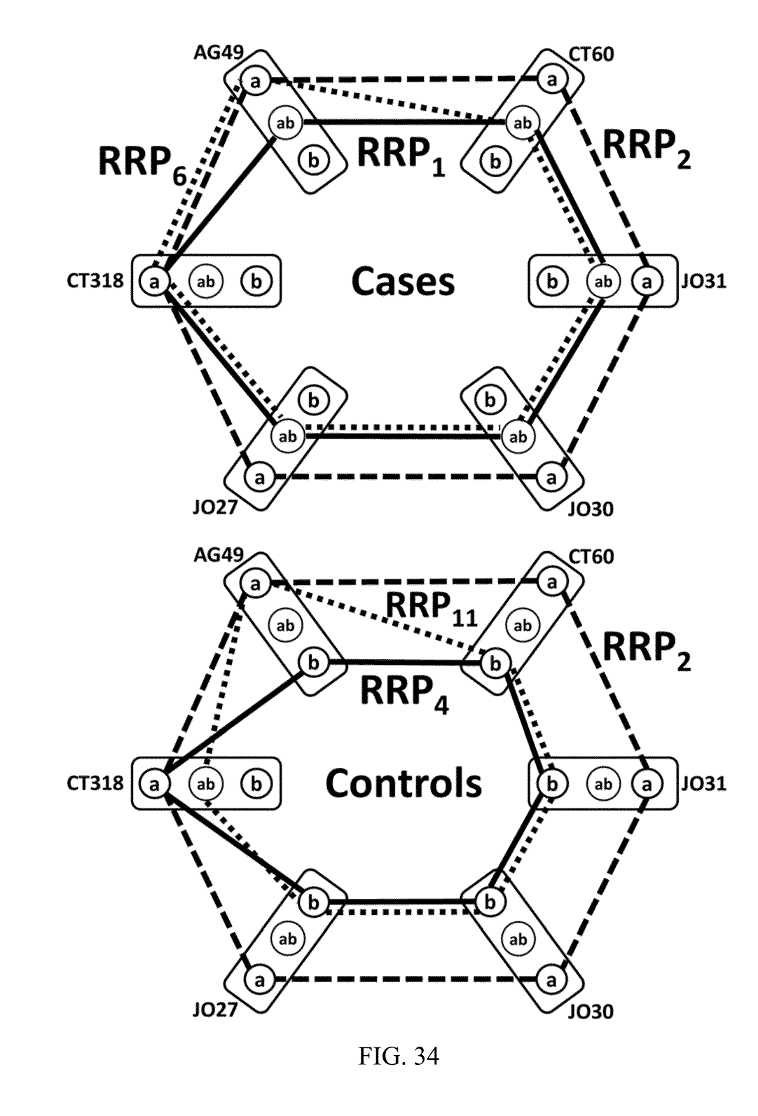

FIG. 34 shows the actual composition of these reference CTLA-4 genotype patterns for cases and controls. For controls, the dominant reference CTLA-4 genotype pattern is all major allele combination (RRP₂) while for cases, RRP₁ dominates, where majority of studied CTLA-4 polymorphisms were in the heterozygous state. This heterogeneity might be utilized in focused prospective study of patients within the three subgroups identified: One being characterized by the minimally genetically affected CTLA-4, another having majority of CTLA-4 polymorphisms with heterozygous state and the third with mixed CTLA-4 genotype relationship patterns, equally different from the two extremes. It is clear that, contrary to melanoma patients, the healthy biosystem of controls can accommodate the CTLA-4 genetic variation where a majority of studied polymorphisms relate to the minor allele states that are identified as reference contexts for two groups with CTLA-4 genotype patterns different from “normal” RRP₂.

Out of the 286 melanoma cases, there were 282 with survival data. Characterization of the possible differences between the long- and short-surviving patients now requires a different analysis strategy. First, the choice of CTLA-4 genotype reference relationship patterns was tested. After separate testing of results from NPS analysis of melanoma case CTLA-4 genotype relationship profiles, it was found that the simplest and statistically most significant results were obtained when the RRP₁-RRP₂₀ resulting from the analysis of combined case/control cohort were used. That makes sense in light of previous standard statistical analysis indicating no significant differences in the actual CTLA-4 genotype patterns. A larger cohort combined from cases and controls provided better coverage of the possible reference CTLA-4 genotype relationship patterns. Moreover, the results were significant when the case sub-cohort was analyzed separately, and overlapped with the patterns identified using differences of distances from the combined analysis.

For the analysis of CTLA-4 genotype relationship pattern differences between the survival categories, a different strategy was used to make sure that what was found was indeed significant. An overall survival threshold was defined and the cohort was separated into patients who lived longer or shorter than the selected threshold. The complete analysis described below was then run, the statistical significance compared, and logistic regression models performed to recognize the survival categories from the Δ(ij). Survival data was systematically iterated through a threshold of 800 days to a threshold 1900 days, and the optimal threshold was found at 1820 days (5 years). This threshold separated the cohort into balanced sub cohorts of 145 shorter and 137 longer surviving patients.

The Δ(ij) was then computed separately for both these survival-defined sub cohorts and the distributions of the results were tested for all 190 CTLA-4 reference relationship pattern pairs. Out of the 190, only 4 combinations resulted in the statistically significantly different means of these distributions, as seen in the p-values of Table 4:

TABLE 4
p-values for difference in mean difference distributions
for distances of PRPs from RRP pairs, differentiating two
survival groups (longer and shorter than 5 years)

| RRP combination | p-values |
|---|---|
| RRP₈-RRP₁₀ | 0.022 |
| RRP₁₀-RRP₁₃ | 0.024 |
| RRP₁₀-RRP₁₆ | 0.025 |
| RRP₁₀-RRP₁₅ | 0.043 |

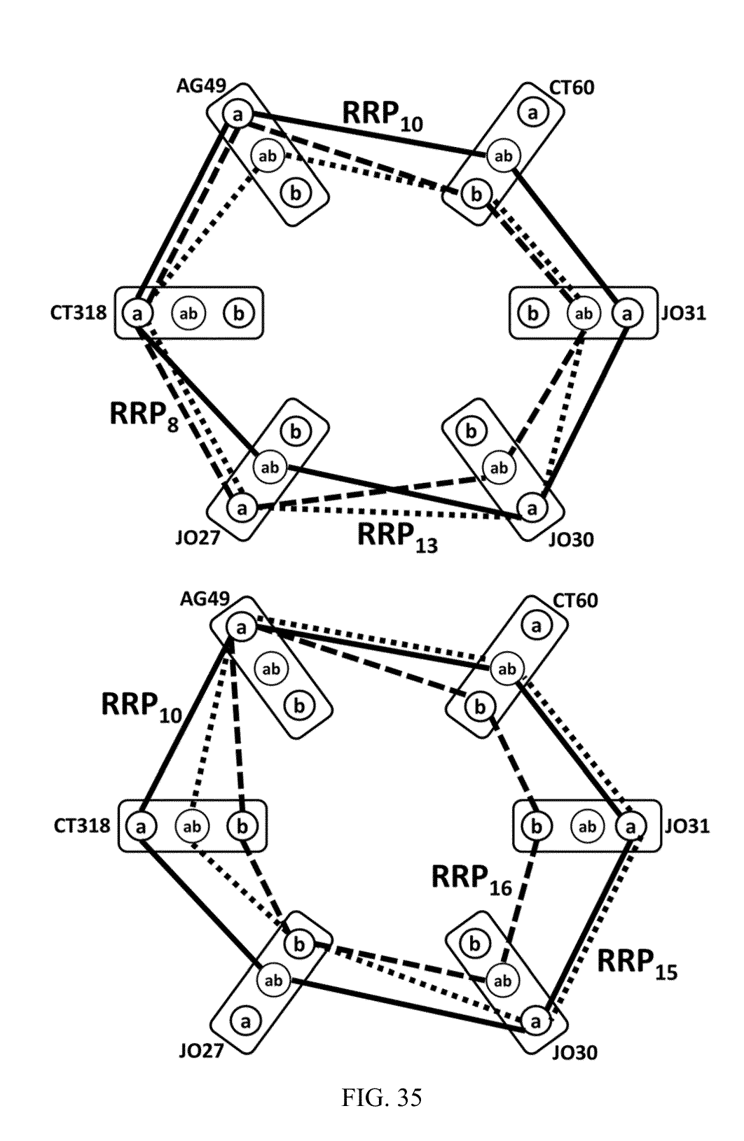

Here, RRP₁₀ reference pattern is the common context in all these CTLA-4 genotype relationship patterns, which are significantly biased between the longer and shorter surviving melanoma patients. A similar interpretation is possible for the localization of the typical CTLA-4 genotype relationship patterns for these outcome different patients: For example, shorter surviving patients have typically positive Δ(ij) for RRP₈-RRP₁₀, so they are closer to RRP₈, meaning that their CTLA-4 genotype tend to converge to 4 minor, one heterozygous and one major allele, as seen in FIG. 35, illustrating a comparison of RRPs, distances from which are most significantly different in the two survival groups (overall survival longer or shorter than 5 years). RRP₁₀ is shown by solid edges in both graphs.

A similar interpretation is possible for the remaining significantly different genotype pattern pairs: RRP₁₀-RRP₁₃ pairing have typically zero Δ(ij) for shorter surviving patients, and positive for longer survivals, indicating that RRP₁₀ pattern with 4 major and 2 heterozygous alleles provides better functioning CTLA-4. Note that—contrary to genotype profiles with conserved allelic states of CTLA-4 polymorphisms—the CTLA-4 genomic profiles typical for cases-only cohort describe states of mixed allelic states of the six polymorphisms. For (CT318-AG49-CT60-J030-JO27) profile, the RRP₈ has (a-a-b-ab-ab-a) allelic pattern, for RRP₁₀ it is (a-a-ab-a-a-ab) pattern. These results allow characterization of the odds for overall survival shorter than 5 years for new patients with known status of six CTLA-4 SNP's. This computation was implemented into a Excel worksheet, similar to that shown in connection with the previous example.

Using a novel approach to the analysis of SNP results for the CTLA-4 gene, it was hypothesized that recognition of melanoma risk genotype profile requires an added dimension of analysis. This second step in the analysis progression moves from analyzing the means and variance of independent SNPs to analyzing the distributions of differences of individual CTLA-4 genotype profiles in the studied cohorts, in reference to normative reference profiles.

The observed haplotypes appear to be the proper reference for this purpose, and should be used to account for interpersonal variability in CTLA-4 genotype profiles. The approach generates 6-partite graphical depictions which are based upon algorithms that identified the same haplotypes and their frequencies in established statistical procedures Importantly, this algorithm has shown that the haplotypes are not markers by themselves, but rather that their averaged constructs, identifying common co-occurrences of CTLA-4 SNPs in case and control cohorts are useful. Having both personal CTLA-4 genotype profiles and the normative reference co-occurring CTLA-4 SNP haplotype patterns represented by the K-partite graphs has two main advantages:

First, it determines from the data used to construct the g and through the decomposition algorithm developed from the statistical conditions used in general characterization of haplotype the actual total number of haplotypes in the cohort (8 in both cohorts). Considering that the theoretical number of haplotypes for g is 64, this is an important data reduction outcome of this approach. It was known from the above discussion that in cases where deconstructed 6-partite graphs are close to random distributions of the conditional probabilities, the number of components needed to fully deconstruct the model increases significantly. Thus, small number of components in the g deconstruction implies the commonality/regularity in the CTLA-4 genotype profile composition and frequency in the example population. This was in agreement with the previous study's results.

B. The component graphs rrpᵢ are data-driven, information-rich references for exact quantitative computation of the \vec{δ}ⱼ descriptors, which are tools enabling to change the focus of the analysis from means and averages to where they are needed (i.e., towards differentiating features) Importantly, the rrpᵢs are not just mathematical constructs, but have well-defined genomic meaning, being haplotypes. This facilitates clinically relevant interpretation of the results in general and the individual (personalized) disease related markers in particular. Results validate the hypothesis.

Another important aspect of this example is its “translation” of the main molecular result of the example to design of tools and algorithms that use the relationship-patterns between genotyped CTLA-4 variants to enable differential outcome analysis. This approach allows for showing that in the relationship patterns picture of the individual CTLA-4 genotype, differential outcome can be caused by a “majority rule,” understood as a larger than critical deviation from an ideal, reference haplotype relationship pattern. Thus, the same impact can be observed for different combinations of the personal CTLA-4 variants, which is clearly quantitatively captured in the NPS (relationship) based analysis, but causes problems in conventional approaches. This sharing of a certain level of differences from a reference normative pattern is very specific in relation to the kinds of patterns that share a particular property. This linkage of several heterogeneous patterns to one “functional” patient's individual difference is that other side of clinical data understanding, which can be brought into analysis using this approach.

Without the pattern-based approach, it would not be possible to recognize the relationship between those patterns or to investigate what is unique about them. More importantly, this common distance of personal CTLA-4 genotype profiles from reference genotype patterns may group patients that would conventionally not have been thought to be potentially grouped for interpretation. By definition, they have different patterns of CTLA-4 parameters. Conventional approaches will indicate that these are different, so that conventional analysis would not investigate whether they have something in common.

NPS techniques—by contrast—have brought together patients with five different CTLA-4 genotypes, allowing for investigation of what these patterns have in common The absence of one common pattern from these five different patterns can clearly be seen to be what distinguishes cases and controls.

The combination of SNPs, shared by all individual patients' profiles that satisfy the condition of having the largest distance from one specific haplotype allows for further investigation into the mechanistic details (for example, why it is just this combination of major and minor allele in the 6 genotyped loci, which separates cases from healthy controls).

This example also shows how NPS helps in extracting collective properties of the CTLA-4 genotype through RRPs characterizing different cohorts. In the processing of complete study data, i.e., from the subject set where about 50% are healthy controls, the dominance of “allelic uniformity” of the CTLA-4 landmarks could be clearly observed (RRPs in FIG. 34). On the contrary, when only the melanoma case sub-cohort was analyzed, the resulting characteristic CTLA-4 genotype RRPs patterns that separate the long and short survival categories indicate that for melanoma cases, the “allelic heterogeneity” dominates the functionally relevant CTLA-4 genotype status.

One issue is that detailed characterization of the genotype by explicit consideration of the actual state of each SNP provides the significant clustering (for one survival group) or difference/distance (for the other survival group) of the prps relative to possibly interesting and interpretable CTLA-4 genotype relationship patterns.

The limitations of this example are: (a) the size of the study cohort and (b) the number of the SNPs studied. Consequently, NPS techniques were not fully exploited to combine clinical and genomic information. However, this example was a proof of principle for NPS, which can be extended in further applications. Specifically, one such application can identify a priori the compensatory and detrimental haplotypes through finding their function-related positive and negative descriptors.

In summary, pattern based polymorphism relationship analysis revealed that in healthy controls, the context in which the CTLA-4 and its genetic variants operate is compatible with the genotype with relationship pattern with “consensus” alleles in all six sites. While some relationship pattern differences can be seen between long and short overall survival groups, these were not independently recognized, and there was no identification of who was long and who was short surviving. To obtain really independent, statistically significant, prediction of the long or short survival would require one additional step: consider that there is a coherence pattern between assayed regions of CTLA-4 gene and that this coherence pattern is affected by the polymorphisms in the personal genotype in an exactly computable way. This is provided by the categorization of disease outcome via analysis of thermodynamic changes in the in CTLA-4 SNPs discovered by entromics, and quantified by the differences in matrices that quantify the energy weights associated with the various genotype profiles in individual patient entromic coherence networks.

### ADDITIONAL EXAMPLES AND APPLICATIONS

In various aspects, NPS techniques can be used for identification of patients with risk of post-operation bleeding after surgical insertion of stent into heart artery, related to comparative treatment efficiency. One advantage of NPS techniques in this situation is that based on data from electronic medical records, information about this important event is sparse (just 4% of patients with adverse reaction), and NPS techniques can allow for decision support for surgeons with respect to replacing that can be personalized, in contrast to universal application of costly biologics drug, indicated for bleeding prevention. By applying NPS techniques, treatment can be given just for the patients who need it.

In a second example, NPS techniques can be applied for identification of optimal patterns for minimally time consuming and minimally invasive probing for periodontal disease. This can provide a public health benefit, minimize the time/cost for preventive medicine, and minimizing patient anxiety.

In a third example, NPS techniques can be applied to identification of relationship between the metabolic syndrome characteristics and the depression status of patients with heart disease. This can be relevant for supporting optimal clinician decisions in order to treat patients with heart disease using drugs that alter mental status, which is a risk factor for heart disease complications.

Additionally, although specific examples discussed above have focused on clinical or biologic situations, in various embodiments, the subject innovation can be employed in a variety of settings to analyze data matrices, particularly in settings wherein the data matrix includes variables that are not readily comparable and/or situations in which the underlying dynamics behind the data matrix depends not just on individual values of parameters, but on relationships between those parameters, which can be examined via NPS techniques of the subject innovation.

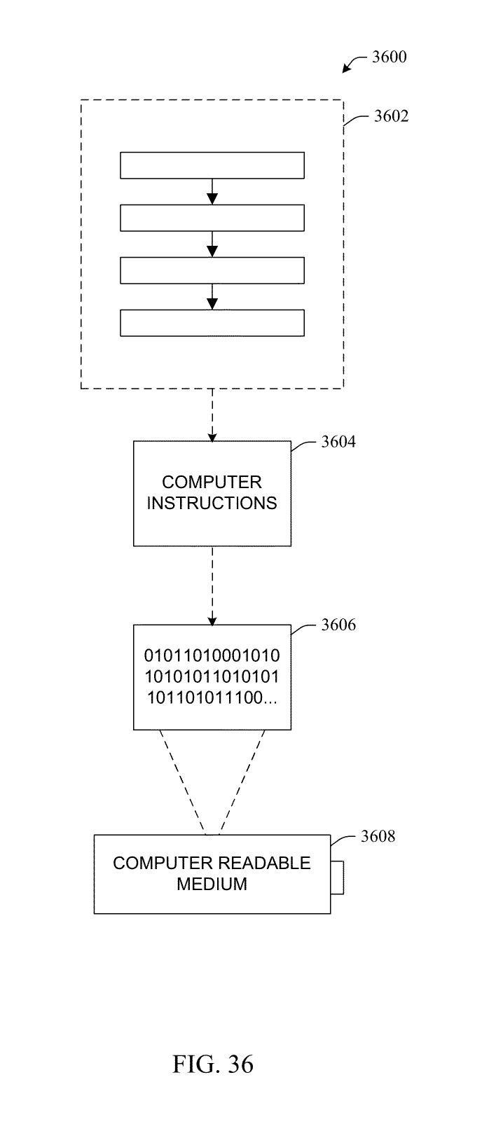

Still another embodiment can involve a computer-readable medium comprising processor-executable instructions configured to implement one or more embodiments of the techniques presented herein. An embodiment of a computer-readable medium or a computer-readable device that is devised in these ways is illustrated in FIG. 36, wherein an implementation 3600 comprises a computer-readable medium 3608, such as a CD-R, DVD-R, flash drive, a platter of a hard disk drive, etc., on which is encoded computer-readable data 3606. This computer-readable data 3606, such as binary data comprising a plurality of zero's and one's as shown in 3606, in turn comprises a set of computer instructions 3604 configured to operate according to one or more of the principles set forth herein. In one such embodiment 3600, the processor-executable computer instructions 3604 is configured to perform a method 3602, such as at least a portion of one or more of the methods described in connection with embodiments disclosed herein. In another embodiment, the processor-executable instructions 3604 are configured to implement a system, such as at least a portion of one or more of the systems described in connection with embodiments disclosed herein. Many such computer-readable media can be devised by those of ordinary skill in the art that are configured to operate in accordance with the techniques presented herein.

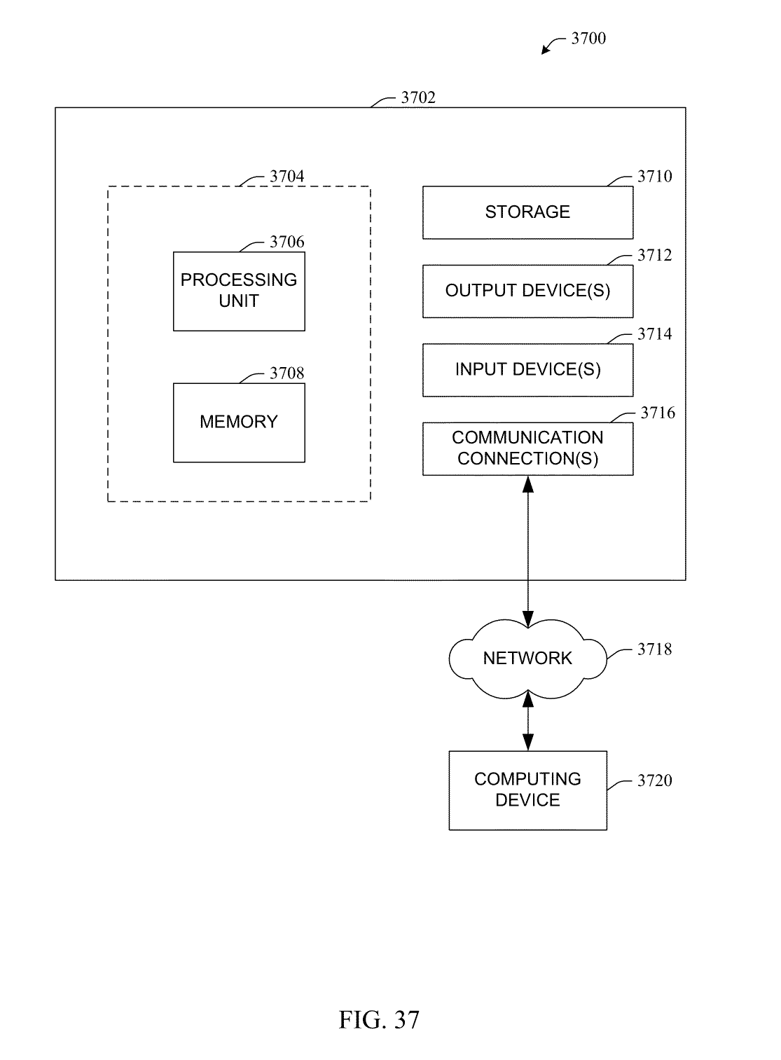

FIG. 37 and the following discussion provide a description of a suitable computing environment in which embodiments of one or more of the provisions set forth herein can be implemented. The operating environment of FIG. 37 is only one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, tablets, and the like, multiprocessor systems, consumer electronics, mini computers, mainframe computers, distributed computing environments that include any of the above systems or devices, and the like.

Generally, embodiments are described in the general context of “computer readable instructions” being executed by one or more computing devices. Computer readable instructions are distributed via computer readable media as will be discussed below. Computer readable instructions can be implemented as program modules, such as functions, objects, Application Programming Interfaces (APIs), data structures, and the like, that perform particular tasks or implement particular abstract data types. Typically, the functionality of the computer readable instructions can be combined or distributed as desired in various environments.

FIG. 37 illustrates a system 3700 comprising a computing device 3702 configured to implement one or more embodiments provided herein. In one configuration, computing device 3702 can include at least one processing unit 3706 and memory 3708. Depending on the exact configuration and type of computing device, memory 3708 may be volatile, such as RAM, non-volatile, such as ROM, flash memory, etc., or some combination of the two. This configuration is illustrated in FIG. 37 by dashed line 3704.

In these or other embodiments, device 3702 can include additional features or functionality. For example, device 3702 can also include additional storage such as removable storage or non-removable storage, including, but not limited to, magnetic storage, optical storage, and the like. Such additional storage is illustrated in FIG. 37 by storage 3710. In some embodiments, computer readable instructions to implement one or more embodiments provided herein are in storage 3710. Storage 3710 can also store other computer readable instructions to implement an operating system, an application program, and the like. Computer readable instructions can be loaded in memory 3708 for execution by processing unit 3706, for example.

The term “computer readable media” as used herein includes computer storage media. Computer storage media includes volatile and nonvolatile, removable and non-removable media implemented in any method or technology for storage of information such as computer readable instructions or other data. Memory 3708 and storage 3710 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 3702. Any such computer storage media can be part of device 3702.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

Device 3702 can include one or more input devices 3714 such as keyboard, mouse, pen, voice input device, touch input device, infrared cameras, video input devices, or any other input device. One or more output devices 3712 such as one or more displays, speakers, printers, or any other output device can also be included in device 3702. The one or more input devices 3714 and/or one or more output devices 3712 can be connected to device 3702 via a wired connection, wireless connection, or any combination thereof. In some embodiments, one or more input devices or output devices from another computing device can be used as input device(s) 3714 or output device(s) 3712 for computing device 3702. Device 3702 can also include one or more communication connections 3716 that can facilitate communications with one or more other devices 3720 by means of a communications network 3718, which can be wired, wireless, or any combination thereof, and can include ad hoc networks, intranets, the Internet, or substantially any other communications network that can allow device 3702 to communicate with at least one other computing device 3720.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method, comprising:
receiving a data matrix comprising a plurality of profiles, wherein each profile comprises a plurality of values, wherein each value is associated with a distinct parameter of a plurality of parameters;
defining a graph topology associated with the data matrix;
constructing a plurality of individual graphs associated with the plurality of profiles;
constructing a data matrix graph as the union of the individual graphs;
determining a plurality of reference relationship patterns (RRPs) from the data matrix graph;
computing the graph-graph distances between the plurality of individual graphs and the plurality of RRPs; and
defining proximities of the plurality of individual graphs to the plurality of RRPs based at least in part on the computed graph-graph distances.

2. The method of claim 1, wherein defining the graph topology comprises:
defining a plurality of partitions, wherein each partition is associated with an associated parameter of the plurality of parameters, and each partition comprises two or more values or ranges of the associated parameter;
defining a plurality of edges, wherein each edge is associated with the co-occurrence of a pair of variables in a profile of the plurality of profiles.

3. The method of claim 1, wherein the data matrix graph and the plurality of individual graphs comprise cycle graphs.

4. The method of claim 1, wherein the plurality of profiles are associated with a plurality of patients.

5. The method of claim 4, wherein the plurality of parameters comprise one or more of clinical, demographic, psychological, epidemiologic, environmental, genetic, or biological parameters.

6. The method of claim 4, further comprising characterizing two or more distinct phenotype, disease, or treatment outcome subgroups, wherein each subgroup is associated with one or more RRPs of the plurality of RRPs.

7. The method of claim 1, further comprising identifying a target pathway associated with inter-group heterogeneities among the one or more RRPs.

8. The method of claim 7, wherein identifying the target pathway comprises identifying one or more candidate biomolecules or portions thereof.

9. The method of claim 7, wherein the one or more candidate biomolecules comprises at least one of DNA, RNA, one or more enzymes, or one or more proteins.

10. The method of claim 9, wherein identifying the target pathway comprises identifying at least one of a conformation, a dynamic stability behavior, a polymorphism, a genetic variation, or a mutation.

11. The method of claim 8, wherein identifying one or more candidate biomolecules or portions thereof comprises identifying one or more candidate biomolecules or portions thereof for each of at least two sets of RRPs.

12. The method of claim 1, wherein at least one of the parameters is associated with entromic data.

13. The method of claim 1, further comprising:
receiving a test profile that comprises a plurality of test values associated with the plurality of parameters;
constructing a test graph associated with the test profile;
computing the graph-graph distances between the test graph and the plurality of RRPs; and
defining test proximities of the test graph to the plurality of RRPs based at least in part on the computed graph-graph distances.

14. The method of claim 13, further comprising generating a prognosis based at least in part on the defined test proximities.

15. A system, comprising:
an input component that receives a data matrix comprising a plurality of profiles, wherein each profile comprises a plurality of values, wherein each value is associated with a distinct parameter of a plurality of parameters;
a topology component that defines a graph topology associated with the data matrix;
a graph component that constructs a plurality of individual graphs associated with the plurality of profiles, wherein the graph component constructs a data matrix graph as the union of the individual graphs;
a reference relationship pattern component that determines a plurality of reference relationship patterns (RRPs) from the data matrix graph; and
a distance component that computes the graph-graph distances between the plurality of individual graphs and the plurality of RRPs, wherein the distance component defines proximities of the plurality of individual graphs to the plurality of RRPs based at least in part on the computed graph-graph distances.

16. The system of claim 15, further comprising an entromics component that determines one or more of the variables and associated values based at least in part on one or more function-linked relationships between genes, gene groups, or pathways.

17. The system of claim 15, wherein the topology component defines a plurality of partitions, wherein each partition is associated with an associated parameter of the plurality of parameters, and each partition comprises two or more values or ranges of the associated parameter, and wherein the topology component defines a plurality of edges, wherein each edge is associated with the co-occurrence of a pair of variables in a profile of the plurality of profiles.

18. The system of claim 15, wherein the data matrix graph and the plurality of individual graphs comprise cycle graphs.

19. The system of claim 15, wherein the plurality of profiles are associated with a plurality of patients.

20. The system of claim 19, wherein the plurality of parameters comprise one or more of clinical, demographic, psychological, epidemiologic, environmental, genetic, or biological parameters.
